(19) United States
(12) Patent Application Publication
(10) Pub. No.: US 2003/0113144 A1
(43) Pub. Date: Jun. 19, 2003

(54) Non-fixing type image receiving sheet, method and device for cleaning convexity of non-fixing type image receiving sheet, convexity-cleaning unit, and method and apparatus for forming toner image on image receiving sheet

(75) Inventors: Masaharu Kanazawa, Osaka (JP); Akira Izutani, Osaka (JP); Hiroshi Mizuno, Ikoma-Shi (JP); Akihito Ikegawa, Osaka (JP); Keyaki Yogome, Kyoto-Shi (JP)

Correspondence Address: McDERMOTT, WILL & EMERY, 600 13th Street, N.W., WASHINGTON, DC, 20005-3096, US

(73) Assignee: Minolta Co., Ltd.

(21) Appl. No.: 10/162,187

(22) Filed: Jun. 5, 2002

(30) Foreign Application Priority Data
Jun. 5, 2001 (JP) 2001-169593
Jun. 25, 2001 (JP) 2001-191630
Jun. 26, 2001 (JP) 2001-193488

(51) Int. Cl. G03G 21/00

(52) U.S. Cl. 399/343

(57) ABSTRACT

Convexity-cleaning method and device for removing toner adhering to a convexity or convexities of an irregular surface of a non-fixing type image receiving sheet. When removing the toner, a contact surface of a cleaning member is brought into contact with the convexity or convexities, the irregular surface is moved relatively to the cleaning member at a first surface moving speed, the contact surface of the cleaning member is moved at a second surface moving speed, and a difference is made between the first and second surface moving speeds.

An image forming apparatus including a toner image forming device for forming a toner image both on an ordinary image receiving sheet and on a non-fixing type image receiving sheet; and a unit-fit part. Any one of a fixing unit and a convexity-cleaning unit can detachably fit to the unit-fit part, and thereby one of the fixing unit and the convexity-cleaning unit fitted to the unit-fit part can be exchanged to the other.

### CROSS-REFERENCE TO RELATED APPLICATION

This application is based on Japanese Patent Applications No.2001-169593 filed in Japan on Jun. 5, 2001, No.2001-191630 filed in Japan on Jun. 25, 2001 and No.2001-193488 filed in Japan on Jun. 26, 2001, the entire contents of which are hereby incorporated by reference.

### BACKGROUND OF THE INVENTION

1. Field of the Invention

The present invention relates to a convexity-cleaning method and device for removing toner adhering to a convexity or convexities of a non-fixing type image receiving sheet that has an irregular surface including at least one convexity and at least one concavity.

The invention also relates to an image forming method and apparatus for forming a toner image on the non-fixing type image receiving sheet, in which the convexity-cleaning is performed.

The invention further relates to an image forming apparatus for forming the toner image both on an ordinary image receiving sheet and on the non-fixing type image receiving sheet as well as a convexity-cleaning unit used in the image forming apparatus when forming the toner image on the non-fixing type image receiving sheet.

2. Description of Related Art

Paper, sheet for an overhead projector (OHP) and the like are widely used as a medium for carrying an image formed thereon.

A variety of image forming methods have been proposed to form the toner image on an ordinary image receiving sheet such as paper, sheet for OHP and the like. Among them, a typical example is an electrophotographic image forming method.

According to the electrophotographic image forming method, the toner image is formed on the ordinary image receiving sheet in a manner, for example, as follows. An electrostatic latent image carrier such as a photosensitive member is charged to have a predetermined potential, and then exposure is performed on the charged region of the electrostatic latent image carrier to form an electrostatic latent image on the carrier according to original image information. Then the electrostatic latent image is developed into a visible toner image using a developer containing toner. The toner image on the electrostatic latent image carrier is transferred directly or indirectly onto the ordinary image receiving sheet, and thereby the toner image is formed on the ordinary image receiving sheet. Thereafter the transferred toner image is fixed to the ordinary image receiving sheet.

An image forming method of a direct recording type has been also proposed, in which the electrostatic latent image is not formed, and the toner is directly adhered onto the ordinary image receiving sheet to form the toner image thereon in accordance with the original image information, and thereafter the toner image thus formed thereon is fixed thereto. Alternatively, the toner image may be directly formed on an intermediate transfer member in a similar manner, and the toner image thus formed on the intermediate transfer member is then transferred to the ordinary image receiving sheet, and thereafter the toner image on the ordinary image receiving sheet is fixed thereto.

Anyway, these conventional image forming methods use the developer containing the toner which can be fixed onto the ordinary image receiving sheet. Typical example of such developer is a developer containing toner of a hot-melting type which is formed of thermoplastic resin and pigment or dye dispersed and mixed therewith.

The toner image composed of such hot-melting type toner is melted by heat to finally fix to the ordinary image receiving sheet made of paper, plastics or the like. In this fixing operation, a pressure is also applied during the heating, if necessary.

The toner fixed onto the ordinary image receiving sheet can not be separated from the ordinary image receiving sheet without difficulty, and therefore reuse of the toner and ordinary image receiving sheet is difficult. For separating the toner from the ordinary image receiving sheet to reuse the ordinary image receiving sheet carrying the toner image fixed thereto, known is a deinking method, in which an aqueous solution of, e.g., a surface active agent is used. However, the deinking method requires a large amount of energy for removing the water permeated into the ordinary image receiving sheet such as paper, and the removed toner can not be reused because it is in the solidified form after melting. Accordingly, the ordinary image receiving sheet having the toner image fixed thereto is usually dumped when it becomes unnecessary.

In this situation, large amounts of toner and ordinary image receiving sheets such as paper are consumed, and the energy required for the production of them as well as a carbon dioxide gas discharged thereby have been increasing.

For overcoming the above problems, Japanese Laid-Open Patent Publication No.2000-250249 has proposed a non-fixing type image receiving sheet that can carry the formed toner image without being fixing thereto, and an image forming method and apparatus for forming the toner image on the non-fixing type image receiving sheet.

The non-fixing type image receiving sheet has an irregular surface including at least one concavity for receiving the toner and at least one convexity for protecting the toner received in the concavity. The toner image is formed on the non-fixing type image receiving sheet by removably adhering the toner to the concavity or concavities. For example, the toner image is firstly formed on the photosensitive member by the electrophotographic method, and then the toner image is electrostatically transferred onto the irregular surface of the non-fixing type image receiving sheet, and thereby the toner image is formed on the irregular surface of the non-fixing type image receiving sheet.

When the toner image is formed on the non-fixing type image receiving sheet in this manner, the toner would be undesirably adhered, in some cases, to the convexity or convexities of the irregular surface of the non-fixing type image receiving sheet. If the toner adhering to the convexity, especially a top portion of the convexity, of the non-fixing type image receiving sheet is not removed, the toner would adhere to a finger of person who handles the image receiving sheet to make the finger dirty with the toner, or to the rear side of overlapped other image receiving sheet to make the other sheet dirty with the toner. That means the toner adhering to the convexity would cause contamination of another object.

In view of this problem, the toner adhering to the convexity or convexities of the irregular surface of the non-fixing type image receiving sheet is usually removed by a convexity-cleaning device provided in the image forming apparatus.

When the non-fixing type image receiving sheet is used instead of the ordinary image receiving sheet such as paper, the toner image can be formed, without the fixing operation, on the image receiving sheet to be retained on the image receiving sheet so that the toner on the image receiving sheet can be separated and removed therefrom. This allows reuse of the non-fixing type image receiving sheet that has been used for carrying the toner image as well as the toner removed from the non-fixing type image receiving sheet.

In view of such a present situation that the ordinary image receiving sheets such as paper are widely used as the media for carrying the toner image, desired is an image forming apparatus that can form the toner image both on the ordinary image receiving sheet and on the non-fixing type image receiving sheet.

As such an image forming apparatus, it is possible to imagine an image forming apparatus that has two sheet-transporting paths, i.e., a first sheet-transporting path opposed to a fixing device for fixing the toner image to the ordinary image receiving sheet and a second sheet-transporting path opposed to a convexity-cleaning device for cleaning the convexity of the non-fixing type image receiving sheet. In this image forming apparatus, the toner image can be formed both on the ordinary image receiving sheet and on the non-fixing type image receiving sheet by selecting the sheet transporting path in accordance with the type of the image receiving sheet to be used for image formation.

The above image forming apparatus having two sheet-transporting paths, however, is required to have a switching member for switching the sheet-transporting path to select the proper one, and an electrical and mechanical structure for driving the switching member, resulting in increased cost for the apparatus. In addition, the image forming apparatus having such two sheet-transporting paths has an increased size. Further disadvantageously, the user might need only one of the functions of the above image forming apparatus, that is, only one of the first function of forming the toner image on the ordinary image receiving sheet and the second function of forming the toner image on the non-fixing type image receiving sheet. In this case, one of the first and second functions is unnecessary for that user, that is, the image forming apparatus has an unwanted function.

### SUMMARY OF THE INVENTION

An object of the present invention is to provide a convexity-cleaning method and device for removing the toner adhering to a convexity or convexities of a non-fixing type image receiving sheet that has an irregular surface including at least one convexity and at least one concavity, more specifically to provide the convexity-cleaning method and device which can remove the toner adhering to the convexity or convexities while suppressing a disturbance of the toner image composed by the toner adhering to the concavity or concavities.

Another object of the invention is to provide an image forming apparatus for forming the toner image on the non-fixing type image receiving sheet, which can remove the toner from the convexity or convexities of the non-fixing type image receiving sheet while suppressing the disturbance of the toner image composed by the toner adhering to the concavity or concavities, and thereby can form a good toner image on the non-fixing type image receiving sheet.

A further object of the invention is to provide the convexity-cleaning method which can smoothly removing the toner adhering to the convexity or convexities of the non-fixing type image receiving sheet, and thereby can suppress contamination of another object by the non-fixing type image receiving sheet carrying the toner image formed thereon.

A still further object of the invention is to provide an image forming method which can smoothly remove the toner adhering to the convexity or convexities of the non-fixing type image receiving sheet after formation of the toner image on the non-fixing type image receiving sheet, and thereby can suppress contamination of another object by the non-fixing type image receiving sheet carrying the toner image formed thereon.

A still further object of the invention is to provide the non-fixing type image receiving sheet with which the toner adhering to the convexity or convexities of the irregular surface can be smoothly and satisfactorily removed.

Another object of the invention is to provide an image forming apparatus that can form the toner image both on the non-fixing type image receiving sheet and an ordinary image receiving sheet, and is inexpensive and compact.

A further object of the invention is to provide a convexity-cleaning unit for cleaning the convexity or convexities of the non-fixing type image receiving sheet, and can be utilized in the image forming apparatus for forming the toner image both on the non-fixing type image receiving sheet and on the ordinary image receiving sheet.

The invention provides the following first to fifth convexity-cleaning methods; convexity-cleaning device; image forming method, first and second image forming apparatuses; convexity-cleaning unit; and non-fixing type image receiving sheet.

In the following convexity-cleaning methods, convexity-cleaning device, image forming method, image forming apparatuses, and convexity-cleaning unit, the non-fixing type image receiving sheet is basically such a sheet that has the irregular surface including at least one concavity for receiving the toner and at least one convexity for protecting the toner received in the concavity. The non-fixing type image receiving sheet is used for carrying the toner image to be formed on the irregular surface by removably adhering the toner to the concavity or concavities of the irregular surface. The toner image to be formed on the non-fixing type image receiving sheet is not to be fixed thereto. The ordinary image receiving sheet is also used for carrying the toner image to be formed thereon, but the toner image to be formed on the ordinary image receiving sheet is to be fixed thereto.

(1) Convexity-Cleaning Method

The first convexity-cleaning method for removing the toner adhering to the convexity or convexities of the irregular surface of the non-fixing type image receiving sheet, includes the steps of: (a) bringing a contact surface of a cleaning member into contact with the convexity or convexities when removing the toner adhering to the convexity or convexities of the irregular surface of the non-fixing type image receiving sheet; (b) moving the non-fixing type image receiving sheet relatively to the cleaning member so that the irregular surface of the non-fixing type image receiving sheet moves relatively to the cleaning member at a first surface moving speed when removing the toner; and (c) moving the contact surface of the cleaning member at a second surface moving speed when removing the toner. In this method, a difference is made between the first and second surface moving speeds.

In the following second to fifth convexity-cleaning methods for cleaning the convexity or convexities of the irregular surface of the non-fixing type image receiving sheet, basically, the toner adhering to a top portion of the convexity is removed with a cleaning roller having a contact surface to be in contact with the top portion of the convexity, and thereby the convexity of the irregular surface of the non-fixing type image receiving sheet carrying the toner image formed thereon is cleaned. The contact surface of the cleaning roller is brought into contact with the top portion of the convexity while rotating the cleaning roller when removing the toner.

In the second convexity-cleaning method, the top portion of the convexity of the non-fixing type image receiving sheet and the contact surface of the cleaning roller satisfy: F_{w}1<F_{w}2, where F_{w}1 is Van Der Waals force between the top portion of the convexity and the toner adhering thereto, and F_{w}2 is Van Der Waals force between the contact surface of the cleaning roller and the toner adhering to the top portion of the convexity.

In the third convexity-cleaning method, the top portion of the convexity of the non-fixing type image receiving sheet and the contact surface of the cleaning roller satisfy: Fₑ1<Fₑ2, where Fₑ1 is an electrostatic attracting force between the top portion of the convexity and the toner adhering thereto, and Fₑ2 is an electrostatic attracting force between the contact surface of the cleaning roller and the toner adhering to the top portion of the convexity.

In the fourth convexity-cleaning method, the top portion of the convexity of the non-fixing type image receiving sheet and the contact surface of the cleaning roller satisfy: F_{b}1<F_{b}2, where F_{b}1 is a water bridging force between the top portion of the convexity and the toner adhering thereto, and F_{b}2 is a water bridging force between the contact surface of the cleaning roller and the toner adhering to the top portion of the convexity.

In the fifth convexity-cleaning method, a surface of the top portion of the convexity of the non-fixing type image receiving sheet has a center line average height in the range of 0.2 μm to 1.0 μm.

(2) Convexity-Cleaning Device

The invention provides a convexity-cleaning device for removing the toner adhering to the convexity or convexities of the irregular surface of the non-fixing type image receiving sheet. This convexity-cleaning device includes: (a) a cleaning member having a contact surface to be in contact with the convexity or convexities of the irregular surface of the non-fixing type image receiving sheet; (b) a first driving device for relatively moving the non-fixing type image receiving sheet with respect to the cleaning member; and (c) a second driving device for moving the contact surface of the cleaning member. In this device, the contact surface of the cleaning member is brought into contact with the convexity or convexities when removing the toner adhering to the convexity or convexities of the irregular surface of the non-fixing type image receiving sheet; the non-fixing type image receiving sheet is moved by the first driving device relatively to the cleaning member so that the irregular surface of the non-fixing type image receiving sheet moves relatively to the cleaning member at a first surface moving speed when removing the toner; the contact surface of the cleaning member is moved by the second driving device at a second surface moving speed when removing the toner; and a difference is made between the first and second surface moving speeds.

(3) Image Forming Method

The invention provides a image forming method for forming the toner image on the non-fixing type image receiving sheet. This image forming method includes the steps of: (a) forming the toner image on the irregular surface of the non-fixing type image receiving sheet by removably adhering the toner to the concavity or concavities; and (b) removing the toner adhering to a top portion of the convexity of the non-fixing type image receiving sheet by implementing one of the above-mentioned first to fifth convexity-cleaning method after forming the toner image on the irregular surface.

(4) Image Forming Apparatus

The first image forming apparatus is for forming the toner image on the irregular surface of the non-fixing type image receiving sheet, and includes: (a) a toner image forming device for forming the toner image on the irregular surface of the non-fixing type image receiving sheet by removably adhering the toner to the concavity or concavities of the irregular surface; and (b) the above-mentioned convexity-cleaning device.

The second image forming apparatus includes: (a) a toner image forming device for forming a toner image both on an ordinary image receiving sheet and on a non-fixing type image receiving sheet; and (b) a unit-fit part arranged at downstream side of the toner image forming device in a sheet feed direction. In the second image forming apparatus, any one of a fixing unit and a convexity-cleaning unit can detachably fit to the unit-fit part, and thereby one of the fixing unit and the convexity-cleaning unit fitted to the unit-fit part can be exchanged to the other. The fixing unit is for fixing the toner image formed on the ordinary image receiving sheet to the ordinary image receiving sheet. The convexity-cleaning unit is for removing the toner adhering to the convexity of the irregular surface of the non-fixing type image receiving sheet.

(5) Convexity-Cleaning Unit

The invention provides a convexity-cleaning unit detachably fittable to the unit-fit part of the above-mentioned second image forming apparatus.

(b 6) Non-Fixing Type Image Receiving Sheet

The invention provides a non-fixing type image receiving sheet, in which a surface of a top portion of the convexity has a center line average height in the range of 0.2 μm to 1.0 μm.

It is possible to combine two or more of the above-mentioned convexity-cleaning methods, convexity-cleaning device, image forming method, image forming apparatuses and convexity-cleaning units.

The foregoing and other objects, features, aspects and advantages of the present invention will become more apparent from the following detailed description and the accompanying drawings.

### BRIEF DESCRIPTION OF THE DRAWINGS

FIG. 1 is a schematic section view showing an example of the non-fixing type image receiving sheet.

FIG. 2 is a schematic plan view showing the non-fixing type image receiving sheet of FIG. 1.

FIG. 3 is a schematic perspective view showing the non-fixing type image receiving sheet of FIG. 1.

FIG. 4(A) is a schematic section view showing another example of the non-fixing type image receiving sheet.

FIG. 4(B) is a schematic plan view showing the image receiving sheet of FIG. 4(B).

FIG. 5 shows such a state that the non-fixing type image receiving sheet is pulled out from a sheet tray.

FIG. 6(A) to FIG. 6(J) show other examples of the configuration of the irregular surface of the non-fixing type image receiving sheet, respectively.

FIG. 7 is a plan view showing a further example of the non-fixing type image receiving sheet.

FIG. 8 is a schematic section view showing a portion of the non-fixing type image receiving sheet of FIG. 7.

FIG. 9(A) to FIG. 9(J) are plan views showing further examples of the non-fixing type image receiving sheets, respectively.

FIG. 10 shows a schematic structure of an example of the image forming apparatus provided with the convexity-cleaning device.

FIG. 11 shows such a state that the toner adhering to the concavities and convexities of the irregular surface of the non-fixing type image receiving sheet is removed to clean the irregular surface by a sheet-cleaning device provided in the image forming apparatus of FIG. 10.

FIG. 12 shows such a state that the toner image is transferred onto the non-fixing type image receiving sheet to form the toner image thereon by a toner image forming device provided in the image forming apparatus of FIG. 10.

FIG. 13 shows such a state that the toner adhering to the convexities of the irregular surface of the non-fixing type image receiving sheet by the convexity-cleaning device provided in the image forming apparatus of FIG. 10.

FIG. 14(A) shows such a state that the non-fixing type image receiving sheet of FIG. 1 is transported in a direction parallel with the convexity-extending direction in the image forming apparatus of FIG. 10. FIG. 14(B) shows such a state that the non-fixing type image receiving sheet of FIG. 1 is transported in a direction perpendicular to the convexity-extending direction in the image forming apparatus of FIG. 10.

FIG. 15 shows such a state that the toner remains on the convexity of the non-fixing type image receiving sheet when removing the toner from the convexity.

FIG. 16 shows such a state that the non-fixing type image receiving sheet having the irregular surface including a lattice-pattern convexity is subjected to the convexity-cleaning operation.

FIG. 17(A) shows a schematic structure of another example of the convexity-cleaning device. FIG. 17(B) shows a schematic structure of a further example of the convexity-cleaning device.

FIG. 18 is a schematic side view showing an example of the image forming apparatus having a unit-fit part.

FIG. 19 is a side view showing a schematic structure of a portion of the image forming apparatus of FIG. 18.

FIG. 20 shows such a state that the toner is transferred from a photosensitive member to the non-fixing type image receiving sheet at a transfer region.

FIG. 21 shows a schematic structure of a fixing unit fitted to the unit-fit part in the image forming apparatus of FIG. 18.

FIG. 22 shows a schematic structure of the convexity-cleaning unit fitted to the unit-fit part in the image forming apparatus of FIG. 18.

FIG. 23 shows such a state that the toner adhering to the convexities of the non-fixing type image receiving sheet carrying the toner image that has been transferred thereonto.

FIG. 24 shows a schematic structure of another example of the convexity-cleaning unit that has a plurality of the convexity-cleaning rollers arranged along a sheet feed direction.

FIGS. 25(A) and 25(B) are plan views of further examples of the non-fixing type image receiving sheets allowing a sheet type detection by a sheet type detecting device shown in FIG. 25(C). FIG. 25(C) shows a schematic perspective view showing an example of the sheet detecting device, and shows such a state that the sheet type detection is performed when the sheets of FIG. 25(A) are accommodated in a sheet cassette.

FIG. 26 is a block diagram schematically showing an example of a control circuit of the image forming apparatus.

FIG. 27 is a flow chart showing an example of an operating routine of the image forming apparatus.

FIG. 28(A) is a plan view showing further example of the non-fixing type image receiving sheet that allows the sheet type detection by the sheet type detecting device shown in FIG. 28(B). FIG. 28(B) shows another example of the sheet type detecting device, and shows such a state that the sheet type detection is performed when the sheets of FIG. 28(A) are accommodated in the sheet cassette. FIG. 28(C) is a plan view showing further example of the non-fixing type image receiving sheet that allows the sheet type detection by the sheet type detecting device shown in FIG. 28(D). FIG. 28(D) shows further example of the sheet type detecting device, and shows such a state that the sheet type detection is performed when the sheets of FIG. 28(C) are accommodated in the sheet cassette.

FIG. 29(A) and 29(B) show further example of the sheet type detecting device. More specifically, FIG. 29(A) shows such a state that the sheet type of the non-fixing type image receiving sheet is detected using a cassette for exclusively accommodating the non-fixing type image receiving sheets. FIG. 29(B) shows such a state that the sheet type of the ordinary image receiving sheet is detected using a cassette for exclusively accommodating the ordinary image receiving sheets.

FIG. 30(A) and 30(B) show further example of the sheet type detecting device. More specifically, FIG. 30(A) shows such a state that the sheet type of the non-fixing type image receiving sheet is detected using a cassette for exclusively accommodating the non-fixing type image receiving sheets. FIG. 30(B) shows such a state that the sheet type of the ordinary image receiving sheet is detected using a cassette for exclusively accommodating the ordinary image receiving sheets.

FIG. 31 shows such a state that the toner adhering to the concavities of the irregular surface of the non-fixing type image receiving sheet is removed with a fur brush device that is an example of the sheet cleaning device and includes a brush roller.

### DESCRIPTION OF THE PREFERRED EMBODIMENTS

Description is given below on preferred embodiments of the non-fixing type image receiving sheet, convexity-cleaning method and device, convexity-cleaning unit and image forming method and apparatus.

For better and easy understanding, first of all, the basic structure of the non-fixing type image receiving sheet will be described.

The non-fixing type image receiving sheet is a target to be cleaned in the convexity-cleaning method and device. In the image forming apparatus having the convexity-cleaning device, the non-fixing type image receiving sheet is a target (medium) onto which the toner image is to be formed, and is also a target to be cleaned by the convexity-cleaning device.

In the following description, the non-fixing type image receiving sheet will be described as the medium (target) onto which the toner image is to be formed by the image forming apparatus. Usually there arises a need for removing the toner adhering to the convexity or convexities of the irregular surface of the image receiving sheet after forming a toner image on the irregular surface of the image receiving sheet.

### §1. Non-Fixing Type Image Receiving Sheet

The non-fixing type image receiving sheet is basically as follows. The non-fixing type image receiving sheet is for carrying or retaining the toner image to be formed on its surface. The toner image is to be merely adhered to the surface of the non-fixing type image receiving sheet but is not to be fixed thereto.

The surface of the non-fixing type image receiving sheet includes an irregular surface (irregular surface region). The surface of the non-fixing type image receiving sheet may further include a margin portion (margin surface or margin region) other than the irregular surface.

The irregular surface of the non-fixing type image receiving sheet includes at least one concavity and at least one convexity. Typically, the irregular surface includes a plurality (e.g., a large number) of at least one kind of the concavity and convexity. That is, the irregular surface typically includes: (a) a plurality of the concavities and a plurality of the convexities; (b) one concavity and a plurality of the convexities; or (c) a plurality of the concavities and one convexity. In the case the irregular surface includes a plurality of the concavities and a plurality of the convexities, the number of the concavities may be same as or different from that of the convexities.

The concavity is provided for receiving toner and can receive one or more toner particles. The convexity is provided for protecting the toner received in the concavity.

An example of a configuration or pattern of the irregular surface is such that the irregular surface includes a large number of linear convexities (convexities in linear forms, or ridges) extending in parallel with each other at a predetermined spacing, or in other words, the irregular surface includes numerous concavities in the form of grooves, although not limited thereto. In this case, the concavities and convexities may be regularly formed over the irregular surface.

When forming the toner image on the irregular surface of the non-fixing type image receiving sheet, the toner is merely adhered to the concavity or concavities, but is not fixed thereto by heating or otherwise. Since the toner image is not fixed to the irregular surface, the toner image formed on the non-fixing type image receiving sheet can be removed by a specified method described later. The toner image can be removably formed on the irregular surface of the non-fixing type image receiving sheet accordingly.

Although the toner image is merely adhered to the irregular surface without being fixed thereto by heating as is done in conventional image forming methods, the toner image formed on the irregular surface of the non-fixing type image receiving sheet can be maintained or kept in the same state insofar as an extraordinary external force or toner-removing force is not exerted on the toner image, because the toner image formed on the non-fixing type image receiving sheet, in other words, the toner received in the concavity or concavities and composing the toner image can be protected by the convexity or convexities of the irregular surface. The toner in the concavity is protected by the convexity or convexities so that weak external force such as contact of the image receiving sheets with each other or light touch of user's finger with the image receiving sheet would be unlikely to affect the toner adhering to the concavity, and thereby the toner image formed on the non-fixing type image receiving sheet is not markedly destroyed.

The toner on the non-fixing type image receiving sheet is merely adhered thereto and can be easily separated from the sheet by the following method in accordance with the property of the toner. For example, when charged toner is used, the toner can be removed from the sheet by an electrostatic attractive force. When magnetic toner is used, the toner can be removed from the sheet by a magnetic force. After removal of the formed toner image, the non-fixing type image receiving sheet can be reused.

When forming the toner image on the non-fixing type image receiving sheet, it is not necessary to use a fixable toner, such as a heat-melting type toner which can be fixed by heating. Consequently a hard material can be used as a material for toner, and accordingly the toner of long life which is unlikely to deform, wear or melt can be used. The toner separated from the non-fixing type image receiving sheet can be reused like as the non-fixing type image receiving sheet.

The non-fixing type image receiving sheet basically has, as described above, the irregular surface including at least one concavity for accommodating the toner. The toner image can be formed on the irregular surface by removably adhering the toner to the concavity or concavities, and the toner adhering to the concavity can be protected by the convexity or convexities of the irregular surface of the sheet.

In general, the non-fixing type image receiving sheet preferably has such a structure that the concavity and convexity of the irregular surface have sizes which do not significantly degrade the quality of the toner image formed thereon. It is also desirable that the sizes of the concavity and convexity (including the width and height of the convexity and the width and depth of the concavity), and the shape and strength thereof provide satisfactorily protection of the toner adhering to the concavity or concavities from the external force. It is also desirable that the non-fixing type image receiving sheet can be manufactured at a minimum cost, assure safety to the environment and be excellent in appearance and pleasant to the touch. The non-fixing type image receiving sheet will be further described below.

(1) Overall Shape

Overall shape of the non-fixing type image receiving sheet may be in a rectangular form (including a square form), or may be other form.

(2) Configuration of Irregular Surface

The configuration (pattern) of the irregular surface may be any of one of configurations described in the following item (2a) to (2d), although not limited thereto.

(2a) The configuration of the irregular surface may be such that the irregular surface includes a plurality of linear convexities extending in parallel with each other as spaced away by a predetermined distance. In this case, an irregular surface region interposed between the two neighboring linear convexities corresponds to the concavity.

The linear convexities may be typically spaced away from each other equidistantly. Alternatively, the spacing between two adjacent linear convexities in a certain region may be different from that in another region.

The linear convexity may have a straight linear form, or a non-straight linear form (e.g., a wavy linear form).

If the non-fixing type image receiving sheet is rectangular, the linear convexities (e.g., convexities in the straight linear form) may extend in parallel with the long-side direction of the sheet, may extend in parallel with the short-side direction of the sheet, or may extend in a non-parallel direction in any of the long-side and short-side directions.

One or more convexities (e.g., linear convexities) may be further arranged between the neighboring two linear convexities, and the convexity or convexities thus further arranged may extend in a direction crossing an extending direction of the linear convexities. Such convexity or convexities may be arranged in some neighboring linear convexities and may not arranged in other neighboring linear convexities. If a plurality of convexities are arranged between the two neighboring linear convexities and are extending in the crossing direction with respect to these linear convexities, a distance between the convexities extending in the crossing direction may be same as or different from that of the neighboring linear convexities.

(2b) The configuration of the irregular surface may be such that the irregular surface includes the convexity having a lattice pattern. In this case, irregular surface regions surrounded with the latticed convexity corresponds to the concavities.

The convexity in the lattice form may include a plurality of first linear portions parallel with each other, spaced with each ohter by a first distance and extending in a first direction; and a plurality of second linear portions parallel with each other, spaced with each other by a second distance and extending in a second direction crossing the first direction.

An angle between the first direction and the second direction is typically 90 degrees, but may be another angle.

If the non-fixing type image receiving sheet is rectangular, the first direction may be parallel with the long-side direction of the sheet, may be parallel with the shor-side direction of the sheet, or may be not parallel with any of the long-side and short-side directions. The same can be said about the second direction.

(2c) The configuration of the irregular surface may be such that the irregular surface includes a plurality of columnar convexities that has predetermined sections and are arranged in a predetermined pattern. In this case, an irregular surface region not provided with columnar convexities corresponds to the concavity.

The sectional form of the columnar convexity may be circular or non-circular, e.g., elliptical, triangular or quadrilateral.

The columnar convexities may be typically arranged regularly, but may be arranged irregularly.

(2d) The configuration of the irregular surface may be such that the irregular surface includes a plurality of the concavities in a predetermined shape arranged in a predetermined pattern. In this case, an irregular surface region not provided with the concavities corresponds to the convexity.

The sectional form of the concavity may be, for example, quadrilateral or non-quadrilateral. All the concavities may be formed in the same shape, or one or more concavities may have a certain shape and the other(s) may have a different shape. The concavities may be typically arranged regularly but may be arranged irregularly.

(3) Sizes of Convexity and Concavity

The sizes of the convexity and concavity in the irregular surface affect a resolution of the toner image formed on the irregular surface, a property of protecting the toner image formed on the irregular surface (in other words, a property of maintaining or retaining the toner image), easiness in removing the toner adhering to the concavity and the like.

If the concavity is widened (the spacing between the neighboring convexities is broadened) to allow accommodation of a plurality of the toner particles, the resolution of the toner image can be increased, and further, the toner adhering to the concavity can be easily removed for reuse of the not-fixing type image receiving sheet. However, if the concavity is excessively widened (the spacing between neighboring convexities is excessively broadened), when the non-fixing type image receiving sheet comes into contact with another object (e.g. finger, another sheet, etc.), the object can be in contact with the toner in the widened concavity, and thereby the toner image formed on the irregular surface is likely to be broken, and contamination of the object with the toner is likely to occur.

The toner adhering to the convexity can be easily transferred onto another object (e.g., finger, another sheet, etc.) when the convexity comes into contact with the object, and therefore the toner adhering to the convexity tends to make the object dirty. For example, when a finger touches the irregular surface, the finger would be contaminated with the toner that has been adhered to the convexity.

To avoid this problem, the toner adhering to the each convexity is usually removed after forming the toner image on the irregular surface. If the toner adhering to the each convexity is removed, the resolution and clarity of the toner image formed on the irregular surface are reduced in the case of the irregular surface having a high ratio of an area occupied by all the convexities to an area of the entire irregular surface [(area occupied by all the convexities)/(area of the entire irregular surface)]. Accordingly, a low ratio of the area occupied by all the convexities at the irregular surface is preferred in view of the resolution.

However, if the spacing between neighboring convexities is excessively widened, or the width of convexities is excessively narrowed to diminish the ratio of the area occupied by all the convexities, the convexity would become insufficient in the capability of protecting the toner adhering to the concavity.

In view of these above, the irregular surface may be such that the ratio of the area occupied by all the convexities to the area of the entire irregular surface is less than 50%, in other words, the area occupied by all the concavities is larger than the area occupied by all the convexities. More specifically, in the case the irregular surface includes a plurality of the linear convexities parallel to each other with a predetermined spacing, the width of the linear convexity may be in the range of about 1/50 to about ½ of the width of the concavity (the spacing width of the neighboring convexities).

The sizes of the concavity and convexity of the irregular surface may be determined in consideration of the size of the toner to be used in formation of the toner image on the irregular surface of the non-fixing type image receiving sheet. The toner (toner particle) to be used may have an average particle size of about 2 μm to about 30 μm. In the case that a plurality of the concavities are formed at the irregular surface or other cases, the concavity may have a size sufficient to receive a plurality of the toner particles. A height of the convexity (depth of the concavity) is preferably greater than the average particle size of the toner particle to be used. If the height of the convexity (depth of the concavity) is less than the average particle size of the toner, it is difficult for the convexity to protect the toner adhering to the concavity. The width of the concavity (spacing between the neighboring convexities) may be two or more times larger than the average particle size of the toner particle.

More specifically, the sizes of the convexity and concavity of the irregular surface may be as follows, although the sizes may be variable in accordance with the size of the toner.

The height of the convexity (depth of the concavity) may be about 5 μm to about 150 μm, preferably about 30 μm to about 150 μm, more preferably about 20 μm to about 100 μm.

The width, diameter or the like, depending on the shape of the convexity, of the convexity may be about 0.5 μm to about 50 μm, preferably about 5 μm to about 50 μm, or about 0.5 μm to about 30 μm, more preferably about 5 μm to about 30 μm.

The width or the like, depending on the shape of concavity, of the concavity (or spacing distance between the two neighboring convexities) may be about 20 μm to about 500 μm.

In the case that the irregular surface includes the convexity in the lattice form as described above, the spacing distance between the neighboring linear portions, each extending in the first direction, of the lattice form convexity may be same as or different from the spacing distance between the neighboring linear portions, each extending in the second direction crossing the first direction, of the lattice form convexity. For example, the spacing distance between the neighboring linear portions, extending in the first direction, of the lattice form convexity may be about 20 μm to about 500 μm, while the spacing distance between the neighboring linear portions, extending in the second direction, of the lattice form convexity may be greater than about 500 μm (e.g. about 1 mm to about 100 mm). In this case, the toner in the concavity can be protected by the linear portions, extending in the first direction, of the lattice form convexity.

In the case that the irregular surface includes a plurality of the concavities each in a groove form, the convexity (ridge) extending along the groove-form concavity preferably has a width that is ½ to 1/50 of the width of the groove-form concavity. In the non-fixing type image receiving sheet having the irregular surface including, e.g., the groove-form concavities, the toner adhering to the groove-form concavity is likely to peel off if the depth of the groove-form concavity (height of convexity) is too low, whereas it is likely to be difficult to adhere the toner to the concavity when forming the toner image on the irregular surface if the depth of the groove-form concavity is too deep. The depth of the groove-form concavity is preferably about 20 μm to about 150 μm, more preferably about 50 μm to about 100 μm.

(4) Structure of Non-Fixing Type Image Receiving Sheet

The non-fixing type image receiving sheet may have either a single layer structure or a multi-layer structure.

In the non-fixing type image receiving sheet having a single layer structure, the single layer (first layer) provides a surface including the irregular surface, and therefore the first layer has an uneven surface.

The non-fixing type image receiving sheet having a multi-layer structure may be composed of at least two layers including, for example, a base layer (substrate) and a surface layer formed on one surface of the base layer and providing a surface including the irregular surface. In this case, one or more layers may be interposed between the base layer and the surface layer.

The non-fixing type image receiving sheet having the irregular surface may be provided by forming at least one convexity with a resin or like material on a flat base layer (a base sheet).

(5) Margin Portion of Non-Fixing Type Image Receiving Sheet

The surface of the non-fixing type image receiving sheet may include, in addition to the irregular surface, at least one margin portion (margin surface portion, margin region) as follows.

The margin portion is to be arranged at an end portion of the surface, including the irregular surface, of the non-fixing type image receiving sheet. The margin portion includes neither the concavity for receiving the toner nor the convexity for protecting the toner accommodated in the concavity.

In other words, the surface, including the irregular surface, of the non-fixing type image receiving sheet may have a region where neither the concavity nor convexity is formed. Typically the toner image is not formed on such margin portion.

The margin portion may be a flat surface which is as high as or substantially as high as a top surface of the convexity of the irregular surface. Alternatively, the margin portion may be a flat surface which is as high as or substantially as high as the bottom surface of the concavity of the irregular surface.

The image forming apparatus for forming the toner image on the non-fixing type image receiving sheet may be provided with a sheet tray or cassette for accommodating a plurality of the non-fixing type image receiving sheets. In this case, the non-fixing type image receiving sheet is drawn, one by one, from the sheet tray for formation of the toner image. In this operation, a pick-up roller, a manipulating roller or the like may be firstly brought into contact with an end surface portion of the non-fixing type image receiving sheet, and therefore the end portion of the non-fixing type image receiving sheet is likely to suffer a substantial stress from the roller. The margin portion may be the end surface portion, that is likely to suffer the substantial stress, of the non-fixing type image receiving sheet, in which case, the margin portion can suppress rapid wear of the convexities of the irregular surface, which makes it possible to reuse the non-fixing type image receiving sheet any number of times for formation of the toner images.

In the case that the non-fixing type image receiving sheet is rectangular, the surface of the image receiving sheet may have four margin portions arranged at four end portions, i.e. upper, lower, left and right end portions, respectively. Alternatively, the surface of the non-fixing type image receiving sheet may have two margin portions arranged at both end portions in a predetermined direction (e.g., a sheet feed direction in the image forming apparatus).

(6) Materials for Forming Non-Fixing Type Image Receiving Sheet

(6a) Materials for Forming Convexity and Concavity

Material for Forming the Convexity and Concavity (e.g. material for forming a layer providing the irregular surface) may be, for example, thermoplastic resin, curable resin that is curable by heat, light, electron rays or the like, resin that is dissolved in a solvent and solidified on vaporization of the solvent, etc.

Examples of the thermoplastic resin are polyethylene, polypropylene, polystyrene, polycarbonate, polyethylene terephthalate and so on. These resins can be used either alone or in combination.

Examples of the thermosetting resin are epoxy resins, phenolic resins, melamine resins, unsaturated polyester resins and so on.

Examples of the photo-curable resin are acrylic resins, epoxy resins, ene-thiol resins, etc. Examples of the acryl oligomer are polyol-modified (meth)acrylate, polyether-modified (meth)acrylate, polyester-modified acrylate, polyurethane-modified (meth)acrylate, epoxy-modified (meth)acrylate, polyacetal-modified (meth)acrylate and the like.

Examples of the photopolymerization initiator to be used in employing a photo-curable resin are hydrogen-drawn polymerization initiators (benzophenone, camphorquinone and the like), photo-cleavage type initiators (benzoinethyl ether, 2,4,6-trimethylbenzoyl diphenylphosphone oxide and the like) and so on. Dimethylaminoethyl methacrylate, n-butylamine, triethylamine, isoamyl ester of 4-dimethylaminobenzoic acid and the like can be used as a sensitizer.

Electron rays-curable resins to be used include, for example, epoxy-modified acrylate, polyurethane-modified acrylate, acryl-modified polyester, etc.

Typical examples of preferable curable resins include epoxy resins which can be selected from a wide range without limitation on the molecule structure, molecular weight and the like insofar as it is a compound having at least two epoxy groups per molecule. Examples of the epoxy resin include epoxy novolak type, biphenyl type and like aromatic type, alicyclic type (such as cyclohexane derivatives), bisphenol A type and bisphenol F type.

Materials for forming concavities and convexities may include, for example, biodegradable resins which are degraded on contact with water or bacteria when buried in the soil.

Examples of useful biodegradable resins are chemosynthetic resins, microorganism-producing resins and natural resins among which it is preferred to use natural resins having a chemical structure like that of the raw material for paper. Materials for forming concavities and convexities include, for example, polymers which are solidified on vaporization of a solvent.

Examples of such polymers solidifiable on vaporization of a solvent are epoxy resins, acrylic resins, urethane resins, urethane-urea resins, cellulose derivatives and the like. These polymers can be used either alone or in combination. A curing agent may be added to these resins.

Materials for forming concavities and convexities may include, for example, materials containing at least one kind of fillers (such as resins containing at least one kind of fillers). The fillers improve the properties of resins. The addition of fillers to the polymer resin upgrades the properties of polymer resin due to the filler. The filler is incorporated into the material for forming concavities and convexities preferably in an amount of about 0.5 wt. % to about 50 wt. %. The filler may be substantially uniformly dispersed in the material for forming concavities and convexities or may be made present locally in portions close to the surface of convexities and concavities.

Useful fillers are, for example, inorganic particles and/or organic particles.

Useful fillers may be reinforced fibers. The filler to be used may be particles and/or fine fibers of cellulose or polymer particles.

Inorganic fillers include, for example, calcium carbonate, barium carbonate, calcium sulfate, barium sulfate, magnesium hydroxide, magnesium oxide, titanium oxide, silica, talc, carbon black, etc.

Examples of the reinforced fibers are glass fibers, aramide fibers, carbon fibers, ceramic fibers, boron fibers, alumina fibers, silicon carbide fibers, etc. Reinforced fibers may be any of twisted fibers, unravelled twines, non-twisted fibers and the like. Because of high strength and durability, carbon fibers are preferred. Useful surface-treated fibers include glass fibers, aramide fibers, boron fibers, alumina fibers, silicon carbide fibers, etc. which are all surface-treated.

These fibers can be used either alone or in combination. At any rate, the filler may be subjected to surface-modifying treatment such as silane-coupling treatment, titanate-coupling treatment or the like to increase the affinity for polymers. At least one kind of additives such as antistatic agents, stabilizers and surface tension adjusting agents and the like may be added to the polymer or like materials for forming concavities and convexities. The additives or like materials may be, for example, dispersed uniformly in the material. The antistatic agents, stabilizers and surface tension adjusting agents may be applied to the irregular surface after formation of irregular surface with the material such as polymers.

To improve the affinity for the resin, the filler may be subjected to surface-modifying treatment such as silane-coupling treatment, titanate-coupling treatment or the like.

The resin may contain at least one kind of additives such as antistatic agents, stabilizers and surface tension adjusting agents. The additives may be, for example, dispersed uniformly in the resin. The antistatic agents, stabilizers and surface tension adjusting agents may be applied to the irregular surface after formation of irregular surface with the material containing the resin.

(6b) Material for Base Layer

In the case that the non-fixing type image receiving sheet includes the base layer, in other words, in the case the surface layer, that provides the surface including the irregular surface, is directly or indirectly formed on the base layer, the base layer (substrate) is formed, e.g. of paper or films. Useful paper may be, for example, wood-free plain paper, regenerated paper, recycled paper or RC paper coated with polyethylene or like resins which have a basis weight of about 25 g/m² to about 250 g/m². Useful films are for example, polyethylene films, polypropylene films, polyethylene terephthalate films and the like. The base layer may be transparent or opaque (e.g. white).

### §1.1.

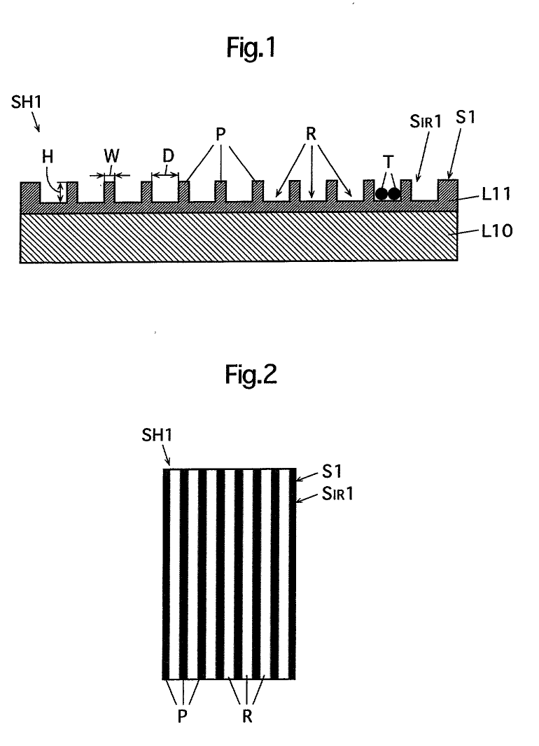

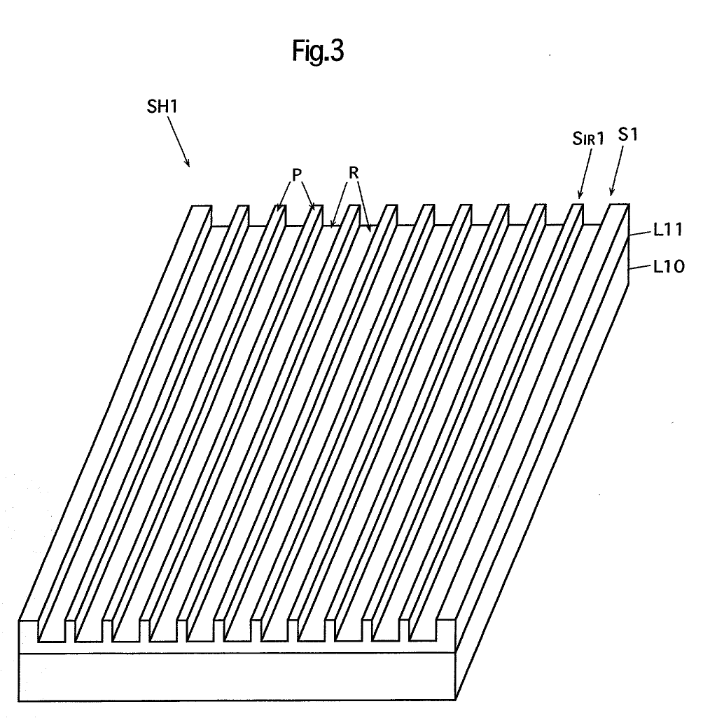

FIGS. 1, 2 and 3 are a schematic section view, a schematic plan view and a schematic perspective view, respectively, showing an example of the non-fixing type image receiving sheet for carrying or retaining the toner image formed thereon.

The non-fixing type image receiving sheet SH1 shown in FIGS. 1 to 3 has a A4 size, and is formed of two layers, i.e. a base layer L10 and a surface layer L11 in this embodiment. The base layer L10 is plain paper, and the surface layer L11 is made of a resin in this embodiment.

The surface layer L11 provides one surface S1 of the non-fixing type image receiving sheet SH1, and the surface S1 includes an irregular surface S_{IR}1. In this embodiment, concavities R and convexities P are formed all over the surface S1, in other words, the entire surface S1 provides the irregular surface S_{IR}1. Optionally the surface S1 may have a region where neither the convexities nor concavities is formed.

The irregular surface S_{IR}1 in the surface S1 has a plurality of concavities R for receiving the toner and a plurality of convexities P for protecting the toner received in the concavities R. Each of the convexities P has a linear form, and these convexities P are parallel with each other and are arranged at a predetermined pitch in this embodiment. The convexities P extend in the long-side direction (lengthwise direction) of the image receiving sheet SH1 in this embodiment. The concavities R are irregular surface portions between the neighboring linear convexities P, and are linear grooves in this embodiment.

The convexity P has a height H (depth of the concavity R) of about 50 μm, and a width W of about 20 μm in this embodiment. The concavity R has a width D (spacing between the neighboring convexities P) of about 80 μm in this embodiment. The concavities and convexities are depicted in a larger size in FIGS. 1 to 3 than the original size thereof for better understanding. This is also true with respect to the figures showing other image receiving sheets described later.

The toner image is formed on the image receiving sheet SH1, in brief, in the following manner. The toner image is formed by removably adhering the toner T (see FIG. 1) to the concavity or concavities R of the irregular surface. The toner T is electrically chargeable, and has an average particle size of about 10 μm in this embodiment. The toner T adhering to the concavity R is protected by the convexities P. The toner composing the toner image is merely adhered to the concavities but is not fixed thereto. For this reason, the toner composing the toner image on the irregular surface can be easily removed by utilizing an electrostatic force, compared with the removal of the toner fixed to the ordinary image receiving sheet such as paper. Consequently the non-fixing type image receiving sheet SH1 can be reused repeatedly for formation of toner images.

### §1.2.

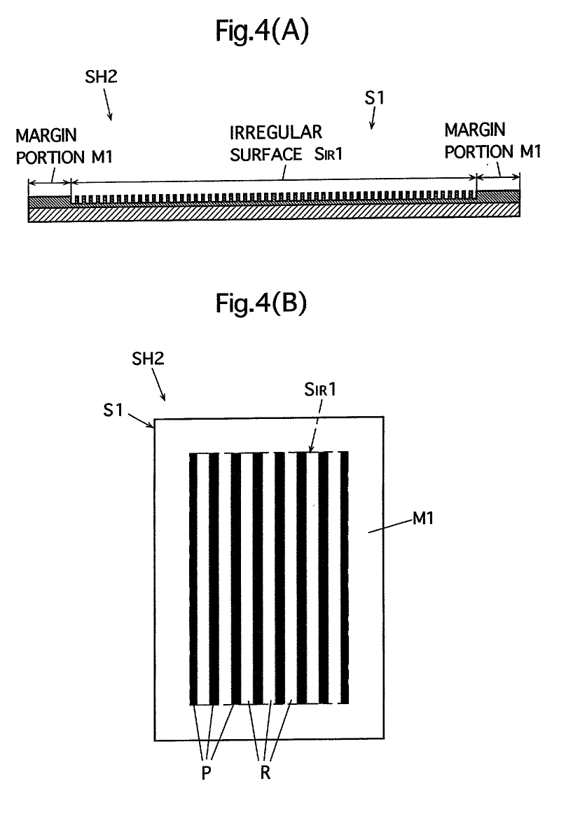

A schematic section view and a schematic plan view showing another example of the non-fixing type image receiving sheet are shown in FIG. 4(A) and FIG. 4(B), respectively. The image receiving sheet SH2 of FIG. 4(A) and FIG. 4(B) is provided at the surface S1 with a margin portion (margin surface portion, margin region) M1 as well as the irregular surface S_{IR}1. The margin portion M1 does not include the concavity for receiving the toner. The margin portion M1 does not have surface irregularity and is planar. The margin portion M1 is positioned at four end portions, i.e., upper, lower, left and right end portions of the surface S1, and takes the form of a frame as a whole in this embodiment. In other words, the irregular surface S_{IR}1 is positioned in the center of the surface S1 in the image receiving SH2. The margin portion M1 has a height as high as the top surfaces of the convexities P of the irregular surface S_{IR}1 in this embodiment.

Such margin portion provided in the image receiving sheet gives the following advantages.

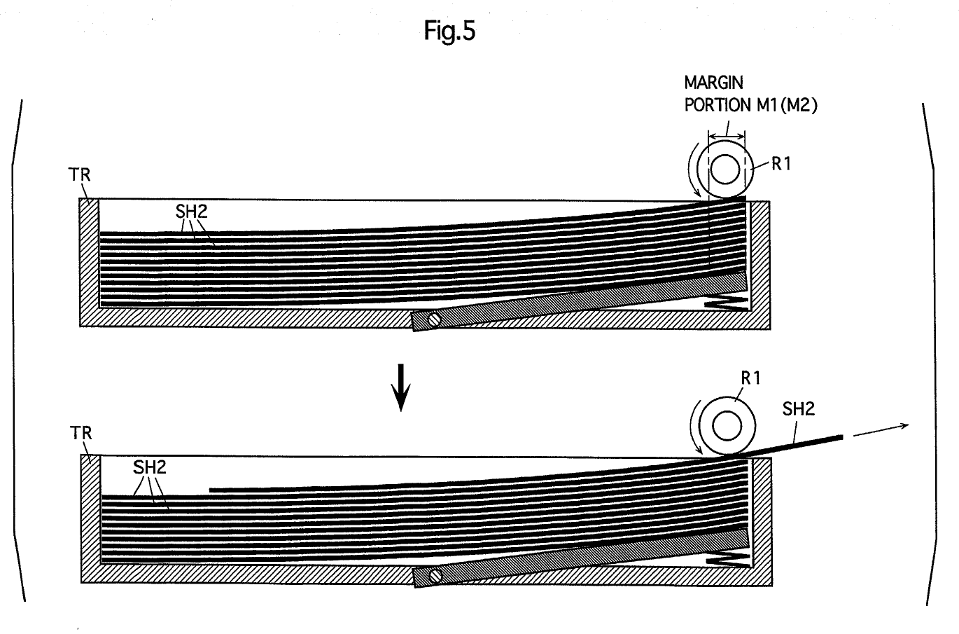

In the image forming apparatus, for example, the image receiving sheet is pulled out from a sheet tray TR accommodating a plurality of the image receiving sheets as shown in FIG. 5, and is then used for forming the toner image thereon. With, e.g., a pick-up roller R1, single image receiving sheet SH2 is pulled out from the sheet tray TR. In the process of pulling out one image receiving sheet SH2 from the sheet tray TR by the pick-up roller R1, an end portion, with which the roller R1 initially comes into contact, of the sheet SH2 suffers a great load or stress, and therefore the end portion of the sheet SH2 is likely to wear away. If the concavities and convexities exist at the end portion of the sheet SH2 with which the roller R1 initially comes into contact, the convexities P would become worn out, and thereby the convexity's capability of protecting the toner received in the concavities would decrease.

The wear of the irregular surface S_{IR}1 can be suppressed by provision of the margin portion M1 located at the sheet end portion with which the pick-up roller R1 initially comes into contact. In the case the non-fixing type image receiving sheet has the margin portion as described above, the toner image formation on the image receiving sheet may be typically performed such that the toner image is not formed on the margin portion. The width of the margin portion M1 may be determined based on the positional relationship between the image receiving sheet SH2 and the pick-up roller R1 when the sheet SH2 is accommodated in the tray TR.

Since the margin portion M1 of the image receiving sheet SH2 has a outer frame form, it is possible to suppress the wear of the irregular surface S_{IR}1 due to the pick-up roller R1 even when the sheet SH2 is pulled out in any direction by the roller R1, in other words, even when the roller R1 initially comes into contact with any one of four end portions of the sheet SH2, in further other words, even when the sheet SH2 is accommodated in any direction inside the tray TR.

If the pulling out direction of the image receiving sheet from the sheet tray is set only one direction, the margin portion may be provided only at both end portions in the pulling out direction, instead of providing the margin portion at four end portions.

### §1.3.

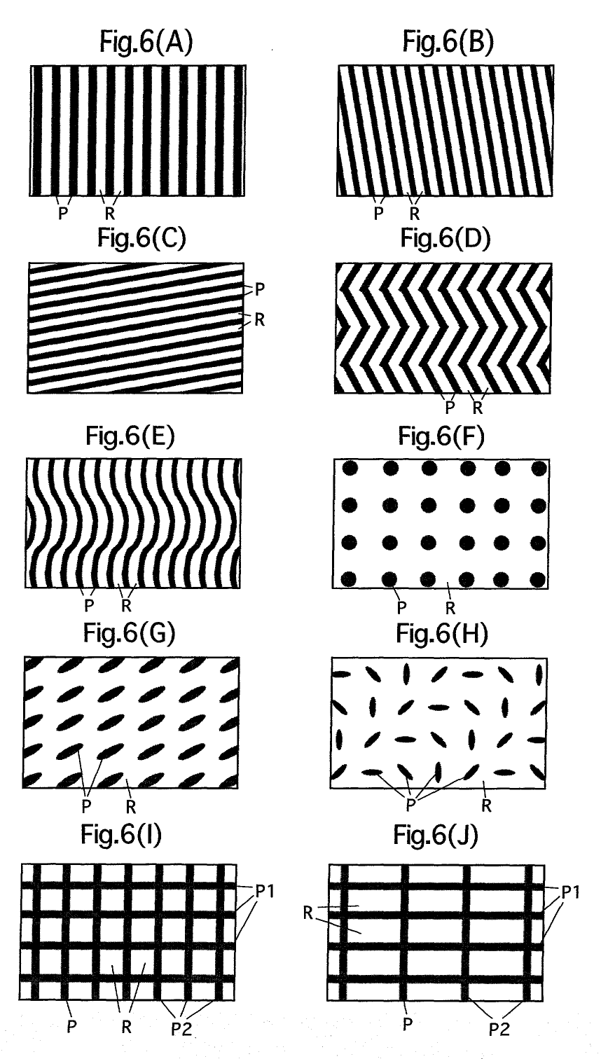

The configuration (pattern) of irregular surface of the non-fixing type image receiving sheet is not limited to that of the sheet SH1 shown in FIG. 2, and may be as shown in FIG. 6(A) to FIG. 6(J).

Each of the irregular surfaces of FIG. 6(A) to FIG. 6(C) has a plurality of linear convexities P parallel with each other with a predetermined pitch. The concavity R is an irregular surface region interposed between the neighboring linear convexities P. More specifically, the irregular surface of FIG. 6(A) has linear convexities P extending in the short-side direction of the sheet. Each of the irregular surfaces of FIG. 6(B) and FIG. 6(C) has the linear convexities P extending in a direction inclined with respect to both the short-side and long-side direction of the sheet.

Each of the irregular surfaces of FIG. 6(D) and FIG. 6(E) has a plurality of wavy convexities P parallel with each other at a predetermined pitch. The concavity R is the irregular surface region interposed between the neighboring convexities P. More specifically, the irregular surface of FIG. 6(D) has a plurality of triangular wavy convexities P. The irregular surface of FIG. 6(E) has a plurality of curved wavy convexities P.

Each of the irregular surfaces of FIG. 6(F) to FIG. 6(H) has a plurality of columnar form (dot-form) convexities P formed in a predetermined pattern. The concavity R is the irregular surface region where no convexity is formed. More specifically, the irregular surface of FIG. 6(F) includes the columnar form convexities P each having a circular section. Each of the irregular surfaces of FIG. 6(G) and FIG. 6(H) includes the columnar convexities P each having an elliptical section. The convexities P in FIG. 6(G) are formed in such a pattern that the convexities extend in the same direction. The convexities P in FIG. 6(H) are formed in such a pattern that the convexities are not extending in the same direction, but the convexities are formed in a regular pattern as a whole.

Each of the irregular surfaces of FIG. 6(I) and FIG. 6(J) has the lattice-form convexity P. The concavities R are the irregular surface regions surrounded by the lattice. More specifically, in the irregular surface of FIG. 6(I), the pitch of first linear portions P1 of the lattice-form convexity P extending in the first direction is same as the pitch of second linear portions P2 of the lattice-form convexity P extending in the second direction. In contrast, the pitch of the first linear portions P1 is different to that of the second linear portions P2 in the irregular surface of FIG. 6(J). In each of the irregular surfaces of FIG. 6(I) and FIG. 6(J), the angle between the first direction and second directions of the first and second linear portions is 90 degrees, but may be other angle.

### §1.4.

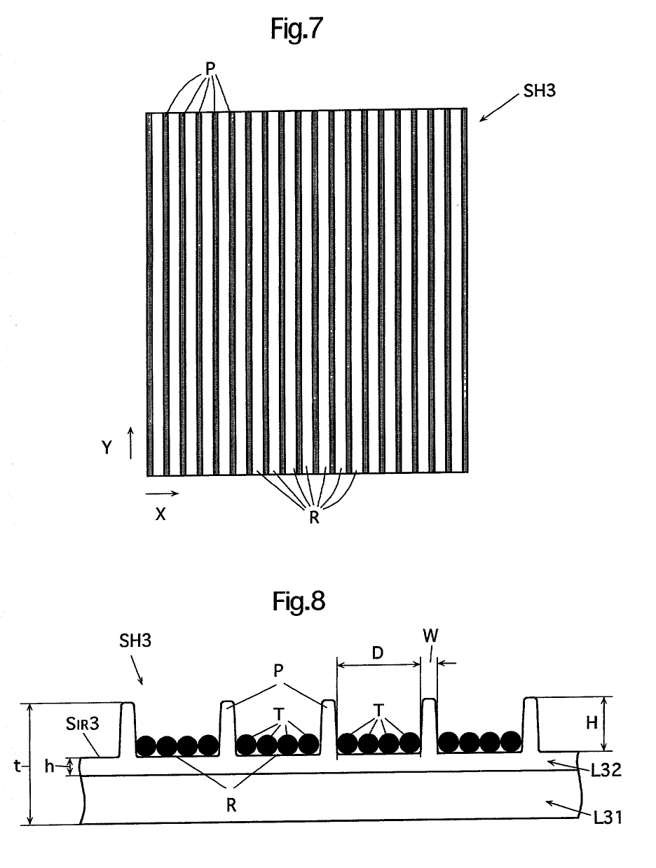

FIG. 7 is a schematic plan view showing a further example of the non-fixing type image receiving sheet. FIG. 8 is a schematic section view showing a portion of the non-fixing type image receiving sheet shown in FIG. 7.

In the image receiving sheet SH3 shown in FIGS. 7 and 8, an irregular layer (image receiving layer) L32 is formed on one surface of a sheet substrate L31. In FIG. 8, the reference symbol “T” indicates the toner illustrated in an exaggeration manner. The image receiving sheet SH3 is white in this embodiment although not limited thereto, and may be other color in accordance with the color of the toner.

The image receiving layer L32 has an irregular surface S_{IR}3 including concavities R for accommodating the toner T and convexities P for protecting the toner T accommodated in the concavities R.

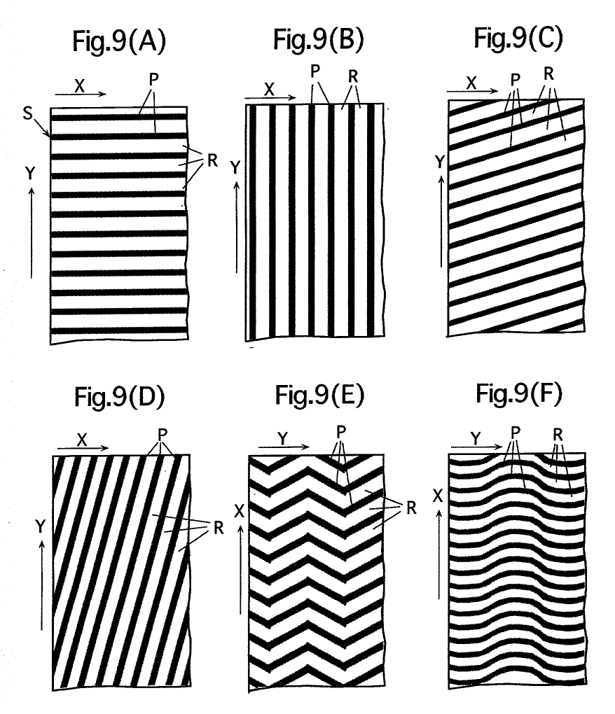

Examples of the arrangement pattern of convexities and concavities in the irregular surface include a pattern in which the concavities R are arranged regularly in the form of continuous grooves with a predetermined spacing as illustrated in FIGS. 9(A) to 9(F). There is the convexity P between the neighboring groove-form concavities R, and the convexity P extends along the concavities R. The reference symbol “Y” in the figures means a feed direction of the image receiving sheet in the process of forming the toner image, and the reference symbol “X” refers to a direction perpendicular to the sheet feed direction.

The configuration of the irregular surface may be such that the irregular surface includes the groove-form concavities, ridge-form convexities extending along the groove-form concavities, and partition wall convexities (transverse convexities) that extends in a direction crossing the extending direction of the groove-form concavities, are formed between the neighboring ridge-form convexities and are spaced to each other by a suitable distance. The configuration described above may be, for example, the lattice pattern shown in FIGS. 6(I) and 6(J). In this case, the irregular surface regions free of the convexities correspond to concavities.

The configuration of the irregular surface may be such that the irregular surface includes a large number of columnar-form convexities P each having a predetermined section and arranged in a predetermined pattern, as illustrated, by way of example, in FIG. 6(F) to FIG. 6(H). In this case, the irregular surface regions free of the convexities correspond to the concavities. In other words, a large number of the concavities may result in one continuous concavity. The section form of convexity may be, for example, circular although not limited thereto, and can be non-circular.

The irregular surface S_{IR}3 of the non-fixing type image receiving sheet SH3 employs the configuration of FIG. 9(B). The irregular surface S_{IR}3 includes the groove-form concavities R for accommodating the toner T and the ridge-form convexities P for protecting the toner T accommodated in the concavities R. The concavities R and convexities P extend in a direction parallel with the sheet feed direction Y (see FIG. 9(B)). In the irregular surface S_{IR}3, the concavities R and convexities P are formed in a substantially uniformly dispersed manner. In the irregular surface S_{IR}3, a total area occupied by the concavities R is larger than a total area occupied by the convexities P. The concavities R are greater in the depth and width than the toner size, and are capable of accommodating a plurality of the toner particles.

Generally speaking, the non-fixing type image receiving sheet may have the following sizes although not limited thereto. The width D (see FIG. 8) of the concavity R may be about 15 μm to about 400 μm. The width W of convexity P may be about 5 μm to about 100 μm. The depth H of the concavity R (height H of the convexity P) may be about 20 μm to about 150 μm. The width W of the convexity P may be in the range of 1/50 to ⅔ of the width D of the concavity R.

As described above, the non-fixing type image receiving sheet SH3 has the irregular surface S_{IR}3 in which the concavities R can accommodate the toner T; the toner image can be formed on the irregular surface S_{IR}3 by removably adhering the toner to the concavity or concavities R; and the convexities P can protect the toner T adhering to the concavities R. Numerous concavities R may be formed in the irregular surface S_{IR}3.

The non-fixing type image receiving sheet can be formed of various materials such as paper, synthetic resin, e.g., polyester, polethylene terephthalate, polyolefin (polypropylene, polyethylene or the like), polyimide, polyamide or the like, combinations thereof or the like.

For example, the non-fixing type image receiving sheet may be formed as follows. A surface layer is formed on a sheet core layer made of paper or the like although not limited thereto. The surface layer may be made of, for example, synthetic resin (polyethylene, acrylic resin, polyester or like thermoplastic resins) alone, or a mixture of synthetic resin and titanium oxide, zinc oxide, silica, alumina, clay, talc or like white pigment, extender pigment or the like, although not limited thereto. The surface layer is then shaped with a mold (e.g., master roller) having an irregular surface corresponding to the irregular surface of the image receiving sheet to be formed. The irregular surface may be formed by casting method in which the resin is casted into the mold.

Alternatively, the irregular surface may be formed as follows. A polymer film as a resist film is formed on the sheet core layer. The resist film may be photo-polymerizable polymer film. The resist film is then exposed via a light screen mask that has apertures corresponding to the concavities to be formed. The resist film portions thus exposed to the light are then removed by, e.g., washing in water, so that the irregular surface is obtained.

The irregular surface may be formed by shaving the flat surface layer with a dicing saw or precision cutting tool to form the desired concavities.

In this example, the non-fixing type image receiving sheet SH3 is produced in the following manner. A sheet of thermoplastic resin (high-density polyethylene resin) is superimposed on a sheet core layer L31 made of paper, and a configuration mold is further superimposed on the resin sheet. Then, the superimposed structure is interposed between metal plates, and is pressed for 30 minutes under a temperature of 150° C. and a pressure of 9.80665×10⁵ Pa (10 kgf/cm²), so that the surface pattern of the mold is transferred to the resin sheet, and the resin sheet is fixed to the core layer L31. Then the mold is separated from the resin sheet that has the irregular surface thus transferred and is fixed to the sheet core layer L31 after cooling, so that the non-fixing type image receiving sheet SH3 is obtained. The non-fixing type image receiving sheet SH3 thus produced has the paper sheet L31 and the polyethylene resin layer L32 that is formed on the sheet L31 and has the irregular surface S_{IR}3 including the concavities and convexities.

The non-fixing type image receiving sheet SH3 thus produced may have the following sizes. In FIG. 8, the width D of each groove-form concavity R is about 100 μm, the height H of each convexity P (depth of each concavity) is about 60 μm, and the width W of each convexity P is about 15 μm. The thickness h of the thinnest portion of the irregular layer L32 (thickness of bottom portion of concavity of irregular layer L32) is about 10 μm.

Instead of the above manner, the non-fixing type image receiving sheet SH3 can be produced in the following manner. An epoxy resin is cast into a configuration mold made of silicone rubber, and then a resin-coated sheet L31 is superimposed on the epoxy resin, and then they are interposed between metal plates, and then they are left to stand for a long time. Thereafter the metal plates are removed, whereby the image receiving sheet SH3 is obtained. The image receiving sheet SH3 thus produced has the irregular surface S_{IR}3 including concavities and convexities which is formed of epoxy resin. The image receiving sheet SH3 thus produced has the irregular surface S_{IR}3 provided by the irregular layer L32. The depth D of each groove-form concavity R may be about 150 μm; the height H of each convexity P (the depth of each concavity) may be about 50 μm; and the width W of each convexity P is about 20 μm. The thickness of the thinnest portion of the irregular layer L32 (thickness of bottom portion of concavities of the irregular layer L32) may be about 15 μm.

Instead of the above manners, the image receiving sheet SH3 having the irregular surface S_{IR}3 including the concavities and convexities can be produced, e.g., by passing a sheet composed of a paper sheet L31 and polyethylene resin film superposed thereon between rollers, one of which has an irregular surface corresponding to the irregular surface S_{IR}3 to be formed, is heated and is brought into contact with the resin film.

§2. Method and Device for Forming Toner Image

In the method and device for forming the toner image, the toner image may be formed on the irregular surface of the non-fixing type image receiving sheet in the following manner, although not limited thereto.

For example, the toner image may be formed on the irregular surface of the non-fixing type image receiving sheet by an electrophotographic method. In the electrophotographic method, the toner image is formed on the irregular surface, for example, as follows. An electrostatic latent image corresponding to an intended toner image is formed on an electrostatic latent image carrier, and is then developed with a developer containing the toner, so that the toner image is formed on the carrier. Thereafter the toner image is transferred onto the irregular surface of the image receiving sheet, whereby the toner image is formed on the irregular surface of the image receiving sheet. The latent image carrier may be, for example, a photosensitive member having a photosensitive layer. In this case, a surface of the photosensitive layer is uniformly charged, and then the charged surface of the photosensitive layer is exposed, and thereby the electrostatic latent image can be formed. Instead of the photosensitive member, the latent image carrier may be a dielectric member having a dielectric layer. In this case, the electrostatic latent image can be formed on the latent image carrier, for example, by an ion flow method or a multi-stylus method.

Instead of the above manners, the toner image may be formed on a carrier without forming an electrostatic latent image by a direct recording method. In this case, the toner image is formed on the carrier, for example, by selectively adhering the toner to the carrier surface regions corresponding to pixels, and is then transferred onto the irregular surface so that the toner image is formed on the irregular surface.

Instead of the above, the toner image may be directly formed on the irregular surface of the non-fixing type image receiving sheet by the direct recording method without forming the toner image on the carrier.

For forming a color toner image on the image receiving sheet or for other purpose, the toner image may be formed on a first carrier, and is then transferred from the first carrier to a second carrier, and is then transferred from the second carrier to the irregular surface of the image receiving sheet, and thereby the toner image is formed on the irregular surface. In this case, the second carrier for carrying the toner image to be transferred to the image receiving sheet functions as so-called intermediate transfer member. The intermediate transfer member may be, for example, an endless belt. The toner image may be formed on the first carrier, for example, by the above-mentioned electrophotographic method or the like.

The toner for forming the toner image may be, for example, a chargeable toner or chargeable magnetic toner. The toner may has an average particle size of, e.g. about 2 μm to about 30 μm, preferably about 5 μm to about 30 μm. For forming the toner image with a high resolution, the average particle size of the toner may be preferably about 2 μm to about 9 μm, more preferably about 5 μm to about 9 μm. If the average particle size of the toner exceeds 30 μm, the resolution of the toner image is reduced. If the average particle size of the toner is less than 2 μm, separation of the toner from the image receiving sheet becomes difficult. Therefore, preferable average particle size of the toner is within the above range.

When the toner image is formed on the irregular surface of the non-fixing type image receiving sheet in the foregoing manner, the toner is adhered to the convexity or convexities if the toner image is present at a position or positions corresponding to the convexity or convexities of the irregular surface.

If the image receiving sheet comes into contact with another object (e.g., a finger, another image receiving sheet or the like) under the condition that the toner adheres to the convexity or convexities of the irregular surface, the toner adhering to the convexity or convexities would be transferred to that object. This means the toner adhering to the convexity or convexities is likely to contaminate the object to be in contact with the non-fixing image receiving sheet. To suppress this problem, the toner adhering to each convexity is removed.

§3. Convexity-Cleaning Method and Device, and Image Forming Apparatus

The convexity-cleaning method and device are for cleaning the convexity or convexities of the non-fixing type image receiving sheet having the irregular surface including at least one convexity and at least one concavity, more specifically for removing the toner adhering to the convexity or convexities of the irregular surface of the non-fixing type image receiving sheet. Typically, the toner adhering to each the convexity in the irregular surface is removed in the convexity-cleaning method and device.

In one of preferred embodiments of the convexity-cleaning method and device, the toner adhering to the convexity or convexities of the non-fixing type image receiving sheet is removed as follows.

With a cleaning member, the toner adhering to the convexity or convexities of the image receiving sheet is removed.

When removing the toner, a contact surface of the cleaning member is brought into contact with the irregular surface of the non-fixing type image receiving sheet. More specifically, the contact surface of the cleaning member is brought into contact with the convexity or convexities of the irregular surface when removing the toner, so that the toner adhering to the convexity or convexities is transferred onto the contact surface of the cleaning member, and thereby the toner adhering to the convexity or convexities is removed.

The cleaning member may have a rotary form. The rotary form cleaning member may be a roller, an endless belt or the like having an endless surface that can be used as the contact surface to be brought into contact with the irregular surface. The endless belt as the cleaning member may be wound around two or more rollers. Instead of the above, the cleaning member may be a non-endless belt. The non-endless belt as the cleaning member may be such that one end portion thereof is wound around a first reel and the other end portion is wound around a second reel. Optionally, at least one tension roller or like rollers may be brought into contact with the non-endless belt.

When removing the toner adhering to the convexity or convexities, the non-fixing type image receiving sheet is moved relatively to the cleaning member while bringing the contact surface of the cleaning member into contact with the irregular surface. More specifically, the non-fixing type image receiving sheet is moved relatively to the cleaning member so that the non-fixing type image receiving sheet relatively passes a position opposed to the cleaning member when removing the toner, and the irregular surface of the non-fixing type image receiving sheet moves relatively to the cleaning member at a first surface moving speed when removing the toner. For example, the cleaning member is located in a stationary position, and only the non-fixing type image receiving sheet is moved when removing the toner. Instead, the image receiving sheet may be located in a stationary position, and only the cleaning member may be moved when removing the toner. Instead of the above, both the image receiving sheet and the cleaning member may be moved when removing the toner. Anyway, the image receiving sheet is moved relatively to the cleaning member when removing the toner, so that the cleaning member faces the irregular surface of the image receiving sheet successively from one end portion thereof to the other end portion in the relative moving direction of the image receiving sheet, and thereby the cleaning member can face all the convexities of the irregular surface of the non-fixing type image receiving sheet.

For moving the non-fixing type image receiving sheet relatively to the cleaning member in this way, the convexity-cleaning device has a first driving device. The first driving device can move the non-fixing type image receiving sheet relatively to the cleaning member so that the irregular surface of the non-fixing type image receiving sheet moves relatively to the cleaning member at the first surface moving speed.

When removing the toner adhering to the convexity or convexities, the contact surface of the cleaning member is moved in a predetermined direction at a second surface moving speed, while relatively moving the non-fixing type image receiving sheet to the cleaning member. The contact surface of the cleaning member may be moved in a direction parallel with a relative moving direction of the image receiving sheet with respect to the cleaning roller in a contact region where the contact surface of the cleaning member is in contact with the image receiving sheet.

In the case the cleaning member has the rotary form as described above, the contact surface of the cleaning member may be moved by rotating the cleaning member. In the case the cleaning member is the non-endless belt wound around the first and second reels at both end portions, the contact surface of the cleaning member (non-endless belt) may be moved by feeding the non-endless belt from one of the first and second reels to the other.

In any case, the contact surface region, coming into contact with the irregular surface of the non-fixing type image receiving sheet, of the cleaning memeber changes by moving the contact surface of the cleaning member. Thereby it is possible to suppress a return of the toner, that has been removed from the convexity or convexities of the irregular surface and has been transferred to the contact surface of the cleaning member, to the irregular surface of the non-fixing type image receiving sheet. The removed toner on the contact surface of the cleaning member may be removed therefrom, if necessary, e.g., with a cleaning blade in contact with the contact surface of the cleaning member.

For moving the contact surface of the cleaning member as described above, the convexity-cleaning device has the second driving device. The second driving device is capable of moving the contact surface of the cleaning member at the second surface moving speed.

In the preferred embodiment of the convexity-cleaning method and device, a difference is made between the first and second surface moving speeds. As described above, the first surface moving speed is the relative moving speed of the irregular surface of the non-fixing type image receiving sheet with respect to the cleaning member, and the second surface moving speed is the contact surface moving speed of the cleaning member.

The difference between the first and second surface moving speeds provides a good cleaning with little toner left on the convexity or convexities of the irregular surface while suppressing a disturbance of the toner image composed by the toner adhering to the concavity or concavities of the irregular surface of the non-fixing type image receiving sheet, compared with the case the first surface moving speed is equal to the second surface moving speed, as shown by experimental results described later.

The preferred embodiment of the convexity-cleaning method and device will be described in more detail.

(1) In the contact region where the cleaning member is in contact with the non-fixing type image receiving sheet, a moving direction of the contact surface of the cleaning member may be same as or opposite to a relative moving direction of the irregular surface of the non-fixing type image receiving sheet with respect to the cleaning member (a moving direction of the irregular surface of the non-fixing type image receiving sheet on the basis of the position of the cleaning member).

If these moving directions are same, a better convexity-cleaning can be achieved even when the first surface moving speed is only slightly different from the second surface moving speed, compared with the case these moving directions are opposite to each other, as shown by the experimental results described later.

(2) In the case the irregular surface of the non-fixing type image receiving sheet includes a plurality of the convexities each in a linear form extending in an extending direction, the non-fixing type image receiving sheet may be moved relatively to the cleaning member in a direction parallel with the extending direction of the linear convexities of the irregular surface when removing the toner.

This can provide a better cleaning compared with the case the non-fixing type image receiving sheet is moved relatively to the cleaning member in a direction crossing the extending direction of the linear convexities when removing the toner, as shown by the experimental results described later.

(3) The second surface moving speed (contact surface moving speed of the cleaning member) may be greater than the first surface moving speed (relative moving speed of the irregular surface of the non-fixing type image receiving sheet with respect to the cleaning member).

In other words, a surface moving speed ratio of the first and second surface moving speeds [=(second surface moving speed)/(first surface moving speed)] may be greater than 1. For example, the surface moving speed ratio may be 1.1 or more.

The toner adhering to the convexity or convexities can be removed while rubbing the convexity or convexities by the contact surface of the cleaning member if the surface moving speed ratio is greater than 1 in the case the moving direction of the contact surface of the cleaning member is same as the relative moving direction of the irregular surface of the non-fixing type image receiving sheet with respect to the cleaning member in the contact region where the cleaning member is in contact with the non-fixing type image receiving sheet. In this case, the toner is likely to unpreferably accumulate in the contact region where the image receiving sheet is in contact with the contact surface of the cleaning member carrying the toner that has been transferred from the convexities of the irregular surface if the surface moving speed ratio is less than 1.

(4) For preventing the disturbance of the toner image composed by the toner adhering to the concavity or concavities of the irregular surface of the non-fixing type image receiving sheet, desirably the cleaning member is not come into contact with the concavity and with the toner adhering to the concavity when removing the toner adhering to the convexity or convexities by bringing the cleaning member into contact with the convexity or convexities of the irregular surface. Therefore, the cleaning member is preferably free from projection, e.g., a brush portion of a brush roller, that would penetrate into the concavity of the irregular surface of the image receiving sheet.

(5) The cleaning member may have a surface layer made of, for example, metal or rubber. More specifically, the cleaning member may be a metallic roller, an endless or non-endless metallic belt, a rubber roller having a surface layer formed of rubber, or an endless or non-endless rubber belt having a surface layer formed of rubber.

In the case the metallic roller or metallic belt is employed as the cleaning member, the cleaning member may be electrically grounded when removing the toner adhering to the convexity or convexities of the irregular surface.

(6) Typically the toner is removed from the contact surface of the cleaning member before the contact surface portion of the cleaning member carrying the removed toner is come into contact with the image receiving sheet again, for preventing contamination of the image receiving sheet with the removed toner that has been transferred to the contact surface of the cleaning member from the convexity or convexities of the image receiving sheet, in the case the cleaning member has the rotary form or other case. In the case the cleaning member is the non-endless belt, the toner may be or may not be removed from the contact surface of the cleaning member.

The toner can be removed from the contact surface of the cleaning member, for example, by scraping off the toner therefrom with a cleaning blade that is in contact with the contact surface of the cleaning member. The convexity-cleaning device may be further provided with a removal device for removing the toner from the contact surface of the cleaning member, for example, in the above manner. The removal device may include the above cleaning blade.

In the case the toner is removed from the contact surface of the cleaning member with the cleaning blade, the toner can be removed more efficiently with the cleaning blade from the contact surface of the cleaning member if the contact surface is a smooth surface such as a metal surface, compared with the case the contact surface is a rubber surface. Therefore a surface layer providing the contact surface of the cleaning member is preferably formed of metal rather than rubber in the case the toner is removed from the contact surface of the cleaning member with the cleaning blade, and thereby the cleaning member may be the metallic roller or the endless or non-endless metallic belt in this case.

The toner removed from the contact surface of the cleaning member may be reused for forming the toner image on the image receiving sheet. The image forming apparatus having the convexity-cleaning device may be provided with a device for returning the toner removed from the contact surface of the cleaning member of the convexity-cleaning device to the toner image forming device for forming the toner image on the image receiving sheet.

(7) The convexity-cleaning device has, as described above, the first driving device for moving the non-fixing type image receiving sheet relatively to the cleaning member at the first surface moving speed and the second driving device for moving the contact surface of the cleaning member at the second surface moving speed.

The first and second driving devices may have one or more parts for use in common.

In the convexity-cleaning device, the difference between the first and second surface moving speeds may be achieved in the following manner. For example, in the case a common driving source (e.g., a motor) is used in the first and second driving devices, the difference between the first and second surface moving speeds can be made by adjusting a relationship between a speed reducing ratio in a first driving force transmitting system as follows and a second driving force transmitting system as follows. The first driving force transmitting system is a component of the first driving device, and is connected to the common driving source for relatively moving the non-fixing type image receiving sheet to the cleaning member. The second driving force transmitting system is a component of the second driving device, and is connected to the common driving source for moving the contact surface of the cleaning member. This manner can provide the compact and inexpensive convexity-cleaning device, because some parts (such as the common driving source) can be used in common between the first and second driving devices.

Instead of the above manner, the driving by the first driving device for relatively moving the non-fixing type image receiving sheet to the cleaning member may be performed independently of the driving by the second driving device for moving the contact surface of the cleaning member. In this case, the difference between the first and second surface moving speeds can be achieved by controlling the first surface moving speed with the first driving device, while controlling the second surface moving speed with the second driving device.

§3.1. Image Forming Apparatus

One of preferred embodiments of the image forming apparatus for forming the toner image on the irregular surface of the non-fixing type image receiving sheet is provided with (a) a toner image forming device for forming the toner image on the irregular surface of the non-fixing type image receiving sheet by removably adhering the toner to the irregular surface; and (b) the above-described preferable convexity-cleaning device.

What is described above on the convexity-cleaning method and device can be also true with the convexity-cleaning device in the above image forming apparatus.

According to the above image forming apparatus, the convexity-cleaning device can remove the toner adhering to the convexity or convexities of the irregular surface of the non-fixing type image receiving sheet with small amount of the toner left on the convexity or convexities while suppressing the disturbance of the toner image composed by the toner adhering to the concavity or concavities of the irregular surface. Consequently it is possible to suppress the contamination of another object (e.g., finger, another image receiving sheet or the like) to be come into contact with the non-fixing type image receiving sheet that carries the toner image formed by the above image forming apparatus.

The toner image forming device may be, for example, the same as one described in the section §2.

The image forming apparatus may be further provided with the removal device for removing the toner from the contact surface of the cleaning member of the convexity-cleaning device described above. The removal device may include the cleaning blade to be brought into contact with the contact surface of the cleaning member of the convexity-cleaning device. The image forming apparatus may be further provided with the returning device for returning the toner removed from the contact surface of the cleaning member of the convexity-cleaning device to the toner image forming device. With this returning device, the toner can be reused for formation of the toner images.

The image forming apparatus may be further provided with a sheet-cleaning device for removing the toner adhering to the irregular surface of the non-fixing type image receiving sheet, more specifically, for removing the toner adhering the convexity or convexities as well as the concavity or concavities of the irregular surface. With this sheet-cleaning device, the toner image formed on the irregular surface of the non-fixing type image receiving sheet can be removed therefrom. Thereby the non-fixing type image receiving sheet can be reused for formation of the toner image. Since the toner on the irregular surface merely adheres to the convexity and concavity and is not fixed thereto, the toner on the irregular surface can be easily removed, for example, by utilizing an electrostatic force or magnetic force in accordance with the property of the toner. The non-fixing type image receiving sheet can be easily reused as described above because the toner is not to be fixed thereto, unlike the conventional ordinary image receiving sheet such as paper.

§3.2.

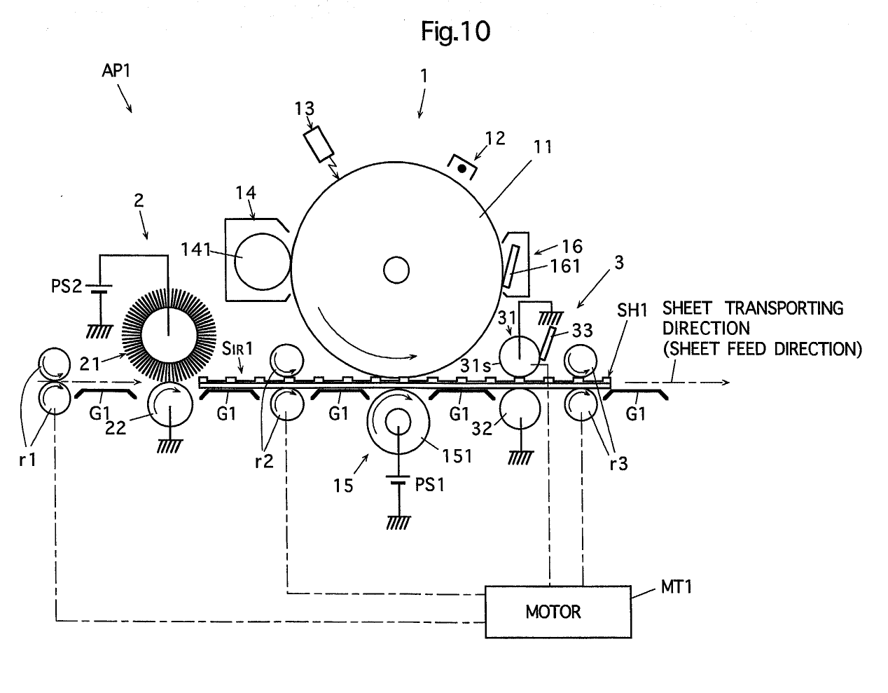

FIG. 10 shows a schematic structure of an example of the image forming apparatus. The image forming apparatus AP1 of FIG. 10 is provided with a convexity-cleaning device 3 for removing the toner adhering to the convexity or convexities of the irregular surface of the non-fixing type image receiving sheet by the above-mentioned convexity-cleaning method.

The image forming apparatus AP1 is further provided with a toner image forming device 1 for forming the toner image on the non-fixing type image receiving sheet, and a sheet-cleaning device 2 for removing the toner image already formed on the non-fixing type image receiving sheet before forming the toner image by the toner image forming device 1.

When forming the toner image on the irregular surface of the non-fixing type image receiving sheet by the image forming apparatus AP1, the image receiving sheet is transported along a predetermined sheet-transporting path as guided by guide members G1 or the like. The non-fixing type image receiving sheet is carried from, for example, a sheet tray (not shown) or a sheet cassette (not shown) for accommodating a plurality of the image receiving sheets toward a discharge tray (not shown) for accommodating the image receiving sheets carrying the toner images formed thereon. The toner image formation is effected on the non-fixing type image receiving sheet thus transported.

The non-fixing type image receiving sheet is transported by roller pairs r1 to r3 and the like arranged in positions opposed to the sheet-transporting path, so that the irregular surface of the image receiving sheet moves at the first surface moving speed. When transporting the image receiving sheet, the roller pairs r1 to r3 are driven to rotate in a predetermined direction at a predetermined speed by a motor MT1 via a driving force transmitting system (not shown) that includes a drive train including gears and/or belts. A drum-form photosensitive member 11 of the toner image forming device 1 and a transfer roller 151 opposed to the photosensitive member 11 also contribute to transportation of the image receiving sheet. The photosensitive member 11 and the transfer roller 151 are driven to rotate by the motor MT1 via the driving force transmitting system (not shown) in this embodiment.

The non-fixing type image receiving sheet thus transported at the predetermined sheet-transporting speed is successively subjected to a sheet cleaning processing by the sheet-cleaning device 2, a toner image forming processing by the toner image forming device 1, and a convexity-cleaning processing by the convexity-cleaning device 3 in this order. Description is given below about operations of these devices in the toner image formation process on the non-fixing type image receiving sheet SH1 shown in FIG. 1. The image forming apparatus AP1 can form the toner image not only on the non-fixing type image receiving sheet SH1 but also on any of the above-described non-fixing type image receiving sheets SH2 to SH4.

The image receiving sheet SH1 is firstly subjected to the following cleaning processing by the sheet cleaning device 2. The sheet cleaning device 2 is provided for removing the toner adhering to the concavities R and convexities P of the irregular surface S_{IR}1 of the image receiving sheet SH1. For making the image receiving sheet SH1 ready for the formation of the toner image by the toner image forming device 1, the toner on the irregular surface S_{IR}1 is removed by the sheet cleaning device 2. This is because the toner image is, in some times, already formed on the irregular surface S_{IR}1 of the image receiving sheet SH1 onto which from now the toner image is formed.

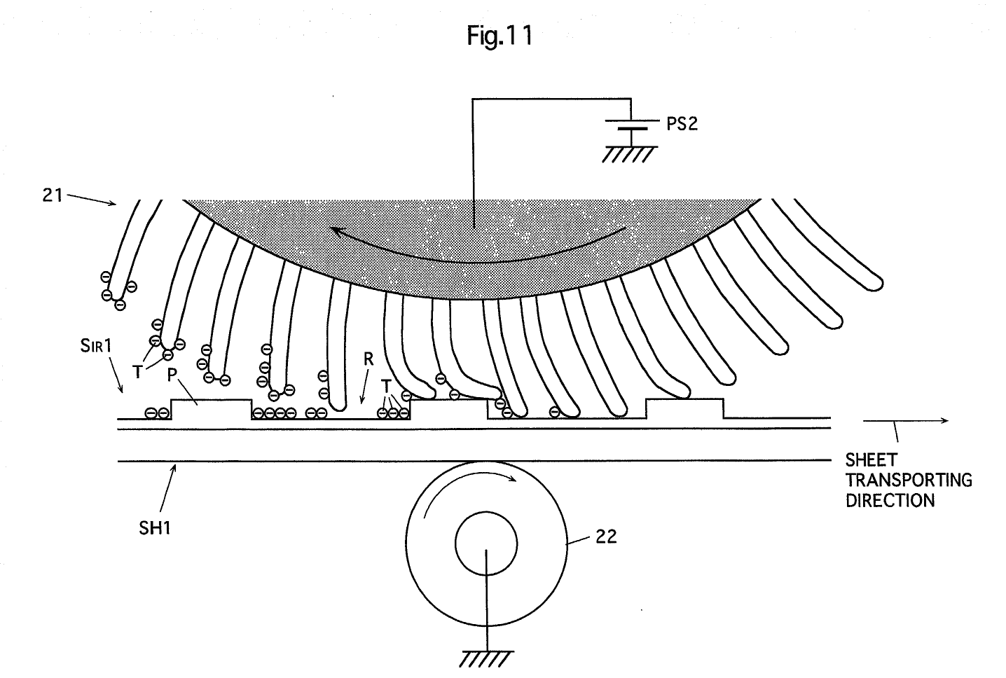

The sheet cleaning device 2 has an electrically conductive brush roller 21 connected to a power source PS2 and an electrically grounded platen roller 22. As shown in FIGS. 10 and 11, the brush roller 21 is supplied with a bias voltage having a polarity opposite to the charged polarity (negative polarity in this embodiment) of toner T on the irregular surface S_{IR}1 of the image receiving sheet SH1 from the power source PS2. By the electrostatic force derived from the bias voltage, the toner T adhering to the convexities P and concavities R of the irregular surface S_{IR}1 of the image receiving sheet SH1 (mainly the toner adhering to the concavities R) can be removed.

The charged toner T on the irregular surface S_{IR}1 of the image receiving sheet SH1 can be easily removed by the electrostatic force. The toner can be so easily removed because the toner composing the toner image is merely adhered to the irregular surface S_{IR}1 of the image receiving sheet SH1 without being fixed thereto. Because of this feature, the image receiving sheet SH1 can be repeatedly reused for formation of the toner image. The toner removed from the image receiving sheet may be reused for formation of the toner images in the toner image forming device 1.

After removal of the toner from the image receiving sheet SH1, the toner image is formed on the image receiving sheet by the toner image forming device 1.

The toner image forming device 1 can form the toner image on the image receiving sheet by electrophotographic method. The toner image forming device 1 has the photosensitive member 11 which is surrounded by a charger 12, an exposing device 13, a developing device 14, a transfer device 15 and a cleaning device 16.

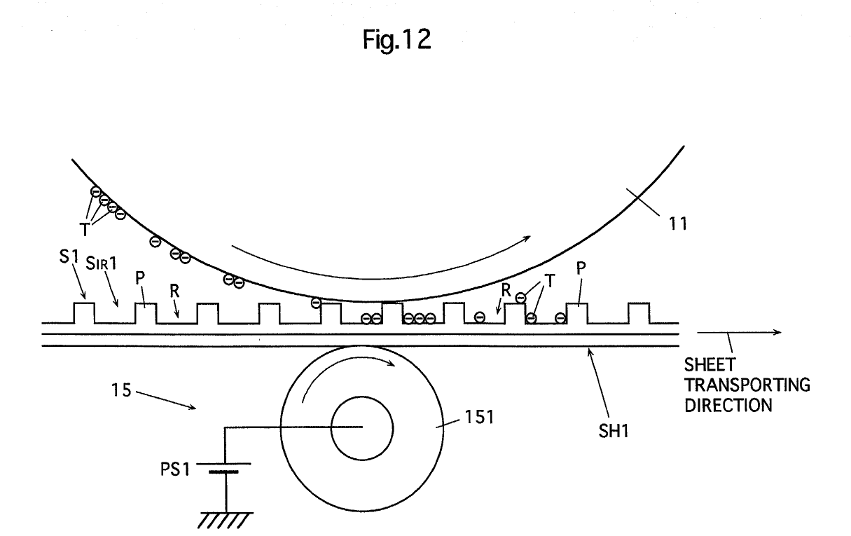

When forming the toner image on the image receiving sheet SH1, a surface of the photosensitive member 11 is uniformly charged by the charger 12 to have a predetermined potential, i.e. about −900V in this embodiment. Then, the charged surface of the photosensitive member 11 is exposed in accordance with a target image to be formed by the exposing device (laser device in this embodiment) to reduce the potential of the exposed surface region of the photosensitive member 11. In this embodiment, the potential of the surface region of the photosensitive member 11 irradiated with light rays is reduced to about −100V. Thereby an electrostatic latent image corresponding to the target image is formed on the surface of the photosensitive member 11. The electrostatic latent image is then developed with the charged toner having a predetermined polarity (negative polarity in this embodiment) by the developing device 14, so that the toner image corresponding to the target image is formed on the photosensitive member 11. In the developing device 14, a developing bias voltage (about −350V in this embodiment) is applied to a developing roller 141 carrying the charged toner, whereby the electrostatic latent image is developed. The toner image formed on the photosensitive member 11 is transferred onto the irregular surface of the image receiving sheet SH1 by the transfer device 15 having the transfer roller 151 opposed to the photosensitive member 11. In this transfer operation, the transfer roller 151 is supplied with a transfer bias voltage having a polarity opposite to the charged polarity (negative polarity in this embodiment) of toner T on the photosensitive member 11 from a power source PS1 as shown in FIGS. 10 and 12. The toner image on the photosensitive member 11 is electrostatically transferred to the irregular surface S_{IR}1 of the image receiving sheet SH1 by the transfer bias voltage. The toner remaining on the photosensitive member 11 without being transferred is removed from the photosensitive member 11 by a cleaning blade 161 of the cleaning device 16. The toner removed from the photosensitive member 11 may be reused for development by the developing device 14, in other words, for formation of the toner image by the toner image forming device 1.

After forming the toner image in this way on the irregular surface S_{IR}1 of the image receiving sheet SH1, the toner adheres to the convexity or convexities P of the irregular surface S_{IR}1 in the case the toner image is transferred to a position or positions corresponding to the convexity or convexities P of the irregular surface S_{IR}1. The toner adhering to the convexity or convexities P is easily transferred to another object (e.g., a finger, another image receiving sheet or the like) when the irregular surface S_{IR}1 comes into contact with the object. This means the toner adhering to the convexity or convexities P is likely to contaminate the object to be come into contact with the irregular surface S_{IR}1 of the non-fixing type image receiving sheet SH1. To suppress such a contamination of the other object with the toner, the toner adhering to each the convexity P is removed by the convexity-cleaning device 3.

The convexity-cleaning device 3 has a cleaning roller 31 and a platen roller 32 both arranged in positions facing the sheet-transporting path. These rollers 31, 32 are positioned in stationary positions in this embodiment. The rollers 31, 32 are both metallic rollers and are electrically grounded in this embodiment. In the convexity-cleaning process, the image receiving sheet SH1 is transported to pass between the rollers 31 and 32, so that a contact surface 31s of the cleaning roller 31 comes into contact with the irregular surface S_{IR}1, mainly the top portions of convexities P of irregular surface S_{IR}1 of the image receiving sheet SH1 when removing the toner from each of the convexities P.

When cleaning the convexities P, more specifically, when removing the toner adhering to each of the convexities P of the image receiving sheet SH1, the image receiving sheet SH1 is transported at the predetermined sheet-transporting speed by the driving device including the motor MT1. Since the cleaning roller 31 is in the stationary position, the image receiving sheet SH1 moves at the predetermined sheet-transporting speed relatively to the cleaning roller 31, so that the irregular surface S_{IR}1 including the convexities P of the image receiving sheet SH1 moves at the first surface moving speed (=sheet-transporting speed) relatively to the cleaning roller 31 when removing the toner.

When cleaning the convexities P, the cleaning roller 31 is driven to rotate in a predetermined direction at a predetermined speed, so that the contact surface 31s of the cleaning roller 31 moves in a predetermined direction at the second surface moving speed. The cleaning roller 31 is driven to rotate by the motor MT1 via the driving force transmitting system (not shown).

The cleaning roller 31 may be driven to rotate either clockwise or counterclockwise in FIG. 10. More specifically, the cleaning roller 31 may be driven to rotate clockwise in FIG. 10, so that the contact surface 31s of the cleaning roller 31 moves in a direction opposite to the sheet feed direction in a contact region where the contact surface 31s is in contact with the image receiving sheet SH1. Alternatively the cleaning roller 31 may be driven to rotate counterclockwise in FIG. 10, so that the contact surface 31s of the cleaning roller 31 moves in the same direction as the sheet feed direction in the contact region where the contact surface 31s is in contact with the image receiving sheet SH1. The platen roller 32 may be rotated, for example, in accordance with the movement of the image receiving sheet SH1 and the movement of the contact surface 31s of the cleaning roller 31.

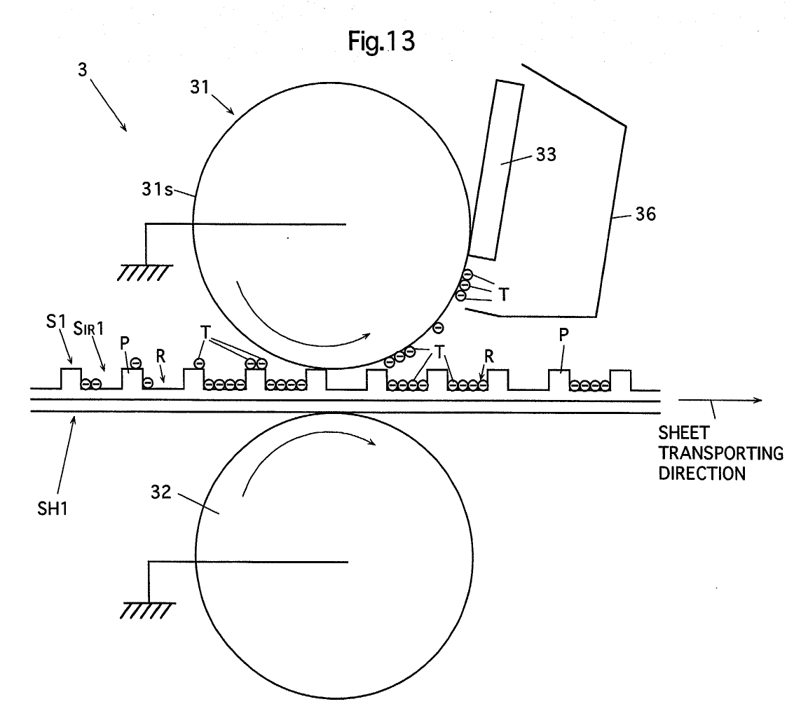

By bringing the contact surface 31s of the cleaning roller 31, that is driven to rotate in the predetermined direction, into contact with the convexity or convexities P of the irregular surface S_{IR}1 of the image receiving sheet SH1 that is transported in the sheet feed direction, the convexity or convexities P is rubbed by the contact surface 31s of the cleaning roller 31, and thereby the toner T adhering to the convexities P is transferred to the contact surface 31s so that the toner T is removed from the convexities P as shown in FIG. 13. In FIG. 13, the cleaning roller 31 is driven to rotate in such a direction that the contact surface 31s of the cleaning roller 31 moves in the same direction as the sheet feed direction of the image receiving sheet SH1 in the contact region where the cleaning roller 31 is in contact with the image receiving sheet SH1. The toner T removed from the convexities P and held on the surface 31s of the cleaning roller 31 is scraped off by a cleaning blade 33 in contact with the surface 31s before the region, holding the removed toner, of the surface 31s comes again into contact with the image receiving sheet SH1. The toner T removed from the cleaning roller 31 is accommodated in a toner container 36 (see FIG. 13, not shown in FIG. 10). The toner T removed from the cleaning roller 31 may be reused for formation of the toner images in the toner image forming device 1.

In the image receiving sheet SH1 carrying the toner image formed thereon in this way, the toner composing the toner image is accommodated in the concavity or concavities R of the irregular surface S_{IR}1, and is protected by the convexities P of the irregular surface S_{IR}1. Consequently unless an extraordinary external force is exerted, the toner image formed on the image receiving sheet can maintain the required state of the toner image, although the toner image is merely adhered to the image receiving sheet and is not fixed thereto by heating which is performed in the conventional image forming method. Slight external force applied on the irregular surface S_{IR}1 is unlikely to cause undesirable incidents such as marked disturbance of the toner image formed on the irregular surface S_{IR}1, and a transferring of the toner from the image receiving sheet SH1 to a rear side of another image receiving sheet overlaid thereon. The slight external force may be applied on the irregular surface S_{IR}1, for example, when looking at the toner image on the image receiving sheet SH1, when storing the image receiving sheets SH1, when moving the image receiving sheet SH1, when the image receiving sheet SH1 comes into contact with another image receiving sheet, or when touching the image receiving sheet SH1 with a finger. Moreover, the toner on the irregular surface S_{IR}1 is merely adhered thereto, and thereby can be separated and removed therefrom, so that the image receiving sheet SH1 from which the toner is removed as well as the removed toner can be reused.

In a preferred convexity-cleaning method and device, a difference is made between the first and second surface moving speeds whether the contact surface 31s of the cleaning roller 31 is moved in the direction as same as or opposite to the moving direction of the irregular surface S_{IR}1 of the image receiving sheet SH1 (sheet feed direction in this embodiment). As described above, the first surface moving speed is the moving speed of the irregular surface S_{IR}1 of the image receiving sheet SH1 that is transported when removing the toner on the convexities P. The second surface moving speed is the moving speed of the contact surface 31s of the cleaning roller 31 when removing the toner. Typically the second surface moving speed of the contact surface 31s of the cleaning roller 31 is greater than the first surface moving speed of the irregular surface S_{IR}1 of the image receiving sheet SH1.

In the image forming apparatus AP1, the difference between the first surface moving speed of the irregular surface S_{IR}1 and the second surface moving speed of the contact surface 31s is made by adjusting the relationship between a speed reducing ratio in a driving force transmitting system laid from the motor MT1 to the roller pairs r1 to r3 for transporting the image receiving sheet SH1 and a speed reducing ratio in a driving force transmitting system laid from the motor MT1 to the cleaning roller 31 for rotationally driving the cleaning roller 31.

The difference between the first and second surface moving speeds achieved in this way provides a good removal of the toner from the convexities P with small amount of the toner left on the convexities P while suppressing the disturbance of the toner image composed of the toner adhering to the concavity or concavities R of the image receiving sheet SH1, as shown in the experimental results described later.

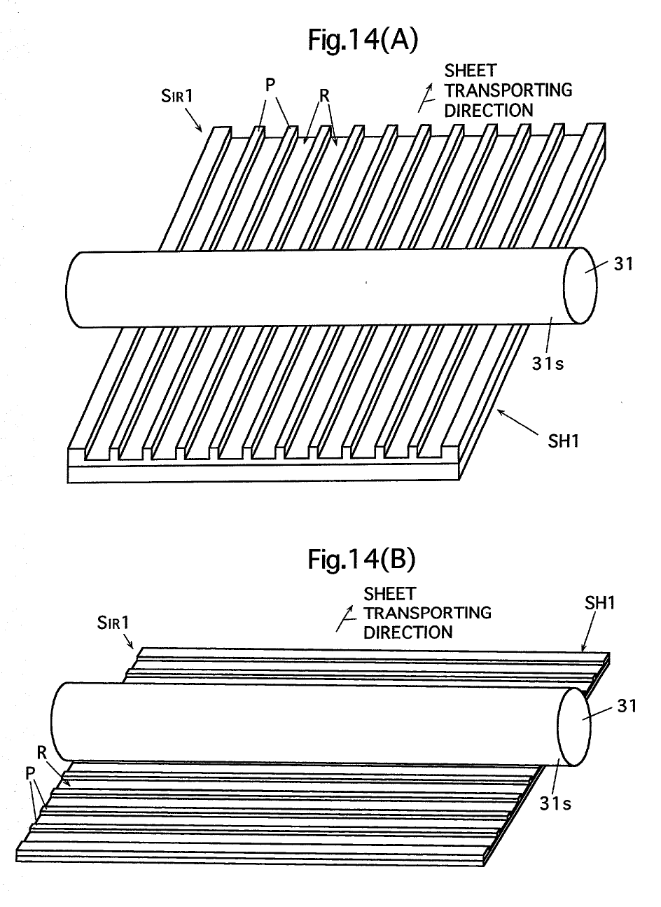

In FIGS. 10 to 13, as also shown in FIG. 14(B), the image receiving sheet SH1 is transported to move in a direction perpendicular to the extending direction of convexities P. Alternatively, the image receiving sheet SH1 may be transported to move in a direction parallel with the extending direction of convexities P as shown in FIG. 14(A). A better convexity-cleaning can be performed when the image receiving sheet SH1 is transported to move in the direction parallel with the extending direction of convexities P than when the image receiving sheet SH1 is transported to move the direction perpendicular to the extending direction of convexities P, as shown in the experimental results described later.

§3.3. Experiments of Convexity-Cleaning

Experiments were carried out to study the convexity-cleaning properties. In those experiments, the convexities of the irregular surface of the non-fixing type image receiving sheet was cleaned after forming the toner image on the irregular surface using the same type image forming apparatus as that shown in FIG. 10. The manners and results of the experiments are described below.

In the experiments, the image receiving sheets SH1 of FIG. 1 were used. The image receiving sheets SH1 used in the experiments had the sizes described hereinbefore. The toner used in the experiments had an average particle size of 10 μm.

The image receiving sheet SH1 was transported to move (1) in the direction parallel with the extending direction of convexities P as shown in FIG. 14(A), or (2) in the direction perpendicular to the extending direction of convexities P as shown in FIG. 14(B).

The first surface moving speed of the irregular surface of the image receiving sheet with respect to the cleaning roller 31 (i.e., transporting speed of the image receiving sheet SH1) was 50 mm/sec.

The cleaning roller 31 was driven to rotate so that the contact surface 31s of the cleaning roller moved (1) in the same direction as the sheet feed direction of the image receiving sheet SH1, or (2) in a direction opposite to the sheet feed direction, in the contact region where the contact surface 31s was in contact with the image receiving sheet SH1.

The second surface moving speed of the contact surface 31s of the cleaning roller 31 was selectively set to (1) 50 mm/sec, (2) 55 mm/sec, (3) 100 mm/sec, or (4) 200 mm/sec. In other words, the surface moving speed ratio between the first and second surface moving speeds [=(second surface moving speed)/(first surface moving speed) (surface moving speed of the contact surface 31s of the cleaning member)/(surface moving speed of the irregular surface)] was selectively set to 1.0, 1.1, 2.0 or 4.0.

Experiments were performed under combinations of these conditions. After cleaning the convexities with the convexity-cleaning device 3, the convexities P of the image receiving sheet SH1 were observed under a microscope to evaluate the degree of cleaning in terms of the presence or absence of toner remaining on the convexities P. The toner image was visually inspected to check the disturbance of the toner image composed by the toner adhering to the concavities R.

The results are shown in the following Table 1.

TABLE 1

| Relationship *1 | | parallel | | crossing | |
|---|---|---|---|---|---|
| Relationship *2 | | same | opposite | same | opposite |
| Speed Ratio *3 | 1.0 | Δ | Δ | Δ | Δ |
| | 1.1 | ◯ | Δ | Δ | Δ |
| | 2.0 | ◯ | Δ | Δ | Δ |
| | 4.0 | ◯ | ◯ | Δ | Δ |

Relationship *1: Direction relationship between the moving direction of the irregular surface of the image receiving sheet and the extending direction of convexities of the image receiving sheet.
Relationship *2: Direction relationship between the moving direction of the contact surface of the cleaning roller and the moving direction of the irregular surface of the image receiving sheet.
Speed ratio *3: Speed ratio between the first and second surface moving speeds.

In Table 1, ◯ means that no toner remained on the convexities of the image receiving sheet, and the disturbance of the toner image composed of the toner adhering to the concavities was not occurred. Δ means that the disturbance of toner image composed of the toner adhering to the concavities was not occurred, but a small amount of the toner remained on the convexities of the image receiving sheet although the toner did not remain to such an extent that the remaining toner significantly hinder the observation of the toner image composed of the toner adhering to the concavities.

The following is apparent from Table 1. In the case the speed ratio is 1, that is, in the case the moving speed of the contact surface of the cleaning roller is same as the moving speed of the irregular surface of the image receiving sheet, the toner would remain on convexities however the other conditions may be changed. The higher speed ratio (i.e., the greater surface moving speed difference) provides better cleaning capability (less toner left on the convexities). Better convexity cleaning can be performed even if the speed ratio (difference between the first and second surface moving speeds) is low in the case the moving direction of the contact surface of the cleaning roller is same as the moving direction of the irregular surface of the image receiving sheet, compared with the case these moving direction are opposite to each other.

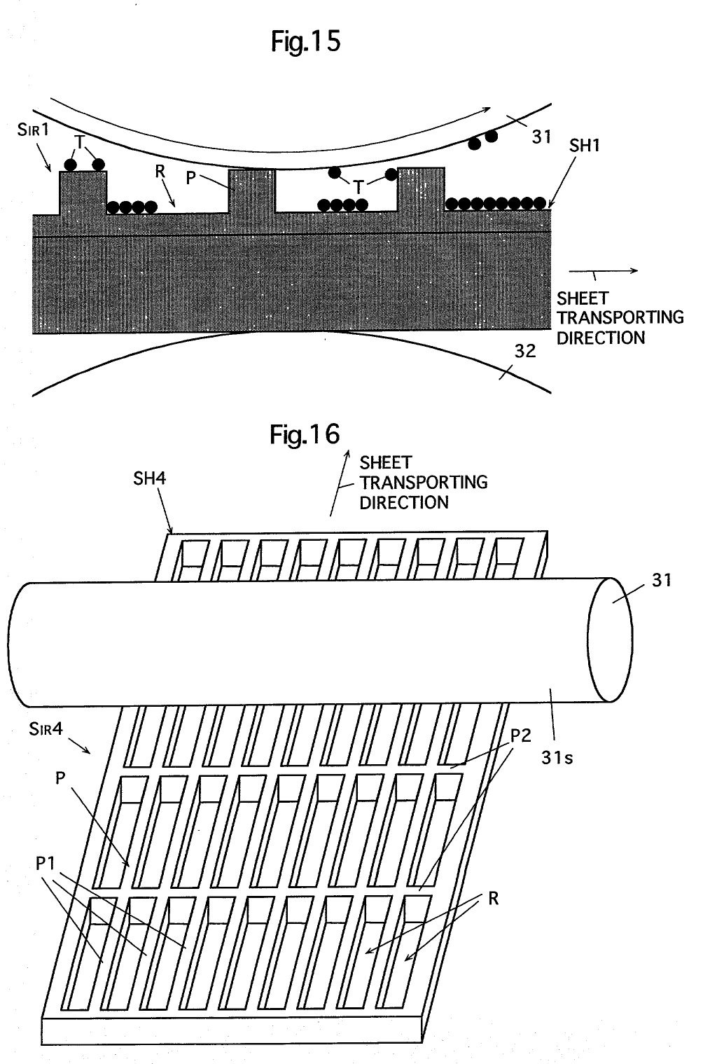

A better convexity cleaning can be accomplished when the image receiving sheet SH1 is moved in the direction parallel with the extending direction of the convexities P than when the image receiving sheet SH1 is moved in the direction perpendicular to the extending direction of convexities P. The toner T was left on an edge portion of the convexity P (a mouth portion of the concavity R) as shown in FIG. 15, and a thin line of the toner extending along the linear convexity P was made as a whole accordingly when the image receiving sheet SH1 was moved in the direction perpendicular to the extending direction of convexities P, although the toner remaining on the convexities did not affect the observation of the toner image to such an extent that the remained toner significantly hinder the observation of the toner image composed of the toner adhering to the concavities.

In the case of cleaning the convexities of the image receiving sheet SH4 having an irregular surface S_{IR}4 including the lattice-pattern convexity P as shown in FIG. 6(J), the influence of the toner remaining on the convexities P can be lessened by moving the image receiving sheet SH4 in a direction shown in FIG. 16. More specifically, the influence of the toner remaining on the convexities P can be diminished when the sheet feed direction of the image receiving sheet SH4 crosses the extending direction of linear portions, that has a greater arrangement pitch among the linear portions P1 and P2, of the lattice-form convexity P. Since the second linear portions P2 has a greater pitch than the first linear portions P1, the influence of the toner remaining on the convexities P can be diminished when the sheet feed direction of the image receiving sheet SH4 crosses the extending direction of linear portions P2 as shown in FIG. 16. Since the number of the second linear portions P2 is less than the number of the first linear portions P1 (the total distance of the second linear portions P2 is shorter than that of the first linear portions P1), the influence of the toner remaining on the lattice-form convexity P can be lowered. The transportation of the image receiving sheet SH4 in the above direction is especially effectively in the case a great difference exists between the pitch of the first linear portions P1 and that of the second linear portions P2, for example, in the case the spacing distance between the neighboring first linear portions P1 is about 20 μm to about 500 μm, and the spacing distance of the neighboring second linear portions P2 is about 10 mm to about 100 mm.

§3.4.

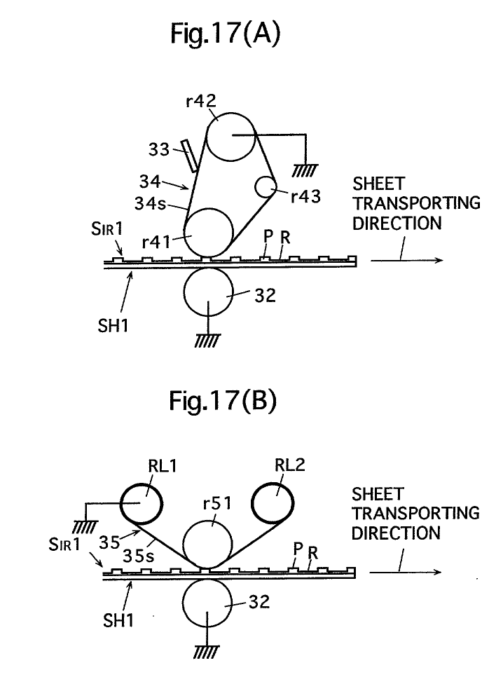

In the convexity-cleaning device, the cleaning member to be brought into contact with the irregular surface of the image receiving sheet may be an endless belt 34 of FIG. 17(A) or a non-endless belt 35 of FIG. 17(B) instead of the roller 31 of FIG. 10.

The endless belt 34 of FIG. 17(A) as the cleaning member is wound around three rollers r41 to r43. The belt 34 is made of metal in this embodiment. When removing the toner adhering to convexities of the image receiving sheet, a surface 34s of the belt 34 is brought into contact with the image receiving sheet moving in the sheet feed direction. Further, one of the rollers r41 to r43 is driven to rotate in a predetermined direction to move the contact surface 34s of the belt 34 in a predetermined direction when removing the toner adhering to the convexities of the image receiving sheet.

The non-endless belt 35 of FIG. 17(B) as the cleaning member is wound around reels RL1, RL2 at both ends. The belt 34 is made of metal in the this embodiment. A roller r51 is in contact with the belt 35 in a position opposed to a platen roller 32. When removing the toner adhering to convexities of the image receiving sheet, a surface 35s of the belt 35 is brought into contact with the irregular surface of the image receiving sheet moving in the sheet feed direction. Further, the belt is wound from one of the reels RL1 and RL2 to the other to move the contact surface 35s of the belt 35 in a predetermined direction when removing the toner adhering to the convexities of the image receiving sheet. When the belt to be fed comes to an end on a delivery side reel by moving the surface 35s of the belt 35 in the predetermined direction, for example, an unit of reels and the belt 35 may be exchanged for a new unit.

Even when the belt 34 or 35 is employed as the cleaning member, a good convexity-cleaning operation can be performed while suppressing the disturbance of toner image composed of the toner adhering to the concavities by making a difference between the moving speed of the contact surface of the belt and the moving speed of the irregular surface of the image receiving sheet, like in the case of using the roller 31 as the cleaning member.

§4. Convexity-Cleaning Method, Image Forming Method and Non-Fixing Type Image Receiving Sheet

For smoothly and efficiently removing the toner adhering to the convexity or convexities of the non-fixing type image receiving sheet, the inventors wholeheartedly studied to find the following.

Various cleaning methods can be employed for removing the toner from the convexities of the non-fixing type image receiving sheet. A simple cleaning method is to use a cleaning roller to be brought into contact with the convexity or convexities of the irregular surface while rotating the cleaning roller.

The toner adhering to a top portion of the convexity of the image receiving sheet can be more efficiently removed (cleaned) in the case a mutual adhesion force between the contact surface of the cleaning roller and the toner adhering to the top portion of the convexity is greater than a mutual adhesion force between the top portion of the convexity and the toner adhering thereto, compared with the case the former is smaller than the latter, assumed that the following factors are constant: the sheet-transporting speed, the rotation direction of the cleaning roller to be brought into contact with the convexity of the image receiving sheet (e.g., in the same direction as the sheet feed direction in the contact region where the cleaning roller is in contact with the image receiving sheet), and the surface moving speed of the cleaning roller in the contact region with the image receiving sheet.

The mutual adhesion force between the contact surface of the cleaning roller and the toner as well as the mutual adhesion force between the top portion of the convexity and the toner tend to be governed mainly by a Van Der Waals force, an electrostatic attracting force and a water bridging force. A center line average height (center line average) of the top portion of the convexity of the image receiving sheet also affects the adhesion force. The water bridging force occurs due to surface tension of water in liquid produced by condensation of water in the air at a boundary region where the toner is in contact with the top portion of the convexity of the image receiving sheet and at a boundary region where the toner is in contact with the surface of cleaning roller. The greater water bridging force provides the higher mutual adhesion force with the toner.

Based on these findings, the following four types of the preferred convexity-cleaning methods for cleaning the convexity of the non-fixing type image receiving sheet; the following preferred image forming method; and the following preferred non-fixing type image receiving sheet are completed. The toner can be smoothly removed using the cleaning roller from the top portion of the convexity of the non-fixing type image receiving sheet according to any types of the following convexity-cleaning methods.

(1) Convexity-Cleaning Method

The following preferred convexity-cleaning method is for cleaning the convexity or convexities of the irregular surface of the non-fixing type image receiving sheet. The irregular surface includes at least one concavity for receiving toner and at least one convexity for protecting the toner received in the concavity. The non-fixing type image receiving sheet is for carrying the toner image to be formed on the irregular surface by removably adhering the toner to the concavity or concavities of the irregular surface.

In any of the following preferred convexity-cleaning methods, the toner adhering to a top portion or top portions of the convexity or convexities is removed with a cleaning roller having a contact surface to be in contact with the at least one top portion of the convexity, and thereby the convexity of the irregular surface of the non-fixing type image receiving sheet carrying the toner image formed thereon is cleaned. When removing the toner, the contact surface of the cleaning roller is brought into contact with at least one top portion of the convexity while rotating the cleaning roller.

(1-1) First Type Preferred Convexity-Cleaning Method

In the first type preferred convexity-cleaning method, the top portion of the convexity of the non-fixing type image receiving sheet and the contact surface of the cleaning roller satisfy: F_{w}<F_{w}2, where F_{w}1 is Van Der Waals force between the top portion of the convexity and the toner adhering thereto, and F_{w}2 is Van Der Waals force between the contact surface of the cleaning roller and the toner adhering to the top portion of the convexity.

In other words, a combination of a material of the top portion of the convexity and a material of the contact surface of the cleaning roller (or a combination of a material of the top portion of the convexity, a material of the contact surface of the cleaning roller and a material of the toner) satisfying F_{w}1<F_{w}2 is employed in the first type preferred convexity-cleaning method.

For fulfilling the condition of F_{w}1<F_{w}2, the top portion of the convexity of the non-fixing type image receiving sheet and the contact surface of the cleaning roller may satisfy: (1+cos θ₁)²<(1+cos θ₂)², where θ₁ is an angle of contact between the top portion of the convexity and diiodomethane (CH₂I₂), and θ₂ is an angle of contact between the contact surface of the cleaning roller and diiodomethane (CH₂I₂). In other words, a combination of a material of the top portion of the convexity and a material of the contact surface of the cleaning roller satisfying the condition of [(1+cos θ₁)²<(1+cos θ₂)²] may be employed for fulfilling the condition of F_{w}1<F_{w}2.

Thereby these Van Der Waals force obtained by the equation of Lifshitz satisfy the condition of F_{w}1<F_{w}2.

By the way, the Lifshitz-Van Der Waals force is represented by the following equation:

Van Der Waals force Fv=h/8πz₁²·d (1+δ/z₁) h=8π²·z₂²·σL·(1+cos θ)²

where h is Lifshitz Van Der Waals constant, z₂ is contact distance with CH₂I₂, δ is quantity of deformation, σL is surface tension of CH₂I₂, z₁ is distance between objects, and d is a converted particle diameter.

A Hamaker constant of the top portion of the convexity may be lower than a Hamaker constant of the contact surface of the cleaning roller. In other words, a Hamaker constant of the top portion material of the convexity may be lower than a Hamaker constant of the contact surface material of the cleaning roller. Thereby the equation of Van Der Waals force of Hamaker fulfills the condition of F_{w}1<F_{w}2.

Hamaker-Van Der Waals force can be represented by the following equation.

In the case wherein the surfaces of objects which are attracted by each other are smooth:

Van Der Waals force Fv=A·d/12z²

where A is Hamaker constant, d is converted particle diameter, z is the closest distance (0.4 nm).

In the case where the surfaces of objects which are attracted by each other are rough:

Van Der Waals force Fvb=A·d/12z²·[z/(z+b)]²

where b is an average value [(b1+b2)/2] of surface roughness of the two objects attracting to each other due to Van Der Waals force.

(1-2) Second Type Preferred Convexity-Cleaning Method

In the second type preferred convexity-cleaning method, the top portion of the convexity of the non-fixing type image receiving sheet and the contact surface of the cleaning roller satisfy: Fₑ1<Fₑ2, where Fₑ1 is an electrostatic attracting force between the top portion of the convexity and the toner adhering thereto, and Fₑ2 is an electrostatic attracting force between the contact surface of the cleaning roller and the toner adhering to the top portion of the convexity.

In other words, a combination of a material of the top portion of the convexity and a material of the contact surface of the cleaning roller (or a combination of a material of the top portion of the convexity, a material of the contact surface of the cleaning roller and a material of the toner) satisfying Fₑ1<Fₑ2 is employed.

The electrostatic force may be an attraction force of the toner due to its charging, and a contact potential difference force at the convexity of the non-fixing type image receiving sheet (or at the contact surface of the cleaning roller) when the toner is not charged.

When the toner is charged, an image force Fei represented by the following equation acts.

Fei=−π/4∈₀·(∈−∈₀)/(∈+∈₀)·d²·σ²

where ∈ is a dielectric constant of vacuum, ∈ is a dielectric constant of object to be adhered (adhered object), d is a converted particle diameter, σ is a surface charge density of the adhering object.

The contact potential difference force is a force generated by contact potential difference when two different objects come into contact with each other. The contact potential difference of organic material such as a polymer for the toner may be considered to correspond to the difference of work function in metals, and is generally expressed in charge-series. However, the magnitude of the contact potential difference is not expressed by the order of charge-series, and requires experimental evaluation. For example, the magnitude of the contact potential difference can be evaluated based on a polarity of difference ΔV (=V1−V0), where a surface potential V0 and a surface potential V1 are as follows: the toner is brought to adhere to an object, then the charged toner on the object is discharged by a discharger, and at this time the object has the surface potential of V0, and thereafter the toner is removed by an air gun, and at this time the object has the surface potential of V1.

The relationship of [(adhesion force between the top portion of the convexity and the toner)]<(adhesion force between the cleaning roller and the toner)] can be fulfilled by satisfying the relationship as follows: the inherent chargeable polarity of the toner particle is same as the polarity of ΔV of the top portion of the convexity of the non-fixing type image receiving sheet, and the inherent chargeable polarity of the toner particle is different from the polarity of ΔV of the cleaning roller.

Accordingly, the condition of Fₑ1<Fₑ2 can be fulfilled in the case where the dielectric constant of the top portion of the convexity (material of the convexity top portion) of the non-fixing type image receiving sheet is lower than the dielectric constant of the contact surface of the cleaning roller (material of the cleaning roller contact surface).

The condition of Fₑ1<Fₑ2 can be also fulfilled in the case where a charged polarity of the toner when forming the toner image on the non-fixing type image receiving sheet is same as a charged polarity of the toner when the toner comes into contact with the top portion of the convexity, and is different from a charged polarity of the toner when the toner comes into contact with the contact surface of the cleaning roller.

(1-3) Third Type Preferred Convexity-Cleaning Method

In the third type preferred convexity-cleaning method, the top portion of the convexity of the non-fixing type image receiving sheet and the contact surface of the cleaning roller satisfy: F_{b}1<F_{b}2, where F_{b}1 is a water bridging force between the top portion of the convexity and the toner adhering thereto, and F_{b}2 is a water bridging force between the contact surface of the cleaning roller and the toner adhering to the top portion of the convexity.

In other words, a combination of a material of the top portion of the convexity and a material of the contact surface of the cleaning roller (or a combination of a material of the top portion of the convexity, a material of the contact surface of the cleaning roller and a material of the toner) satisfying F_{b}1<F_{b}2 is employed.

The water bridging force is assumed to scarcely affect the convexity-cleaning operation since the convexity-cleaning is usually performed short time after the transfer of the toner image onto the non-fixing type image receiving sheet, but seriously affects jamming of the sheet or the like.

The magnitude of water bridging force FL is determined in accordance with the magnitude of contact angle of water as evident from the following equation.

FL=2π·d·γL·cos θ

where d is converted particle diameter, γL is surface tension of water, and θ is the contact angle of water.

The condition of F_{b}1<F_{b}2 can be fulfilled by satisfying the relationship as follows: a contact angle between water and the top portion of the convexity is smaller than a contact angle between water and the contact surface of the cleaning roller.

(1-4) Fourth Type Preferred Convexity-Cleaning Method

In the fourth type preferred convexity-cleaning method, used for toner image formation is such a non-fixing type image receiving sheet that a surface of the top portion of the convexity of the non-fixing type image receiving sheet has a center line average height in the range of 0.2 μm to 1.0 μm.

The adhesion force between the top portion of the convexity and the toner depends on the material of the top portion of the convexity and the like, and thereby is variable. At any rate, the toner particle used in forming the toner image on the non-fixing type image receiving sheet may have a particle size of about 1 μm to about 20 μm. In view of the above, the Van Der Waals force is increased if the top portion of the convexity has an excessively small surface roughness and thereby is a flat smooth surface, whereas if the top portion of the convexity has an excessively great surface roughness, the contact point between the toner and the top portion of the convexity is presumed to have a flat smooth surface.

Accordingly, although the Van Der Waals force and the material of the convexity are to be considered in order to carry out the convexity-cleaning operation efficiently, the surface of the top portion of the convexity of the non-fixing type image receiving sheet preferably has the center line average height in the range of about 0.2 μm to about 1.0 μm.

A combination of two or more of the above four types of the preferred convexity-cleaning methods may be employed.

(2) Image Forming Method

The preferred image forming method for forming the toner image on the non-fixing type image receiving sheet, including the steps of: (a) forming the toner image on the irregular surface of the non-fixing type image receiving sheet by removably adhering the toner to the concavity or concavities; and (b) removing the toner adhering to a top portion of the convexity of the non-fixing type image receiving sheet by implementing one or combination of the first to fourth types of the above-mentioned preferred convexity-cleaning method after forming the toner image on the irregular surface.

(3) Non-Fixing Type Image Receiving Sheet

In the preferred non-fixing type image receiving sheet having an irregular surface for carrying a toner image to be formed thereon, the irregular surface includes at least one concavity for receiving toner and at least one convexity for protecting the toner adhering to the concavity, and a surface of the top portion of the convexity of the non-fixing type image receiving sheet has a center line average height in the range of 0.2 μm to 1.0 μm.

§4.1.

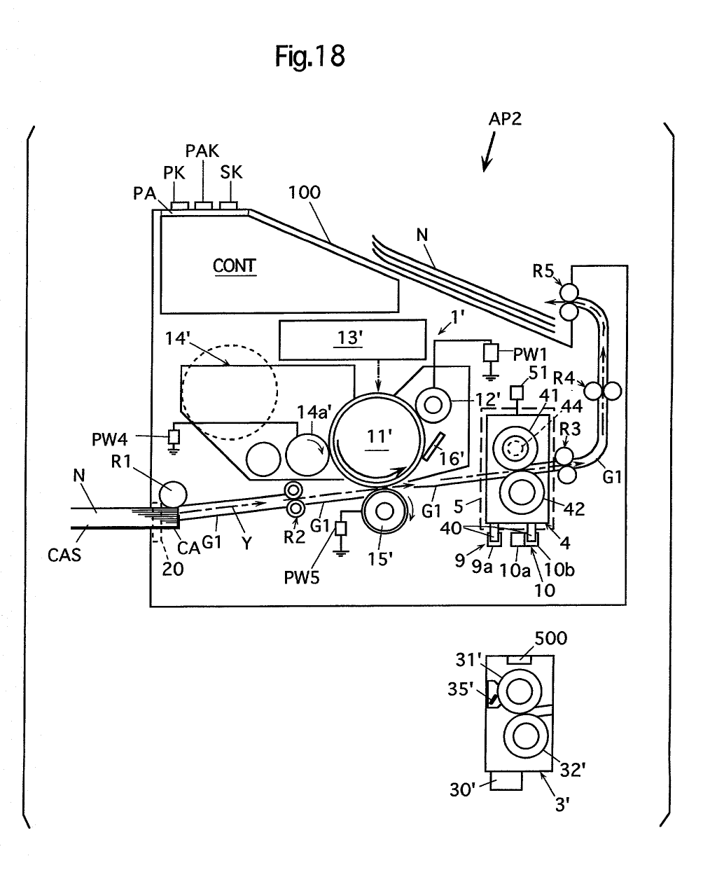

The above-mentioned preferred convexity-cleaning methods and image forming methods can be implemented, for example, on one of the foregoing non-fixing type image receiving sheets SH1-SH4, for example, in one of the above-described image forming apparatus AP1 of FIG. 10 and the image forming apparatus AP2 of FIG. 18 to be described later.

For example, the toner T adhering to the convexities P of the non-fixing type image receiving sheet SH3 of FIG. 7 can be more efficiently cleaned when the mutual adhesion force between the contact surface 31s of the cleaning roller 31 of the convexity-cleaning device 3 in the image forming apparatus AP1 of FIG. 10 and the toner T is greater than the mutual adhesion force between the top portion of the convexity P and the toner T adhering thereto as described above. For this purpose, at least one of the above-mentioned preferred convexity-cleaning methods may be employed. Any of the above-mentioned preferred convexity-cleaning methods allows smooth removal of the toner T adhering to the top portions of the convexities P of the non-fixing type image receiving sheet SH3.

§4.2. Experiments

Experiments reporting the implementation of convexity-cleaning operations are described below.

The toner T used in any of the experiments were as follows.

Material of toner: thermoplastic polyester resin

Charged polarity of the toner used for forming the toner image (inherent chargeable polarity of the toner): negative

Average particle size of the toner: 10 μm

In any of the experiments, the angle of contact was measured with a contact angle meter CA-X type, manufactured by Kyowa Interface Science Co., Ltd. The surface roughness was measured by a surface shape measuring microscope VF7500, manufactured by Keyence Corporation.

(1) Experiment Example 1

Material of top portion of convexity P of non-fixing type image receiving sheet: PP (P2102, manufactured by Toyobo Co., Ltd.)

Center line average height Ra of convexity P: 0.90 μm

Material of the contact surface of cleaning roller 31: stainless steel

In this case, the relationship of:

(1+cos θ)²=2.5<(1+cos θ₂)²=2.9

was established, where the angle of contact θ₁ (θ₁=54 degrees) between the top portion of the convexity and diiodomethane (CH₂I₂), and the angle of contact θ₂ (θ₂=46 degrees) between the contact surface of the cleaning roller 31 and diiodomethane (CH₂I₂). Thereby the relationship of F_{w}1<F_{w}2 was established between F_{w}1 and F_{w}2, where F_{w}1 is Van Der Waals force by the equation of Lifshitz between the top portion of the convexity and the toner, and F_{w}2 is Van Der Waals force by the equation of Lifshitz between the contact surface of the cleaning roller and the toner. Thereby the top portions of the convexities were smoothly cleaned.

(2) Experiment Example 2

Material of top portion of convexity P of non-fixing type image receiving sheet: PE (HS-30, manufactured by Toyobo Co., Ltd.)

Dielectric constant of top portion of convexity P of image receiving sheet: 2.3 (60 Hz)

Center line average height Ra of convexity P: 0.81 μm

Material of contact surface of cleaning roller 31: urethane resin

Dielectric constant of material of contact surface of cleaning roller 31: 6.2 (60 Hz)

The relationship of Fₑ1<Fₑ2 was established between Fₑ1 and Fₑ2, where Fₑ1 is the electrostatic attracting force between the top portion of the convexity P and the toner, and Fₑ2 is the electrostatic attracting force between the contact surface of the cleaning roller 31 and the toner. Thereby the convexities were smoothly cleaned.

(3) Experiment Example 3

Charged polarity of toner: negative

Material of top portion of convexity P of non-fixing type image receiving sheet: PET (Lumirror, manufactured by Toray Industries, Inc)

Center line average height Ra of convexity P: 0.88 μm

Material of contact surface of cleaning roller 31: epoxy resin (TSE-350, CE62, manufactured by Toshiba Silicone Co., Ltd.)

In this case, the polarity of difference ΔV (=V1−V0) was different from the inherent chargeable polarity of the toner, where a surface potential V0 and a surface potential V1 were as follows: the toner was brought to adhere to the image receiving sheet, then the charged toner on the image receiving sheet was discharged by a discharger, and at this time the image receiving sheet had the surface potential of V0, and thereafter the toner was removed by an air gun, and at this time the image receiving sheet had the surface potential of V1.

Further, the polarity of difference ΔV (=V1−V0) was same as the inherent chargeable polarity of the toner, where a surface potential V0 and a surface potential V1 were as follows: the toner was brought to adhere to the contact surface of the cleaning roller 31, then the charged toner on the cleaning roller was discharged by a discharger, and at this time the cleaning roller had the surface potential of V0, and thereafter the toner was removed by an air gun, and at this time the cleaning roller had the surface potential of V1.

According to these above, the relationship of Fₑ1<Fₑ2 was established between Fₑ1 and Fₑ2, where Fₑ1 is the electrostatic attracting force between the top portion of the convexity P and the toner, and Fₑ2 is the electrostatic attracting force between the contact surface of the cleaning roller 31 and the toner. Thereby the convexities were smoothly cleaned.

(4) Experiment Example 4

Material of top portion of convexity P of non-fixing type image receiving sheet: PP (P2102, manufactured by Toyobo Co., Ltd.)

Angle of contact between top portion of convexity P of image receiving sheet and water: 94 degrees

Center line average height Ra of convexity P: 0.81 μm

Material of contact surface of cleaning roller 31: polyamide resin (N7150, manufactured by Toyobo Co., Ltd.)

Angle of contact between contact surface of cleaning roller 31 and water: 68 degrees

The relationship of F_{b}1<F_{b}2 was established between F_{b}1 and F_{b}2, where F_{b}1 is the water bridging force between the top portion of the convexity P and the toner, and F_{b}2 is the water bridging force between the contact surface of the cleaning roller 31 and the toner. Thereby the convexities were smoothly cleaned.

(5) Experiment Example 5

Experiment Example 5 was carried out under the same conditions as in Experiment Example 1 except that the center line average height Ra of the convexity P of the non-fixing type image receiving sheet was 0.22 μm.

The center line average height Ra of the convexity P of the image receiving sheet in Experiment Example 5 was lower than that in Experiment Example 1, and thereby the top portions of the convexities were more smoothly cleaned.

(6) Experiment Example 6

Experiment Example 6 was carried out under the same conditions as in Experiment Example 3 except that the center line average height Ra of the convexity P of the non-fixing type image receiving sheet was 0.25 μm.

The center line average height Ra of the convexity P of the image receiving sheet in Experiment Example 6 was greater than that in Experiment Example 3, and thereby the top portions of the convexities were more smoothly cleaned.

(7) Experiment Example 7

Experiment Example 7 was carried out under the same conditions as in Experiment Example 4 except that the center line average height Ra of the convexity P of the non-fixing type image receiving sheet was 0.20 μm.

The center line average height Ra of the convexity P of the image receiving sheet in Experiment Example 7 was lower than that in Experiment Example 4, and thereby the top portions of the convexities were more smoothly cleaned.

(8) Experiment Example 8

Experiment Example 8 was carried out under the same conditions as in Experiment Example 5 except that the center line average height Ra of the convexity P of the non-fixing type image receiving sheet was 0.25 μm.

The center line average height Ra of the convexity P of the image receiving sheet in Experiment Example 8 was greater than that in Experiment Example 5, and thereby the top portions of the convexities were more smoothly cleaned.

§5. Image Forming Apparatus

Another preferred embodiment of the image forming apparatus includes: (a) a toner image forming device for forming a toner image both on an ordinary image receiving sheet and on the non-fixing type image receiving sheet; and (b) a unit-fit part arranged at downstream side of the toner image forming device in a sheet feed direction.

In this preferred image forming apparatus, any one of a fixing unit and a convexity-cleaning unit can detachably fit to the unit-fit part, and thereby one of the fixing unit and the convexity-cleaning unit fitted to the unit-fit part can be exchanged to the other. The fixing unit is to be provided for fixing the toner image formed on the ordinary image receiving sheet to the ordinary image receiving sheet. The convexity-cleaning unit is to be provided for removing the toner adhering to the convexity or convexities of the irregular surface of the non-fixing type image receiving sheet.

The ordinary image receiving sheet is such a sheet that the toner image to be formed thereon is to be fixed thereto, and thereby can be called a fixing-type image receiving sheet. The ordinary image receiving sheet may be an ordinary paper sheet, a sheet for an overhead projector (OHP), or the like.

The non-fixing type image receiving sheet has, as described above, the irregular surface including at least one concavity for receiving toner and at least one convexity for protecting the toner adhering to the concavity, and is for carrying the toner image to be formed on the irregular surface by removably adhering the toner to the concavity or concavities of the irregular surface.

The term “unit” in “fixing unit” and “convexity-cleaning unit” means a unit which can be easily fit to and can be easily detached from the image forming apparatus (more specifically, body of the image forming apparatus) by an operator, serviceperson or the like, and thereby means so-called cartridge.

Typically the above preferred image forming apparatus further includes at least one of the fixing unit and the convexity-cleaning unit, but may not include any one of them. In the case, for example, the image forming apparatus includes the fixing unit, a fixed toner image can be formed on the ordinary image receiving sheet with this image forming apparatus by fitting the fixing unit to the unit-fit part. In this case, when there arises a need later for forming the toner images on the non-fixing type image receiving sheets, the need can be satisfied by additionally purchasing the convexity-cleaning unit so that the toner image can be formed on the non-fixing type image receiving sheet by replacing the fixing unit with the convexity-cleaning unit for fitting the convexity-cleaning unit to the unit-fit part. Reversely, the image forming apparatus including the convexity-cleaning unit may be firstly used, and the fixing unit may be later purchased if necessary. Of course, the image forming apparatus may include both the fixing unit and the convexity-cleaning unit from the beginning.

Anyway, in the above preferred image forming apparatus having the unit-fit part, the fixing unit and the convexity-cleaning unit can be replaced with each other to fit to the unit-fit part. When the fixing unit is fitted to the unit-fit part, the toner image formed on the ordinary image receiving sheet can be fixed thereto by the fixing unit, and thereby the fixed toner image can be formed on the ordinary image receiving sheet. When the convexity-cleaning unit is fitted to the unit-fit part instead of the fixing unit, the toner image can be formed on the non-fixing type image receiving sheet like on the ordinary image receiving sheet, and thereafter the toner adhering to the convexity or convexities of the non-fixing type image receiving sheet can be removed by the convexity-cleaning unit.

In addition, only one sheet-transporting path for transporting both the non-fixing type image receiving sheet and the ordinary image receiving sheet is sufficient in the above preferred image forming apparatus, and thereby it is not necessary for the image forming apparatus to have switching members for switching the sheet-transporting paths nor an electrical and mechanical structure for driving the switching members, so that the cost and sizes of the above preferred image forming apparatus can be reduced. Further, the above preferred image forming apparatus can be designed without majorly changing basic structure of a conventional image forming apparatus.

In the above preferred image forming apparatus having the unit-fit part, the fixing unit may include a fixing roller to be driven via a first gear train, and/or the convexity-cleaning unit may include a convexity-cleaning roller to be driven via a second gear train. The first gear train may include a first driving gear arranged in the unit-fit part, and a first driven gear or gear train arranged in the fixing unit and detachably engageable with the first driving gear. The second gear train may include a second driving gear arranged in the unit-fit part, and a second driven gear or gear train arranged in the convexity-cleaning unit and detachably engageable with the second driving gear. In this case, the image forming apparatus may be further provided with the first driving gear for driving the fixing roller and the second driving gear for driving the convexity-cleaning roller. The image forming apparatus may be provided with the first and second driving gears independently of each other. Alternatively, the first driving gear for driving the fixing roller may be identical with the second driving gear for driving the convexity-cleaning roller, that is, the image forming apparatus may be provided with a common driving gear that serves as both the first and second driving gears, and thereby for driving both the fixing roller and the convexity-cleaning roller.

In the case the convexity-cleaning unit includes the convexity-cleaning roller, the contact surface of the convexity-cleaning roller may be moved in a direction same as or opposite to the sheet feed direction. In any case where the contact surface of the convexity-cleaning roller is moved in a direction same as or opposite to the sheet feed direction, the difference may be made between the surface moving speed of the contact surface of the cleaning roller and the surface moving speed of the irregular surface of the non-fixing type image receiving sheet to be transported when removing the toner. Typically, the surface moving speed of the contact surface of the convexity-cleaning roller, namely the circumferential (peripheral) speed of the convexity-cleaning roller, may be higher than the surface moving speed of the irregular surface of the non-fixing type image receiving sheet, so that the cleaning effect can be usually greater.

On the other hand, in the case the fixing unit has the fixing roller, it is preferred that the circumferential speed of the fixing roller is equal to or substantially equal to the transporting speed of the ordinary image receiving sheet (i.e., relative surface moving speed of the ordinary image receiving sheet with respect to the fixing roller) to avoid the disturbance of the toner image to be fixed to the ordinary image receiving sheet with the fixing roller.

For this, in the case the first driving gear for driving the fixing roller is identical with the second driving gear for driving the convexity-cleaning roller, the second driven gear or gear train arranged in the convexity-cleaning unit may be such that the second driven gear or gear train arranged in the convexity-cleaning unit can rotate the convexity-cleaning roller at a peripheral surface moving speed higher than a peripheral surface moving speed of the fixing roller of the fixing unit. The convexity-cleaning unit may be provided with a plurality of convexity-cleaning rollers that includes said convexity-cleaning roller and are arranged along the sheet feed direction.

In any case, the image forming apparatus having the unit-fit part may be further provided with a power-supply connector that is detachably fittable to an electrical heater of the fixing unit, and is provided for supplying an electrical power to the electrical heater for fixing the toner image.

In the above image forming apparatus, the power-supply connector is electrically connected to the electrical heater of the fixing unit when the fixing unit is fitted to the unit-fit part, and via the power-supply connector the electrical power can be supplied to the electrical heater of the fixing unit for fixing the toner image.

On the other hand, when the convexity-cleaning unit is fitted to the unit-fit part, it is unnecessary to supply the electrical power to the electrical heater of the fixing unit. However, if the image forming apparatus is in the above state, the image forming apparatus would stop the operation, in some cases, for forming the toner image on the non-fixing type image receiving sheet under such a judgment that a trouble has occurred, which depends on the judgment algorithm or the like.

To avert this, the convexity-cleaning unit may further provided with a fixing unit-dummy (e.g., thermistor) detachably fittable to the power-supply connector.

The image forming apparatus having the unit-fit part may be further provided with (a) a sheet type detecting device for detecting whether the image receiving sheet to be used for forming the toner image is the ordinary image receiving sheet or the non-fixing type image receiving sheet, and/or (b) a unit type detecting device for detecting whether the unit fitted to the unit-fit part is the fixing unit or the convexity-cleaning unit. In this case, toner image formation on the ordinary image receiving sheet may be permitted when the sheet type detecting device detects the ordinary image receiving sheet and the unit type detecting device detects the fixing unit. The toner image formation on the non-fixing type image receiving sheet may be permitted when the sheet type detecting device detects the non-fixing type image receiving sheet and the unit type detecting device detects the convexity-cleaning unit.

§5.1.

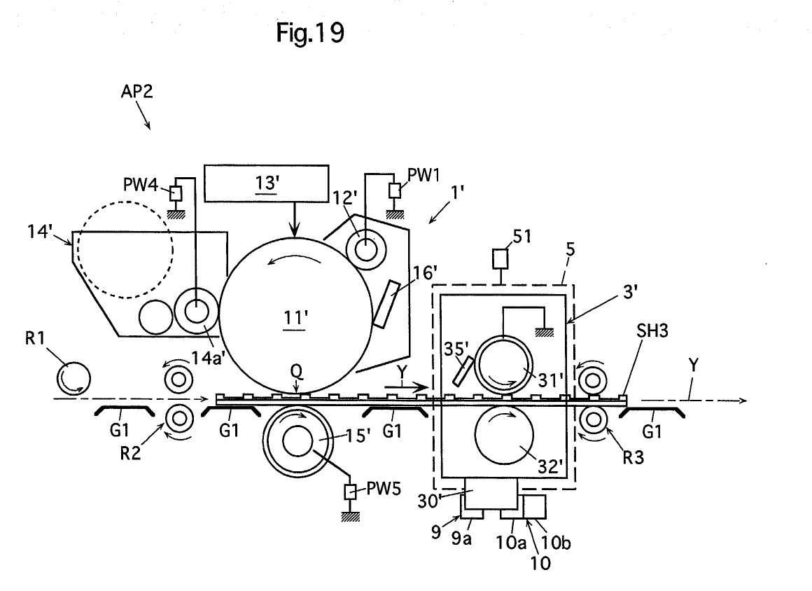

FIG. 18 is a schematic side view showing an example of the image forming apparatus having the unit-fit part. FIG. 19 partially shows a schematic structure of the image forming apparatus shown in FIG. 18. FIG. 18 shows the image forming apparatus in such a state that the fixing unit is fitted to the unit-fit part for forming the toner image on the ordinary image receiving sheet. FIG. 18 also shows the convexity-cleaning unit, at the outside of the image forming apparatus, which can be replaced with the fixing unit. FIG. 19 shows the image forming apparatus in such a state that the convexity-cleaning unit is fitted to the unit-fit part for forming toner image on the non-fixing type image receiving sheet.

The image forming apparatus AP2 shown in FIGS. 18 and 19 is provided with a toner image forming device 1′ capable of forming the toner image both on an ordinary image receiving sheet N and on the non-fixing type image receiving sheet. The ordinary image receiving sheet N is such a sheet that the toner image to be formed thereon is to be fixed thereto, and is, for example, a plain paper sheet, a sheet for an overhead projector or the like. In this embodiment, the ordinary image receiving sheet N is the plain paper sheet, and the non-fixing type image receiving sheet is the foregoing non-fixing type image receiving sheet SH3 shown in FIGS. 7 and 8. The image forming apparatus AP2 can form the toner image not only on the non-fixing type image receiving sheet SH3 but also on any types of the above-mentioned non-fixing type image receiving sheets.

The image forming apparatus AP2 is further provided with a unit-fit part 5 arranged at downstream side of the toner image forming device 1′ in a sheet feed direction Y, a fixing unit 4 and a convexity-cleaning unit 3′. The fixing unit 4 is provided for fixing the toner image formed on the ordinary image receiving sheet N to the sheet N after the toner image is formed on the sheet N by the toner image forming device 1′. The convexity-cleaning unit 3′ is provided for removing the toner adhering to the convexities P of the non-fixing type image receiving sheet SH3 after the toner image is formed on the sheet SH3 by the toner image forming device 1′.

Any one of the fixing unit 4 and the convexity-cleaning unit 3′ can detachably fit to the unit-fit part 5, and thereby one of the fixing unit 4 and the convexity-cleaning unit 3′ fitted to the unit-fit part 5 can be exchanged to the other. The term “unit” of “fixing unit” and “convexity-cleaning unit” means that an operator or serviceperson can easily mount the unit on or remove the unit from the image forming apparatus AP2 (e.g. without use of a special implement, tool or the like).

For this, the image forming apparatus AP2 may have a swing-part that can swing on a hinge with respect to the apparatus body so that the operator or serviceperson can access the unit fitting to the unit-fit part 5 for exchanging the unit when the swing-part is in an open state, and the apparatus inner components such as the unit fitting to the unit-fit part 5, the toner image forming device 1′ can be covered when the swing-part is in a closed state.

The image forming apparatus AP2 is further provided with a cassette-fit part CA to which a cassette CAS for accommodating a plurality of the image receiving sheets can be detachably fitted. A drawing roller (pick-up roller) R1 faces the image receiving sheet in the cassette CAS fitted to the cassette-fit part CA for drawing out or pulling out single image receiving sheet from the cassette.

For forming the toner image on the ordinary image receiving sheet N, the fixing unit 4 is fitted to the unit-fit part 5, and the cassette CAS accommodating a plurality of the ordinary image receiving sheets N is fitted to the cassette-fit part CA as shown in FIG. 18. When forming the toner image on the ordinary image receiving sheet N in the image forming apparatus AP2, the image receiving sheet N is transported along a predetermined sheet-transporting path as guided by a guide member G1 or the like. More specifically, when forming the toner image on the ordinary image receiving sheet N, single sheet N is pulled out from the cassette CAS, and is then transported along the sheet transporting path toward a discharge tray 100 (not shown in FIG. 19) for accommodating the sheets carrying the toner images formed thereon. On the way to the discharge tray 100, operations for forming the toner image are performed on the running ordinary image receiving sheet N.

For forming the toner image on the non-fixing type image receiving sheet SH3, the convexity-cleaning unit 3′ is fitted to the unit-fit part 5 as shown in FIG. 19, and the cassette CAS (not shown in FIG. 19) accommodating a plurality of the non-fixing type image receiving sheets SH3 is fitted to the cassette-fit part CA. When forming the toner image on the non-fixing type image receiving sheet SH3 in the image forming apparatus AP2, like when forming the toner image on the ordinary image receiving sheet N, the sheet SH3 is transported along the predetermined sheet-transporting path as guided by the guide member G1 or the like. More specifically, when forming the toner image on the non-fixing type image receiving sheet SH3, single sheet SH3 is pulled out from the cassette CAS, and is then transported along the sheet transporting path toward the discharge tray 100, and on the way to the discharge tray 100, operations for forming the toner image are performed on the running sheet SH3.

When forming the toner image, the ordinary image receiving sheet N or the non-fixing type image receiving sheet SH3 is pulled out from the cassette CAS by a sheet-drawing roller R1 (see FIG. 18), and is transported at a predetermined sheet transporting speed by rollers R2 to R5 (rollers R4 and R5 are not shown in FIG. 19) arranged in positions opposed to the sheet-transporting path. When the image receiving sheet N or SH3 is transported, the rollers R2 to R5 are driven to rotate in a predetermined direction at a predetermined speed by a driving device (not shown). A photosensitive member 11′ and a transfer roller 15′ to be described later are driven to rotate by a driving device (not shown) in this embodiment.

The image receiving sheet N or SH3 thus transported at the predetermined sheet transporting speed is subjected successively to a toner image forming processing by the toner image forming device 1′, to a fixing processing by the fixing unit 4 or to a convexity-cleaning processing by the convexity-cleaning device 3′ in this order.

The toner image forming device 1′ can form the toner image on any of the ordinary image receiving sheet N and the non-fixing type image receiving sheet SH3 by the electro-photographic method. The toner image forming device 1′ is provided with a drum-form photosensitive member 11′ serving as the electrostatic latent image carrier. The photosensitive member 11′ is surrounded by a charging device including a charging roller 12′, an exposing device 13′, a developing device 14′, a transfer device including a transfer roller 15′, and a cleaner including a cleaning blade 16′.

When forming the toner image, the photosensitive member 11′ is driven to rotate counterclockwise in FIGS. 18 and 19 by a driving device (not shown).

The charging roller 12′ is supplied with a predetermined direct current voltage from a power source PW1, so that the surface of the rotating photosensitive member 11′ is uniformly charged by the charging roller 12′ to have a predetermined potential (−900V in this embodiment).

The photosensitive member 11′ surface thus charged by the charging roller 12′ is exposed according to an original image by the exposing device 13′ to form an electrostatic latent image corresponding to the toner image to be formed. At this time, the surface potential of the photosensitive member 11′ is reduced to about −100V in the exposed region but is maintained at about −900V in the unexposed region.

The exposing device 13′ may expose according to the original image, for example, based on an original image information sent from a host device such as a computer, word processing device or the like. Instead of this, the exposing device 13′ may include a scanner for optically scanning an original image and expose according the scanned original image.

The electrostatic latent image on the photosensitive member 11′ is developed by the developing device 14′. The developing device 14′ accommodates a negatively charged toner and has a developing roller 14a′. In the development operation, the developing roller 14a′ is driven to rotate clockwise in FIGS. 18 and 19 by a driving device (not shown), and is supplied with a direct current developing bias voltage (−350V in this embodiment) by a power source PW4 to develop the electrostatic latent image.

Meanwhile, the image receiving sheet N or SH3 pulled out from the cassette CAS is fed by the timing roller pair R2 toward a transfer region where the transfer roller 15′ faces the photosensitive member 11′ to pass between the transfer roller 15′ and the photosensitive member 11′.

Onto the image receiving sheet N or SH3 thus fed to the transfer region by the timing roller pair R2, the toner particles composing the toner image on the photosensitive member 11′ is transferred by the transfer roller 15′. In the transferring operation, the transfer roller 15′ is driven to rotate clockwise in FIGS. 18 and 19, and is supplied with a direct current transfer voltage (about +1 kV in this embodiment) from a power source PW5.

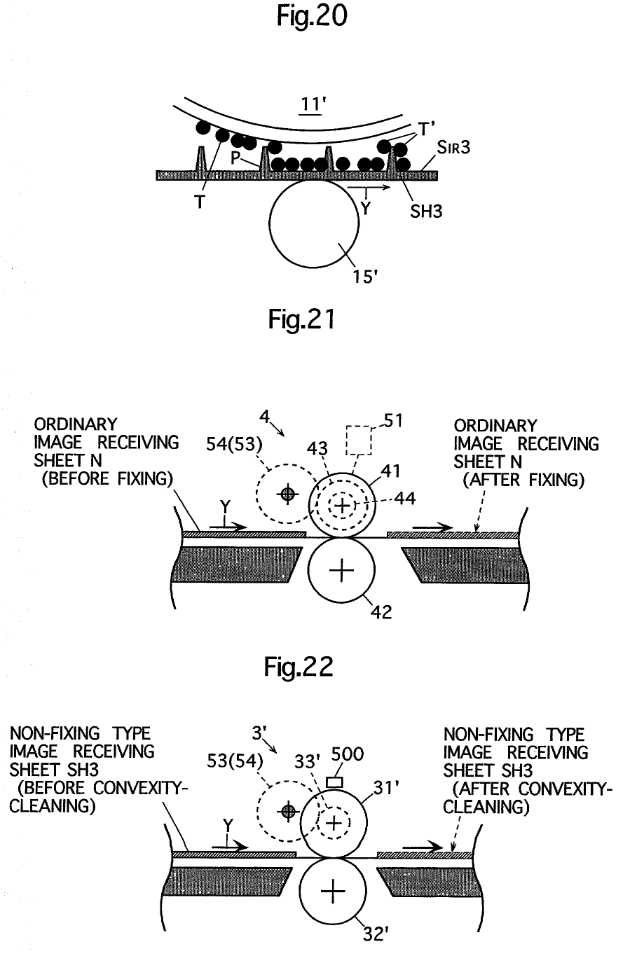

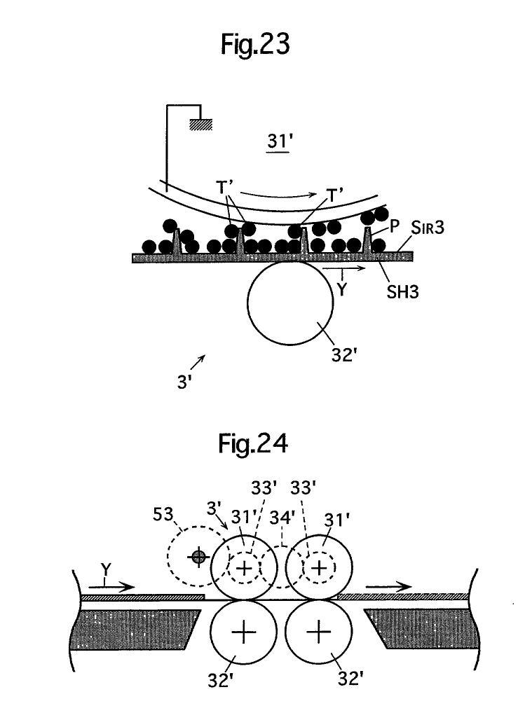

FIG. 20 shows the transferring state in which the toner particles on the photosensitive member 11′ are transferred to the non-fixing type image receiving sheet SH3. The image receiving sheet SH3 has, as described above, the irregular surface pattern of the type shown in FIG. 9(B) wherein the concavities R and convexities P extend in the direction parallel with the sheet feed direction Y. However, FIG. 20 shows the irregular surface pattern of the type shown in FIG. 9(A) wherein the concavities R and convexities P extend in parallel with a direction X perpendicular to the sheet feed direction Y, instead of the irregular surface pattern of the type of FIG. 9(B) for better understanding. This is also true with FIG. 23 and FIG. 31 to be described later.

After transferring of the toner image, the toner remaining on the photosensitive member 11′ without being transferred to the image receiving sheet N or SH3 is removed by the cleaning blade 16′ in contact with the photosensitive member 11′. The ordinary image receiving sheet N onto which the toner has been transferred is then subjected to the fixing operation by the fixing unit 4. The non-fixing type image receiving sheet SH3 onto which the toner image has been transferred is then subjected to the convexity-cleaning operation by the convexity-cleaning unit 3′.

FIG. 21 shows a schematic structure of the fixing unit 4 in such a state that the fixing unit 4 fits to the unit-fit part 5, and thereby is mounted on the image forming apparatus AP2.

The fixing unit 4 fitted to the unit-fit part 5 is placed in a position facing the sheet-transporting path. The fixing unit 4 has a pair of fixing rollers, i.e., an upper fixing roller 41 and a lower fixing lower roller 42. The fixing rollers 41 and 42 are placed in stationary positions in the fixing unit 4. The fixing roller 41 has a hollow form, and is provided internally with an electrical heater 44 for heating the fixing roller 41 to fix the toner image. The heater 44 is supplied with an electrical power via a power-supply connector 51 when heating the fixing roller 41. The power-supply connector 51 is arranged at the unit-fit part 5 (apparatus body side), and is detachably fittable with respect to the heater 44. The ordinary image receiving sheet N onto which the toner image has been transferred is passed between the fixing rollers 41 and 42 to apply heat and pressure to the toner composing the toner image, and thereby the toner image is fixed to the sheet N.

When fixing the toner image, the fixing roller 41 is driven to rotate counterclockwise via a first gear train including a first driving gear 54 and a first driven gear 43. The first driving gear 54 is arranged at the unit-fit part 5, in other words, at the apparatus body side. The first driven gear 43 is arranged in the fixing unit 4, and has the same axis as the fixing roller 41 in this embodiment. The first driven gear 43 arranged in the fixing unit 4 is detachably engageable with the first driving gear 54 arranged at the unit-fit part 5, so that the engagement between the driving gear 54 and the driven gear 43 is made when the fixing unit 4 fits to the unit-fit part 5, and the engagement between the gears 54 and 43 is broken when the fixing unit 4 is detached from the unit-fit part 5. The fixing roller 41 is driven to rotate via the first gear train when fixing the toner image so that its peripheral surface, which is come into contact with the toner image on the ordinary image receiving sheet N, moves at the same speed as the sheet transporting speed.

FIG. 22 shows a schematic structure of the convexity-cleaning unit 3′ in such a state that the convexity-cleaning unit 3′ fits to the unit-fit part 5, and thereby is mounted on the image forming apparatus AP2. FIG. 23 shows a state, in the convexity-cleaning unit, of removal of toner particles T′ adhering to the top portions of the convexities P of the irregular surface S_{IR}3 of the non-fixing type image receiving sheet SH3 onto which the toner image has been transferred.

The convexity-cleaning unit 3′ fitted to the unit-fit part 5 is placed in a stationary position facing the sheet transporting path. The convexity-cleaning unit 3′ has a convexity-cleaning roller 31′ with which a toner-removing blade is in contact, and a platen roller 32′. For better understanding, the cleaning roller 31′ of FIG. 23 is illustrated in an enlarged size. The rollers 31′ and 32′ are placed in stationary positions in the convexity-unit 3′, are metallic rollers and are electrically grounded in this embodiment.

When removing the toner from the convexities P of the non-fixing type image receiving sheet SH3, the convexity-cleaning roller 31′ is driven to rotate counterclockwise in FIGS. 22 and 23 via a second gear train including a second driving gear 53 and a second driven gear 33′ (see FIG. 22). The second driving gear 53 is arranged at the unit-fit part 5, in other words, at the apparatus body side. The second driven gear 33′ is arranged in the convexity-cleaning unit 3′, and has the same axis as the convexity-cleaning roller 31′ in this embodiment. The second driven gear 33′ arranged in the convexity-cleaning unit 3′ is detachably engageable with the second driving gear 53 arranged at the unit-fit part 5, so that the engagement between the driving gear 53 and the driven gear 33′ is made when the convexity-cleaning unit 3′ fits to the unit-fit part 5, and the engagement between the gears 53 and 33′ is broken when the convexity-cleaning unit 3′ is detached from the unit-fit part 5.

In this embodiment, the first driving gear 54 (see FIG. 21) for driving the fixing roller 41 is identical with the second driving gear 53 (see FIG. 22) for driving the convexity-cleaning roller 31′. That is, the image forming apparatus AP2 is provided at the apparatus body side with single common driving gear 53(54) that is commonly used for driving the fixing roller 41 and the convexity-cleaning roller 31′, is detachably engageable with the first driven gear 43 arranged in the fixing unit 4, and is also detachably engageable with the second driven gear 33′ arranged in the convexity-cleaning unit 3′.

The convexity-cleaning roller 31′ is driven to rotate via the second gear train including the common driving gear 53(54) when removing the toner from the convexities of the non-fixing type image receiving sheet SH3. Thereby the contact surface, to be come into contact with the convexities P of the non-fixing type image receiving sheet SH3, moves at a predetermined surface moving speed in a predetermined direction.

Meanwhile, when removing the toner T′ adhering to the convexities P of the non-fixing type image receiving sheet SH3, in other words, when carrying out the convexity-cleaning operation, the sheet SH3 is transported at the predetermined sheet-transporting speed along the sheet transporting path by the driving device (not shown), so that the sheet SH3 passes between the convexity-cleaning roller 31′ and the platen roller 32′ and thereby the sheet SH3 moves at the predetermined sheet transporting speed with respect to the convexity-cleaning roller 31′ since the convexity-cleaning roller 31′ is placed in the stationary position. More specifically, the irregular surface S_{IR}3 including convexities P of the non-fixing type image receiving sheet SH3 moves at the predetermined surface moving speed (=sheet transporting speed) with respect to the convexity-cleaning roller 31′ when removing the toner from the convexities.

In this embodiment, the convexity-cleaning roller 31′ is driven to rotate counterclockwise in FIGS. 22 and 23 when removing the toner from the convexities, so that the contact surface of the convexity-cleaning roller 31′ moves in the same direction as the sheet transporting direction of the non-fixing type image receiving sheet SH3 in the contact region where the contact surface of the convexity-cleaning roller 31′ is in contact with the sheet SH3. The platen roller is rotated in accordance with the movement of the image receiving sheet SH3 or the rotation of the convexity-cleaning roller 31′ in this embodiment.

Further in this embodiment, the convexity-cleaning roller 31′ is driven to rotate so that the contact surface of the convexity-cleaning roller 31′ moves at a surface moving speed higher than the transporting speed of the non-fixing type image receiving sheet SH3, more specifically at a surface moving speed that is about 1.1 times to about 4 times as high as the sheet transporting speed of the image receiving sheet SH3. If the contact surface speed of the convexity-cleaning roller 31′ is 1 times as fast as the transporting speed of the non-fixing type image receiving sheet SH3, namely is equal to the transporting speed of the sheet SH3, the effect of cleaning the convexities P of the sheet SH3 would be hardly achieved. If the contact surface speed of the convexity-cleaning roller 31′ is more than 4 times of the transporting speed of the image receiving sheet SH3, the sheet SH3 would be not transported in the desirable manner, and the sheet SH3 may be stopped halfway through the operation, or may be jammed or may not be properly discharged from the convexity-cleaning region between the convexity-cleaning roller 31′ and the platen roller 32′.

From another point of view, in this embodiment, the driven gear 33′, that is arranged in the convexity-cleaning unit 3′ and is driven by the common driving gear 53(54), drives the convexity-cleaning roller 31′ to move the contact surface (peripheral surface) of the convexity-cleaning roller 31′ at the surface moving speed higher than the sheet transporting speed when removing the toner from the convexities of the non-fixing type image receiving sheet SH3. On the other hand, the driven gear 43, that is arranged in the fixing unit 4 and is driven by the common driving gear 53(54), drives the fixing roller 41 to move the contact surface (peripheral surface) of the fixing roller 41 at the surface moving speed same as the sheet transporting speed when fixing the toner image in this embodiment. Accordingly, in this embodiment, the driven gear 33′ of the convexity-cleaning unit 3′ is capable of rotating the convexity-cleaning roller 31′ at the peripheral surface moving speed higher than the peripheral surface moving speed of the fixing roller 41 of the fixing unit 4 to be driven via the driven gear 43. The driven gear 33′ of the convexity-cleaning unit 3′ has a smaller number of teeth (smaller diameter) than the driven gear 43 of the fixing unit 4.

When removing the toner from the convexities of the non-fixing type image receiving sheet SH3 carrying the toner image that has been transferred thereto, as described above, the contact surface of the convexity-cleaning roller 31′ driven to rotate in the predetermined direction is come into contact with the convexities P of the irregular surface S_{IR}3 of the sheet SH3 transported in the specified direction, so that the top portions of convexities P are rubbed by the contact surface of the convexity-cleaning roller 31′, and thereby the toner particles T′ adhering to the top portions of the convexities P are transferred from the convexities P to the convexity-cleaning roller 31′ by the image force and/or other force to remove the toner from the convexities P.

The blade 35′ in contact with the convexity-cleaning roller 31′ is made of a rubber material in this example, and is pressed against the convexity-cleaning roller 31′. Thereby the removed toner on the convexity-cleaning roller 31′ can be scraped off therefrom so that the roller 31′ can invariably bring its smooth metallic surface into contact with the image receiving sheet SH3. The toner removed from the cleaning roller 31′ may be reused to form the toner image in the toner image forming device 1′.

The convexity-cleaning unit 3′ is further provided with a thermistor 500 serving as the fixing unit dummy that is detachably fitted to the power supply connector 51 arranged at the apparatus body side when the convexity-cleaning unit 3′ is attached to the unit-fit part 5.

The convexity-cleaning unit 3′ may have a plurality of convexity-cleaning rollers 31′ arranged along the sheet transporting direction as shown in FIG. 24. In the convexity-cleaning unit 3′ of FIG. 24, these convexity-cleaning rollers 31′ are to be driven via the driving gear 53 arranged at the apparatus body side as well as driven gears 31′ and 34′ arranged at the convexity cleaning unit 3′.

As shown in FIGS. 18 and 19, the image forming apparatus AP2 is further provided with a unit presence detecting device 9 for detecting whether or not one of the fixing unit 4 and the convexity-cleaning unit 3′ is fitted to the unit-fit part 5, and a unit type detecting device 10 for detecting whether the unit fitted to the unit-fit part 5 is the fixing unit 4 or the convexity-cleaning unit 3′. In this embodiment, the unit presence detecting device 9 includes a microswitch 9a, and the unit type detecting device 10 includes microswitches 10a and 10b.

The convexity-cleaning unit 3′ has a projection 30′ for making the microswitches 9a and 10a on-state. When the convexity-cleaning unit 3′ is fitted to the unit-fit part 5, the microswitches 9a and 10a are brought to the on-state, and the off-state of the microswitch 10b is maintained.

On the other hand, the fixing unit 4 has projections 40 for making the microswitches 9a and 10b on-state. When the fixing unit 4 is fitted to the unit-fit part 5, the microswitches 9a and 10b are brought to the on-state, and the off-state of the microswitch 10a is maintained.

According to these above, the unit presence detecting device 9 can detect the presence or absence of the unit fitted to the unit-fit part 5 by checking the on-off state of the microswitch 9a. The unit type detecting device 10 can detect the fact that the convexity-cleaning unit 3′ is fitted to the unit-fit part 5 when the microswitch 10a is in the on-state. The unit type detecting device 10 also can detect the fact that the fixing unit 4 is fitted to the unit-fit part 5 when the microswitch 10b is in the on-state. The unit type detecting device 10 may also serve as the unit presence detecting device 9.

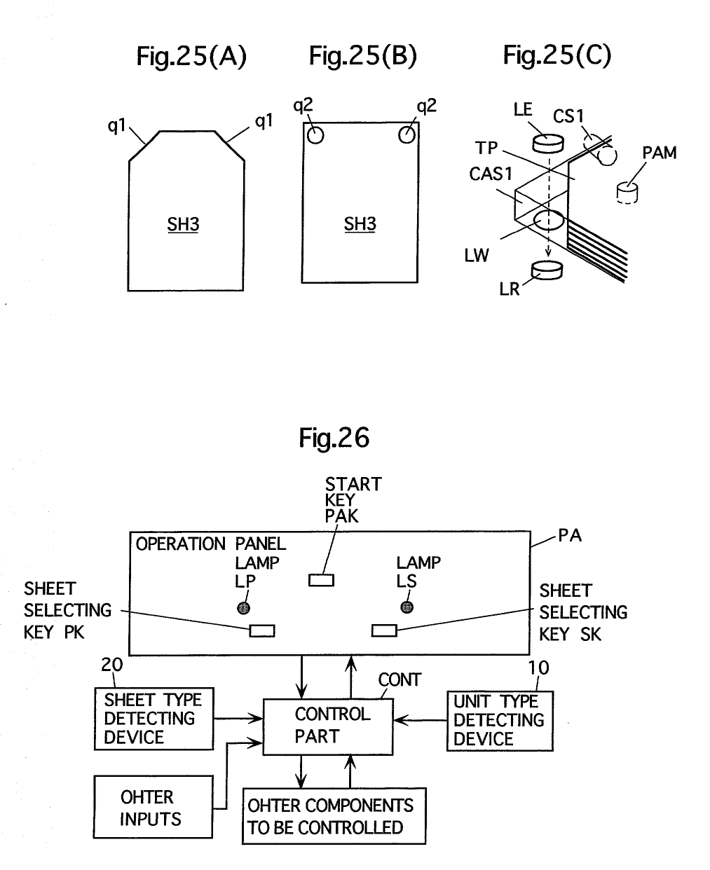

The image forming apparatus AP2 is further provided, at the cassette-fit part CA (see FIG. 18), with a sheet type detecting device 20 (see FIGS. 25(A), 25(B) and 25(C)) for detecting whether the image receiving sheet to be used for forming the toner image is the ordinary image receiving sheet N or the non-fixing type image receiving sheet SH3. In this embodiment, the sheet type detecting device 20 detects whether the image receiving sheet(s) accommodated in the cassette CAS is the ordinary image receiving sheet(s) N or the non-fixing type image receiving sheet(s).

The sheet type detecting device 20 includes a cassette CAS1, a light-emitting element LE and a light-receiving element LR. The cassette has a light permeable window LW formed at a corner of bottom surface of the cassette as shown in FIG. 25(C), and is capable of accommodating any type of the ordinary image receiving sheets N and the non-fixing type image receiving sheets SH3. The light-emitting element LE and the light-receiving element LR are arranged at upper and lower positions of the light permeable window LW, respectively, when the cassette CAS1 is fitted in the body of the image forming apparatus (cassette-fit part CA).

When the cassette CAS1 fitted in the image forming apparatus accommodates the non-fixing type image receiving sheets SH3 in which inclined corner portions (cut-off corner portions) q1 are formed as shown in FIG. 25(A) or in which apertures q2 are formed at corners of the sheet as shown in FIG. 25(B), one of the inclined corner portions q1 or the apertures q2 of the non-fixing type image receiving sheet SH3 are come to positions opposed to the light-emitting element LE and the light-receiving element LR, so that the light beam emitted from the light-emitting element LE is detected by the light-receiving element LR, and thereby the fact that the sheet accommodated in the cassette CAS1 is the non-fixing type image receiving sheet SH3 is detected.

On the other hand, when the cassette CAS1 fitted in the image forming apparatus accommodates the ordinary image receiving sheets (fixing-type image receiving sheets) N without the inclined corner portions q1 or the apertures q2, the light beam emitted from the light-emitting element LE is not detected by the light-receiving element LR, and thereby the fact that the sheet accommodated in the cassette CAS1 is the ordinary image receiving sheet N is detected.

The image forming apparatus AP2 is further provided, at the cassette-fit part CA, with a sensor CS1 for detecting the presence or absence of the cassette CAS1, and a sensor PAM for detecting the presence or absence of the image receiving sheets in the fitted cassette.

A control part CONT for controlling the overall operations is also provided in the image forming apparatus AP2, and is arranged above the exposing device 13′ as shown in FIG. 18.

FIG. 26 is a block diagram schematically showing a control circuit of the image forming apparatus AP2.

Connected to the control part CONT of the apparatus AP2 are, as shown in FIG. 26, a control panel PA, the unit type detecting device 10, the sheet type detecting device 20, and other components to be operationally controlled. Various items of information are input to the control part CONT via an input port (not shown) from detectors such as a thermistor of the fixing unit 4, the fixing unit dummy 500 of the convexity-cleaning unit 3′, the unit type detecting device 10, the sheet type detecting device 20, the unit presence detecting device 9, and the sheet presence detecting sensor PAM (see FIG. 25(A) to FIG. 25(C) and other figures).

The components to be operationally controlled include: (a) a part for rotationally driving the photosensitive member 11′; (b) a part for rotationally driving the charging roller 12′ and the power source PW1 connected to the roller 12′; (c) the exposing device 13′; (d) a driving part for the developing device 14′ and the developing bias power source PW4; (e) a part for driving the transfer roller 15′ and the transfer power source PW5 connected to the roller 15′; (f) a part for driving the sheet-drawing roller R1; (g) a part for driving the timing roller pair R2; (h) a part for driving the fixing roller pair 41, 42 or the convexity-cleaning roller 31′; (i) a part for driving the discharging rollers R3 to R5; and (j) parts relating to them.

The control panel PA is provided with a key PAK for instructing the start of image formation, a sheet type selecting key PK for instructing to form the image on the ordinary image receiving sheet N, a sheet type selecting key SK for instructing to form the image on the non-fixing type image receiving sheet SH3, a LED lamp LP that turns on when the ordinary image receiving sheet is selected, a LED lamp LS that turns on when the non-fixing type image receiving sheet is selected and so on.

The toner image is formed on the ordinary image receiving sheet N or the non-fixing type image receiving sheet SH3 by the toner image forming device 1′ as described above. Thereafter the toner image is fixed onto the ordinary image receiving sheet N by the fixing unit 4 fitted to the unit-fit part 5 in the case the toner image is formed on the sheet N. Alternatively, in the case the toner image is formed on the non-fixing type image receiving sheet SH3, the toner adhering to the top portions of the convexities P of the sheet SH3 is removed by the convexity-cleaning unit 3′ fitted to the unit-fit part 5.

The ordinary image receiving sheet N carrying the fixed toner image formed thereon by the toner image forming device 1′ and fixed thereto by the fixing unit 4, or the non-fixing type image receiving sheet SH3 that carries the non-fixed toner image formed thereon by the toner image forming device 1′ and has been subjected to the convexity-cleaning operation by the convexity-cleaning unit 3′ is transported by the discharge roller pairs R3 to R5 for accommodation into the discharge tray 100.

The image forming apparatus AP2 performs the operations as described above to form the toner image. These operations are performed under the instructions from the control part CONT based on the results of detection by the unit type detecting device 10, the sheet type detecting device 20 and the like.

In the image forming apparatus AP2, when the key PK in the control panel PA is pushed, the apparatus AP2 (the control part CONT) recognizes the image formation operation from now on is to be performed on the ordinary image receiving sheet N, and turns on the selection indicating LED lamp LP for the ordinary image receiving sheet. When the key SK is pushed, the apparatus AP2 recognizes that the image formation operation from now on is to be performed on the non-fixing type image receiving sheet, and turns on the selection indicating LED lamp LS for the non-fixing type image receiving sheet. The apparatus AP2 (control part CONT) permits to form the toner image on the ordinary image receiving sheet N when the sheet type detecting device 20 detects the ordinary image receiving sheet N, and the unit type detecting device 10 detects the fixing unit 4. The apparatus AP2 (control part CONT) permits to form the toner image on the non-fixing type image receiving sheet SH3 when the sheet type detecting device 20 detects the non-fixing type image receiving sheet SH3 and the unit type detecting device 10 detects the convexity-cleaning unit 3′.

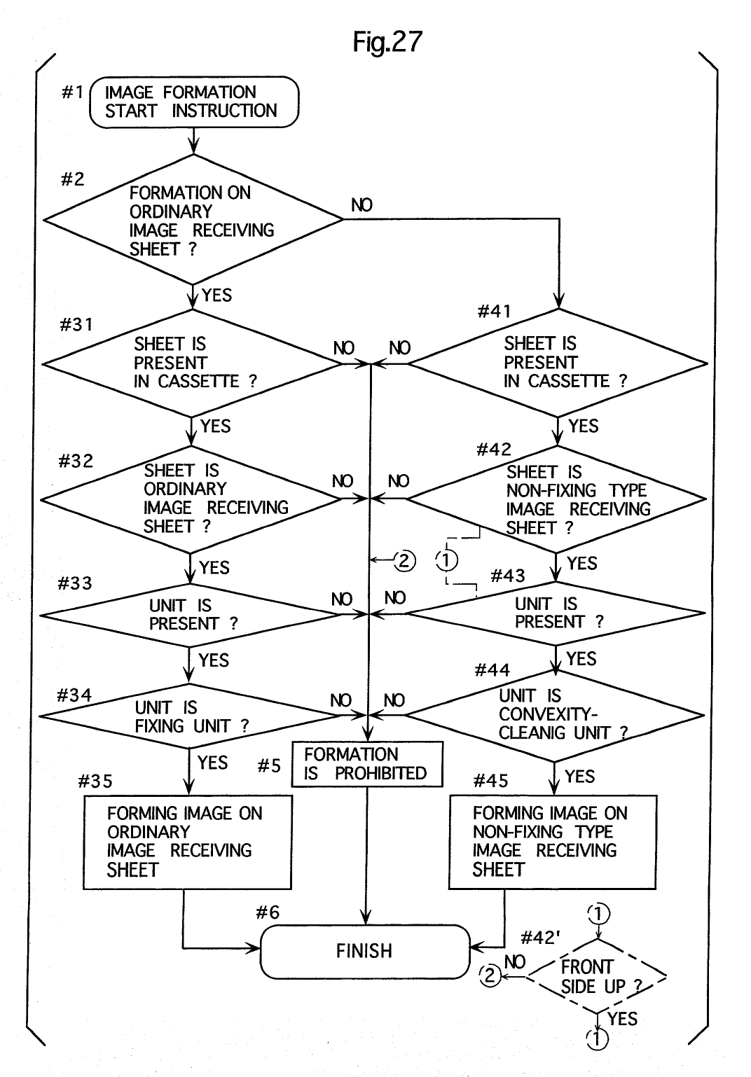

More detailed description is given below about the foregoing operations with reference to FIG. 27.

When the key PAK for instructing the start of the image formation is pushed, the commencement of the image formation operations is instructed (step #1 in FIG. 27). Then, it is determined whether the image formation operations are to be performed from now on the ordinary image receiving sheet N in accordance with the push of key PAK or on the non-fixing type image receiving sheet SH3 in accordance with the push of key SK (step #2).

When it is determined that the image formation operations from now are to be performed on the ordinary image receiving sheet N (step #2:Yes), the sensor PAM judges the presence or absence of the image receiving sheet in the cassette CAS (step #31). In the case of absence of the image receiving sheet in the cassette CAS, image formation is prohibited (step #5). In the case of presence of the image receiving sheet in the cassette CAS, the sheet type detecting device 20 detects whether or not the image receiving sheet accommodated in the cassette CAS is the ordinary image receiving sheet N (step #32).

In the case the image receiving sheet accommodated in the cassette CAS is not the ordinary image receiving sheet N, image formation is prohibited (step #5). In the case the image receiving sheet accommodated in the cassette CAS is the ordinary image receiving sheet N, the unit presence detecting device 9 detects whether or not the unit is fitted to the unit-fit part 5 (step #33). When no unit is fitted to the unit-fit part 5, image formation is prohibited (step #5). When the unit is fitted to the unit-fit part 5, the unit type detecting device 10 detects whether or not the unit fitted to the unit-fit part 5 is the fixing unit 4 (step #34).

When the unit fitted to the unit-fit part 5 is not the fixing unit, image formation is prohibited (step #5). When the unit fitted to the unit-fit part 5 is the fixing unit 4, the image formation onto the ordinary image receiving sheet N is permitted, so that the image formation operations, i.e., the toner image forming operation (toner image transferring operation in this embodiment) and the fixing operation are performed (step #35), and thereafter the image formation is finished (step #6).

When it is determined that the image formation operations from now are to be performed on the non-fixing type image receiving sheet SH3 (step #2: No), the sensor PAM judges whether the image receiving sheet is present or absent in the cassette CAS (step #41). In the case of absence of the sheet in the cassette CAS, image formation is prohibited (step #5). On the other hand, in the case of presence of the sheet in the cassette CAS, the sheet type detecting device 20 detects whether or not the image receiving sheet accommodated in the cassette CAS is the non-fixing type image receiving sheets (step #42).

When the image receiving sheet accommodated in the cassette CAS is not the non-fixing type image receiving sheets SH3, image formation is prohibited (step #5). When the image receiving sheet accommodated in the cassette CAS is the non-fixing type image receiving sheets, the unit presence detecting device 9 detects whether or not the unit is fitted to the unit-fit part 5 (step #43). When no unit is fitted to the unit-fit part 5, image formation is prohibited (step #5). When the unit is fitted to the unit-fit part 5, the unit type detecting device 10 detects whether or not the unit fitted to the unit-fit part 5 is the convexity-cleaning unit 3′ (step #44).

When the unit fitted to the unit-fit part 5 is not the convexity-cleaning unit 3′, image formation is prohibited (step #5). When the unit fitted to the unit-fit part 5 is the convexity-cleaning unit 3′, the image formation onto the non-fixing type image receiving sheet SH3 is permitted, so that the image formation operations, i.e., the toner image forming operation (toner image transferring operation in this embodiment) and the convexity-cleaning operation are performed (step #45), and thereafter the image formation is finished (step #6).

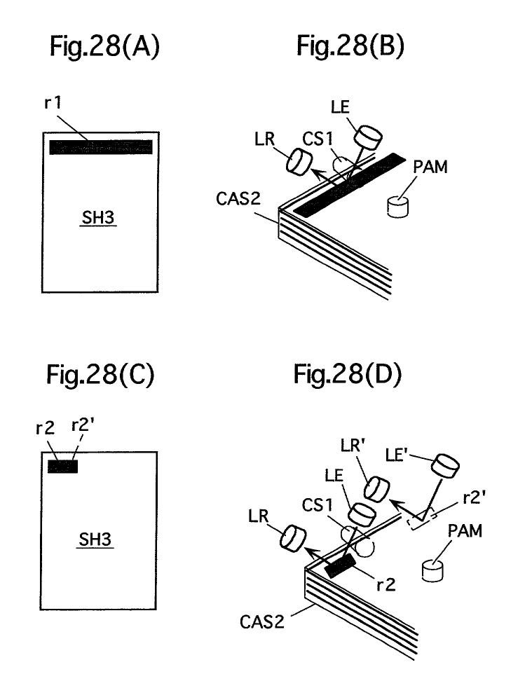

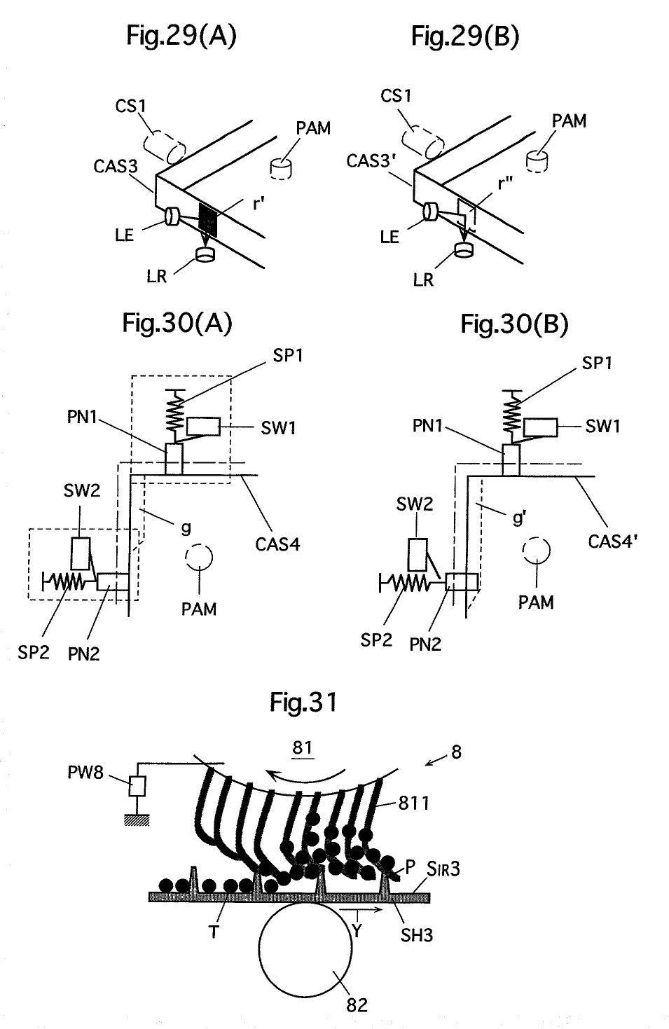

Instead of the sheet type detecting device 20 shown in FIGS. 25(A) to 25(C), the sheet type detecting devices shown in FIGS. 28 (A) to 28(D), shown in FIGS. 29(A) and 29(B), or shown in FIGS. 30(A) and 30(B) may be employed. The sensor PAM shown in the above figures is the same as the sensor PAM shown in FIG. 25(C) for detecting the presence or absence of the image receiving sheet in the cassette, and is designated by the same reference symbol.

The sheet type detecting device shown in FIG. 28(B) includes the light-emitting element LE and the light-receiving element LR arranged in positions to be opposed to the image receiving sheet accommodated in the cassette CAS2 when the cassette CAS2 that can accommodate any of the ordinary image receiving sheet N and the non-fixing type image receiving sheet SH3 is fitted to the apparatus body.

In the case the cassette CAS2 fitted to the apparatus body (more specifically, cassette-fit part CA) accommodates the non-fixing type image receiving sheet SH3 having a light-reflecting surface region r1 at one end region as shown in FIG. 28(A), the light ray emitted from the light-emitting LE is reflected by the light-reflecting surface region r1 of the non-fixing type image receiving sheet SH3, and thereby is received by the light-receiving element LR, so that the fact the sheet accommodated in the cassette CAS2 is the non-fixing type image receiving sheet SH3 is detected.

In the case the cassette CAS2 fitted to the apparatus body accommodates the ordinary image receiving sheet N having no light-reflecting surface portion r1, the light beams emitted from the light-emitting element LE cannot be detected by the light-receiving element LR, or even if the light beams are detected by the light-receiving element LR, the light-receiving element LR can receive only small amount of light beams. Anyway the fact the sheet accommodated in the cassette is the ordinary image receiving sheets N can be detected.

Even when the cassette CAS2 accommodates the ordinary image receiving sheet N and the non-fixing type image receiving sheet in the mixed fashion, the sheet type detecting device shown in FIG. 28(B) can detect the sheet type.

The sheet type detecting device shown in FIG. 28(D) includes the light-emitting elements LE and LE′ as well as the light-receiving elements LR and LR′ arranged in positions to be opposed to the image receiving sheet accommodated in the cassette CAS2 when the cassette CAS2 that can accommodate any of the ordinary image receiving sheet N and the non-fixing type image receiving sheet SH3 is fitted to the apparatus body.

In the case the cassette CAS2 fitted to the apparatus body accommodates the non-fixing type image receiving sheet SH3 having a light-reflecting surface region r2 on the front side surface (irregular surface side) and a light-reflecting surface region r2′ on the back side surface as shown in FIG. 28(C), and when the sheet SH3 is accommodated with its front side surface up in the cassette CAS2, the light ray emitted from the light-emitting element LE is reflected by the light-reflecting surface region r2 of the non-fixing type image receiving sheet SH3, and thereby is received by the light-receiving element LR, so that the fact the sheet accommodated in the cassette CAS2 is the non-fixing type image receiving sheet SH3 and the fact the sheet SH3 is accommodated with its front side surface up in the cassette CAS2 are detected.

In the case the non-fixing type image receiving sheet SH3 is accommodated with its back side surface up in the cassette CAS2, the light ray emitted from the light-emitting element LE′ is reflected by the light-reflecting surface region r2′ on the back side surface, and thereby is received by the light-receiving element LR′, so that the fact the sheet accommodated in the cassette CAS2 is the non-fixing type image receiving sheet SH3 and the fact the sheet SH3 is accommodated with its back side surface up in the cassette CAS2 are detected.

In the sheet type detecting device of FIG. 28(D), the fact that the sheet accommodated in the cassette is the ordinary image receiving sheets N can be detected like in the sheet type detecting device of FIG. 28(B). Also in the sheet type detecting device of FIG. 28(D), the sheet type can be detected even when the cassette CAS2 accommodates the ordinary image receiving sheet N and the non-fixing type image receiving sheet in the mixed fashion.

In the case of detecting whether the non-fixing type image receiving sheet SH3 is accommodated with its front side surface up or back side surface up in the cassette CAS2 as described above, a step #42′ may be conducted between the steps #42 and #43 as shown with a chain line in FIG. 27. When the sheet SH3 is accommodated with its front surface side down, that is, when the sheet SH3 is accommodated with its irregular surface down, the step #42′ is executed to prohibit image formation (step #5), and the operation is finished (step# 6). When the front side surface is up, the foregoing step #43 is performed.

The ordinary image receiving sheet N and the non-fixing type image receiving sheet SH3 may be identified by giving them different static capacitances, surface resistances, magnetic properties or the like, instead of giving them different light-reflecting properties by providing the non-fixing type image receiving sheet SH3 the light-reflecting surface portion(s) r1, r2 and r2′.

The sheet type detecting device shown in FIGS. 29(A) and 29(B) includes a cassette CA3 that is provided for accommodating the non-fixing type image receiving sheets SH3 and has a high reflection density surface portion r′ at its side (see FIG. 29(A)); a cassette CA3′ that is provided for accommodating the ordinary image receiving sheets N and has a low reflection density surface portion r″ at its side (see FIG. 29(B)); a cassette sensor CS1 for detecting whether or not the cassette is fitted to the apparatus body; and the light-emitting element LE and light-receiving LR arranged to face the reflecting surface portion r′ or r″ of the cassette when the cassette is fitted to the apparatus body.

The fact that the sheet accommodated in the cassette is the non-fixing type image receiving sheet is detected when the cassette sensor CS1 detects the mounted cassette CAS3, and the light-emitting element LE and light-receiving element LR detect the high reflection density surface portion r′.

The fact that the sheet accommodated in the cassette is the ordinary image receiving sheet is detected when the cassette sensor CS1 detects the mounted cassette CAS3′, and the light-emitting element LE and light-receiving element LR detect the low reflection density surface portion r″.

Instead of the above, the cassette CAS3 for accommodating the non-fixing type image receiving sheets may have the low reflection density surface portion, and the cassette CAS3′ for accommodating the ordinary image receiving sheets may have the high reflection density surface portion.

The sheet type detecting device shown in FIGS. 30(A) and 30(B) includes two sensors arranged at the cassette-fit part in the image forming apparatus body. One of the sensors has a pin PN1 which retracts against a spring SP1 when pressed by a forward end face of the cassette to be fitted to the cassette-fit part, and a switch SW1 to be triggered by the retraction of the pin PN1. The other sensor has a switch SW2 and a pin PN2 that is to be fitted into a groove g or g′ formed on the side of the cassette CAS4 or CAS4′, respectively, when the cassette CAS4 for accommodating the non-fixing type image receiving sheets or cassette CAS4′ for accommodating the ordinary image receiving sheet is fitted to the image forming apparatus. The pin PN2 retracts against a spring SP2 to trigger the switch SW2 when pressed by a side portion of the cassette CAS4 that has the groove g shorter than the groove g′ of the cassette CAS4′. When the cassette CAS4′ having the long groove g′ is fitted to the apparatus, the pin PN2 is fitted into the groove g′ so that the pin PN2 does not retract, and thereby the switch SW2 is not triggered by the pin PN2.

When the switches SW1 and SW2 are both triggered, the fact that the cassette fitted to the apparatus is the cassette CAS4 for accommodating the non-fixing type image receiving sheets is detected, and thereby the fact that the sheet accommodated in the cassette is the non-fixing type image receiving sheet SH3 is detected. When only the switch SW1 is triggered, the fact that the cassette fitted to the apparatus is the cassette CAS4′ for accommodating the ordinary image receiving sheets is detected, and thereby the fact that the sheet accommodated in the cassette is the ordinary image receiving sheet SH3 is detected.

In this embodiment, it is instructed by the operator who pushes the sheet type selecting key PK or SK whether the image is to be formed on the ordinary image receiving sheet N or the non-fixing type image receiving sheet SH3. Instead of this, it may be determined whether the image is to be formed on the sheet N or the sheet SH3 based on the sheet type, detected by the sheet type detecting device 20, of the image receiving sheet that is accommodated in the cassette fitted by the operator to the apparatus.

In this embodiment, the image formation operation is performed on the image receiving sheet based on detection results such as the unit type detected by the unit type detecting device 10 and the sheet type detected by the sheet type detecting device 20. Instead of this, the image forming apparatus may not be provided with such detecting devices, and the image formation operation may be performed on such an assumption that the combination of the image receiving sheet accommodated by the operator in the cassette and the unit fitted by the operator to the unit-fit part 5 is proper. In this case, on the operator's own responsibility, the operator should fit the cassette accommodating the ordinary image receiving sheet N to the cassette-fit part CA and should fit the fixing unit 4 to the unit-fit part 5 when forming the image on the ordinary image receiving sheet N; and the operator should fit the cassette accommodating the non-fixing type image receiving sheet SH3 to the cassette-fit part CA and should fit the convexity-cleaning unit 3′ to the unit-fit part 5 when forming the image on the non-fixing type image receiving sheet SH3. In this case, the non-fixing type image receiving sheet SH3 may be colored, for example, a light or pale color for enabling the operator to easily distinguish the non-fixing type image receiving sheet SH3 from the ordinary image receiving sheet N. Of course, the colored image receiving sheet may be detected.

In the image forming apparatus AP2 described above, the fixing unit 4 can be fitted to the unit-fit part 5 when forming the toner image on the ordinary image receiving sheet N, alternatively, the convexity-cleaning unit 3′ can be fitted to the unit-fit part 5 when forming the toner image on the non-fixing type image receiving sheet SH3. The toner image is formed on the ordinary image receiving sheet N or on the non-fixing type image receiving sheet SH3 by the toner image forming device 1′. Then, the toner image formed on the ordinary image receiving sheet N is fixed thereto by the fixing unit 4 fitted to the unit-fit part 5, or the toner T′ adhering to the convexities P of the non-fixing type image receiving sheet SH3 is removed by the convexity-cleaning unit 3′ fitted to the unit-fit part 5. Consequently, according to the image forming apparatus AP2, the toner image can be formed both on the non-fixing type image receiving sheet SH3 and on the ordinary image receiving sheet N.

In addition, the image forming apparatus AP2 has only one sheet-transporting path for transporting both the non-fixing type image receiving sheet SH3 and the ordinary image receiving sheet N. Therefore the apparatus AP2 does not required to have a switching member for switching the sheet-transporting path to select the desired path, and also does not required to have an electrical and mechanical structure for driving the switching member. Further, the image forming apparatus AP2 can be designed without fundamentally changing the structure of the conventional image forming apparatus for forming only on the ordinary image receiving sheet or the conventional image forming apparatus for forming only on the non-fixing type image receiving sheet. According to these above, the costs of the apparatus AP2 can be lowered and the apparatus AP2 can be compacted.

Further the single image forming apparatus AP2 can carry out both of two functions, i.e. a first function of forming the toner image on the ordinary image receiving sheet N and a second function of forming toner image on the non-fixing type image receiving sheet SH3.

Even if a consumer buy the image forming apparatus AP2 having only one of those first and second functions (e.g., the function of forming the toner image on the ordinary image receiving sheet), that is, even if the consumer buy the apparatus AP2 having only one of the fixing unit 4 and the convexity-cleaning unit 3′ (e.g., fixing unit 4), and thereafter when the consumer need or want the other function (e.g., the function of forming the toner image on the non-fixing type image receiving sheet), it is required for the consumer to buy only the unit (e.g., the convexity-cleaning unit 3′) having additionally necessary function, and it is not required for the consumer to buy a new whole image forming apparatus having the additionally necessary function.

The conventional image forming apparatus for forming the toner image on the ordinary image receiving sheet N consumes a large amount of energy for the fixing operation. In contrast, the image forming apparatus AP2 requires no energy for the fixing operation in the case of forming the toner image on the non-fixing type image receiving sheet SH3, resulting in overcoming of environmental problems.

In the image forming apparatus AP2, an electric power is supplied via the power-supply connector 51 to the electric heater 44 of the fixing unit 4 for fixing the toner image to the ordinary image receiving sheet when the fixing unit 4 is fitted to the unit-fit part 5.

On the other hand, when the convexity-cleaning unit 3′ is fitted to the unit-fit part 5, it is unnecessary to supply the electric heater 44 with the electric power. However, if the image forming apparatus AP2 is in the above state, the image forming apparatus AP2 would stop the operation, in some cases, for forming the toner image on the non-fixing type image receiving sheet SH3 under such a judgment that a trouble has occurred, which depends on the judgment algorithm, hardware logic for that judgment or the like. To avert this, the convexity-cleaning unit 3′ has the fixing unit-dummy (thermistor in this embodiment) 500 detachably fittable to the power-supply connector 51 arranged at the apparatus body.

For properly corresponding the image receiving sheet to be used for image formation to the unit fitted to the unit-fit part 5, the following structure may be employed in the image forming apparatus AP2.

For properly corresponding the non-fixing type image receiving sheet SH3 to the cassette CAS for accommodating the sheets SH3 and for properly corresponding the ordinary image receiving sheet N to the cassette CAS for accommodating the sheets N, accommodation part of each of the cassettes may have the shape matched with the shape of the corresponding sheet, so that putting of the sheet in the improper cassette can be prevented, that is, putting of the image receiving sheet SH3 into the cassette for accommodating the ordinary image receiving sheet N can be prevented, and also putting of the ordinary image receiving sheet N into the cassette for accommodating the non-fixing type image receiving sheet SH3 can be prevented.

For this, for example, the shape of the accommodation part of the cassette for accommodating the sheet SH3 may be different from the shape of the accommodation part of the cassette for accommodating the sheet N, and the shape of each of the sheet SH3 and N may have the shape of the accommodation part of the corresponding cassette. More specifically, for example, different overall sizes may be given to the non-fixing type image receiving sheet and the ordinary image receiving sheet, and to the corresponding accommodation parts of the cassettes. Alternatively, different shapes may be given to the non-fixing type image receiving sheet and the ordinary image receiving sheet, and to the corresponding accommodation parts of the cassettes. In this case, a portion (e.g., corner) of the non-fixing type image receiving sheet SH3 may be cut off, and the accommodation part of the cassette for accommodating the sheets SH3 may have the corresponding shape of the sheet SH3.

In this case, for example, small-size projections may be formed in different positions of the respective cassettes CAS for the non-fixing type image receiving sheet SH3 and for the ordinary image receiving sheet N, and microswitches corresponding to the respective projections may be provided at the cassette-fit part CA of the image forming apparatus AP2. When the cassette accommodating image receiving sheets SH3 or N is fitted to the cassette-fit part CA of the apparatus body, the projection of the cassette pushes the corresponding microswitch of the apparatus body. On the other hand, when the unit 3′ or 4 corresponding to the cassette is fitted to the unit-fit part of the apparatus body, the projection 30′ or 40 of the unit 3′ or 4 pushes the switch 10a or 10b of the apparatus body. In this way, the image receiving sheet SH3 (or N) to be used for image formation corresponds properly to the unit 3′ (or 4).

In this embodiment, the image forming apparatus AP2 has only one cassette-fit part to which the cassette CAS is fitted. Instead of this, the image forming apparatus may have two or more cassette-fit parts to which the cassette CAS for the non-fixing type image receiving sheets SH3 and the cassette CAS for the ordinary image receiving sheets N can be fitted. In this case, the sheet-drawing roller may be provided at each cassette-fit part for pulling out the single image receiving sheet from each cassette, and sheet-transporting path may be provided from each the cassette to the timing roller pair R2 for guiding the image receiving sheet from each the cassette to the timing roller pair R2.

When reusing the non-fixing type image receiving sheet SH3 after the toner image on the sheet SH3 has become unnecessary, the toner is separated and removed by the sheet-cleaning device from the image receiving sheet SH3 carrying the toner image formed thereon, so that the sheet SH3 is regenerated into such a state that the sheet SH3 do not carry the toner image.

Such a sheet-cleaning device may be, for example, a well-known conventional magnetic brush device that has a magnet roller carrying magnetic carrier-particles in the brush form, or a fur brush device including a brush roller. In any case, the toner particles adhering to the concavity or concavities of the irregular surface of the non-fixing type image receiving sheet are removed therefrom by the brush.

The image forming apparatus AP2 of FIG. 18 and FIG. 19 may be further provided with the above sheet-cleaning device at the upstream side, in the sheet feed direction Y, of the toner image formation region Q (the transfer region Q in this embodiment, see FIG. 19) where the toner image is formed on the image receiving sheet by the toner image forming device 1′. In this case, when forming the toner image on the ordinary image receiving sheet N, the sheet-cleaning device may be evacuated to such a position that the brush roller or the like of the sheet-cleaning device is not come into contact with the ordinary image receiving sheet N. Instead of the above, the image forming apparatus may not provided with the sheet-cleaning device. The sheet-cleaning device may be of an independent type.

FIG. 31 shows such a state that the toner T adhering to concavities R of the irregular surface S_{IR}3 of the non-fixing type image receiving sheet SH3 is separated and removed therefrom by a fur brushing device 8 including a brush roller 81 as an example of the sheet-cleaning device.

In the fur brush device 8, the brush roller 81 is driven to rotate clockwise in FIG. 31 by a driving device (not shown), and is supplied from the power source PW8 with a bias voltage (about +300 to +500V) having a polarity opposite to the charged polarity of the toner particles when cleaning. A roller 82 faces the brush roller 81 and is electrically grounded. Thereby a charge for separating and removing the toner from the image receiving sheet SH3 can be applied to the sheet SH3.

In the fur brush device 8, the irregular surface S_{IR}3 of the image receiving sheet SH3 carrying the toner image is mechanically rubbed or brushed by the brush hair (brush fiber) 811 of the brush roller 81, so that the toner adhering to the concavities R of the irregular surface S_{IR}3 is transferred to the brush roller 81 while utilizing the electrostatic force, and thereby the toner on the irregular surface S_{IR}3 is removed. The removed toner T may be reused. In the case the image forming apparatus is provided with the sheet-cleaning device, the removed toner T may be returned to the developing device 14′ for reuse.

In the case the concavities R of the irregular surface of the non-fixing type image receiving sheet have groove forms, the extending directions of the groove-form concavities R are preferably parallel or substantially parallel with the sheet feed direction Y, like the concavities R shown in FIGS. 9(B), 9(D), 9(E) and 9(F), so that the brush fiber can smoothly brush away the toner along the concavities R to facilitate the removal of the toner from the concavities R. As described hereinbefore, FIG. 31 shows the image receiving sheet with the irregular surface pattern of the type shown in FIG. 9(A) wherein the concavities R and convexities P extend in parallel with a direction X perpendicular to the sheet feed direction Y, instead of the image receiving sheet of FIG. 9(B) for better understanding.

Although the present invention has been described and illustrated in detail, it is clearly understood that the same is by way of illustration and example only and is not to be taken by way of limitation, the spirit and the scope of the present invention being limited only by the terms of the appended claims.

What is claimed is:

1. A convexity-cleaning method for removing toner adhering to a convexity or convexities of an irregular surface of a non-fixing type image receiving sheet, the irregular surface including at least one concavity for receiving the toner and at least one convexity for protecting the toner received in the concavity, the non-fixing type image receiving sheet being for carrying a toner image to be formed on the irregular surface by removably adhering the toner to the concavity or concavities of the irregular surface, the method comprising the steps of:
bringing a contact surface of a cleaning member into contact with the convexity or convexities when removing the toner adhering to the convexity or convexities of the irregular surface of the non-fixing type image receiving sheet;
moving the non-fixing type image receiving sheet relatively to the cleaning member so that the irregular surface of the non-fixing type image receiving sheet moves relatively to the cleaning member at a first surface moving speed when removing the toner; and
moving the contact surface of the cleaning member at a second surface moving speed when removing the toner; wherein
a difference is made between the first and second surface moving speeds.

2. The convexity-cleaning method according to claim 1, wherein the cleaning member has a rotary form, and the contact surface of the cleaning member is moved by rotating the cleaning member.

3. The convexity-cleaning method according to claim 1, wherein the second surface moving speed is greater than the first surface moving speed.

4. The convexity-cleaning method according to claim 1, wherein in a contact region where the cleaning member is in contact with the non-fixing type image receiving sheet, a moving direction of the contact surface of the cleaning member is same as a relative moving direction of the irregular surface of the non-fixing type image receiving sheet with respect to the cleaning member.

5. The convexity-cleaning method according to claim 1, wherein in a contact region where the cleaning member is in contact with the non-fixing type image receiving sheet, a moving direction of the contact surface of the cleaning member is opposite to a relative moving direction of the irregular surface of the non-fixing type image receiving sheet with respect to the cleaning member.

6. The convexity-cleaning method according to claim 1, wherein the irregular surface of the non-fixing type image receiving sheet includes a plurality of the convexities each in a linear form extending in an extending direction, and the non-fixing type image receiving sheet is moved relatively to the cleaning member in a direction parallel with the extending direction of the linear convexities of the irregular surface of the non-fixing type image receiving sheet when removing the toner.

7. A convexity-cleaning device for removing toner adhering to a convexity or convexities of an irregular surface of a non-fixing type image receiving sheet, the irregular surface including at least one concavity for receiving the toner and at least one convexity for protecting the toner received in the concavity, the non-fixing type image receiving sheet being for carrying a toner image to be formed on the irregular surface by removably adhering the toner to the concavity or concavities of the irregular surface, the convexity-cleaning device comprising:
a cleaning member having a contact surface to be in contact with the convexity or convexities of the irregular surface of the non-fixing type image receiving sheet;
a first driving device for relatively moving the non-fixing type image receiving sheet with respect to the cleaning member; and
a second driving device for moving the contact surface of the cleaning member; wherein
the contact surface of the cleaning member is brought into contact with the convexity or convexities when removing the toner adhering to the convexity or convexities of the irregular surface of the non-fixing type image receiving sheet;
the non-fixing type image receiving sheet is moved by the first driving device relatively to the cleaning member so that the irregular surface of the non-fixing type image receiving sheet moves relatively to the cleaning member at a first surface moving speed when removing the toner;
the contact surface of the cleaning member is moved by the second driving device at a second surface moving speed when removing the toner; and
a difference is made between the first and second surface moving speeds.

8. The convexity-cleaning device according to claim 7, wherein the cleaning member has a rotary form, and the contact surface of the cleaning member is moved by rotating the cleaning member by the second driving device.

9. The convexity-cleaning device according to claim 7, wherein the second surface moving speed is greater than the first surface moving speed.

10. The convexity-cleaning device according to claim 7, wherein in a contact region where the cleaning member is in contact with the non-fixing type image receiving sheet, a moving direction of the contact surface of the cleaning member is same as a relative moving direction of the irregular surface of the non-fixing type image receiving sheet with respect to the cleaning member.

11. The convexity-cleaning device according to claim 7, wherein in a contact region where the cleaning member is in contact with the non-fixing type image receiving sheet, a moving direction of the contact surface of the cleaning member is opposite to a relative moving direction of the irregular surface of the non-fixing type image receiving sheet with respect to the cleaning member.

12. The convexity-cleaning device according to claim 7, wherein the irregular surface of the non-fixing type image receiving sheet includes a plurality of the convexities each in a linear form extending in an extending direction, and the non-fixing type image receiving sheet is moved relatively to the cleaning member in a direction parallel with the extending direction of the linear convexities of the irregular surface of the non-fixing type image receiving sheet when removing the toner.

13. An image forming apparatus for forming a toner image on an irregular surface of a non-fixing type image receiving sheet, the irregular surface including at least one concavity for receiving toner and at least one convexity for protecting the toner received in the concavity, the apparatus comprising:
a toner image forming device for forming the toner image on the irregular surface of the non-fixing type image receiving sheet by removably adhering the toner to the concavity or concavities of the irregular surface; and
the convexity-cleaning device according to claim 7.

14. A convexity-cleaning method for cleaning a convexity or convexities of an irregular surface of a non-fixing type image receiving sheet, the irregular surface including at least one concavity for receiving toner and at least one convexity for protecting the toner received in the concavity, the non-fixing type image receiving sheet being for carrying a toner image to be formed on the irregular surface by removably adhering the toner to the concavity or concavities of the irregular surface, wherein
the toner adhering to a top portion of the convexity is removed with a cleaning roller having a contact surface to be in contact with the top portion of the convexity, and thereby the convexity of the irregular surface of the non-fixing type image receiving sheet carrying the toner image formed thereon is cleaned;
the contact surface of the cleaning roller is brought into contact with the top portion of the convexity while rotating the cleaning roller when removing the toner; and
the top portion of the convexity of the non-fixing type image receiving sheet and the contact surface of the cleaning roller satisfy:
F_{w}1<F_{w}2
where F_{w}1 is Van Der Waals force between the top portion of the convexity and the toner adhering thereto, and F_{w}2 is Van Der Waals force between the contact surface of the cleaning roller and the toner adhering to the top portion of the convexity.

15. The convexity-cleaning method according to claim 14, wherein the top portion of the convexity of the non-fixing type image receiving sheet and the contact surface of the cleaning roller satisfy:
(1+cos θ₁)²<(1+cos θ₂)²
where θ₁ is an angle of contact between the top portion of the convexity and diiodomethane (CH₂I₂), and θ₂ is an angle of contact between the contact surface of the cleaning roller and diiodomethane (CH₂I₂).

16. The convexity-cleaning method according to claim 14, wherein a Hamaker constant of the top portion of the convexity is lower than a Hamaker constant of the contact surface of the cleaning roller.

17. A convexity-cleaning method for cleaning a convexity or convexities of an irregular surface of a non-fixing type image receiving sheet, the irregular surface including at least one concavity for receiving toner and at least one convexity for protecting the toner received in the concavity, the non-fixing type image receiving sheet being for carrying a toner image to be formed on the irregular surface by removably adhering the toner to the concavity or concavities of the irregular surface, wherein
the toner adhering to a top portion of the convexity is removed with a cleaning roller having a contact surface to be in contact with the top portion of the convexity, and thereby the convexity of the irregular surface of the non-fixing type image receiving sheet carrying the toner image formed thereon is cleaned;
the contact surface of the cleaning roller is brought into contact with the top portion of the convexity while rotating the cleaning roller when removing the toner; and
the top portion of the convexity of the non-fixing type image receiving sheet and the contact surface of the cleaning roller satisfy:
Fₑ1<Fₑ2
where Fₑ1 is an electrostatic attracting force between the top portion of the convexity and the toner adhering thereto, and Fₑ2 is an electrostatic attracting force between the contact surface of the cleaning roller and the toner adhering to the top portion of the convexity.

18. The convexity-cleaning method according to claim 17, wherein a dielectric constant of the top portion of the convexity of the non-fixing type image receiving sheet is lower than a dielectric constant of the contact surface of the cleaning roller.

19. The convexity-cleaning method according to claim 17, wherein a charged polarity of the toner when forming the toner image on the non-fixing type image receiving sheet is same as a charged polarity of the toner when the toner comes into contact with the top portion of the convexity, and/or is different from a charged polarity of the toner when the toner comes into contact with the contact surface of the cleaning roller.

20. A convexity-cleaning method for cleaning a convexity or convexities of an irregular surface of a non-fixing type image receiving sheet, the irregular surface including at least one concavity for receiving toner and at least one convexity for protecting the toner received in the concavity, the non-fixing type image receiving sheet being for carrying a toner image to be formed on the irregular surface by removably adhering the toner to the concavity or concavities of the irregular surface, wherein
the toner adhering to a top portion of the convexity is removed with a cleaning roller having a contact surface to be in contact with the top portion of the convexity, and thereby the convexity of the irregular surface of the non-fixing type image receiving sheet carrying the toner image formed thereon is cleaned;
the contact surface of the cleaning roller is brought into contact with the top portion of the convexity while rotating the cleaning roller when removing the toner; and
the top portion of the convexity of the non-fixing type image receiving sheet and the contact surface of the cleaning roller satisfy:
F_{b}1<F_{b}2
where F_{b}1 is a water bridging force between the top portion of the convexity and the toner adhering thereto, and F_{b}2 is a water bridging force between the contact surface of the cleaning roller and the toner adhering to the top portion of the convexity.

21. The convexity-cleaning method according to claim 20, wherein a contact angle between water and the top portion of the convexity is smaller than a contact angle between water and the contact surface of the cleaning roller.

22. A convexity-cleaning method for cleaning a convexity or convexities of an irregular surface of a non-fixing type image receiving sheet, the irregular surface including at least one concavity for receiving toner and at least one convexity for protecting the toner received in the concavity, the non-fixing type image receiving sheet being for carrying a toner image to be formed on the irregular surface by removably adhering the toner to the concavity or concavities of the irregular surface, wherein
the toner adhering to a top portion of the convexity is removed with a cleaning roller having a contact surface to be in contact with the top portion of the convexity, and thereby the convexity of the irregular surface of the non-fixing type image receiving sheet carrying the toner image formed thereon is cleaned;
the contact surface of the cleaning roller is brought into contact with the top portion of the convexity while rotating the cleaning roller when removing the toner; and
a surface of the top portion of the convexity of the non-fixing type image receiving sheet has a center line average height in the range of 0.2 μm to 1.0 μm.

23. An image forming method for forming a toner image on a non-fixing type image receiving sheet having an irregular surface which includes at least one concavity for receiving toner and at least one convexity for protecting the toner received in the concavity, the method comprising the steps of:
forming the toner image on the irregular surface of the non-fixing type image receiving sheet by removably adhering the toner to the concavity or concavities; and
removing the toner adhering to a top portion of the convexity of the non-fixing type image receiving sheet by implementing the convexity-cleaning method according to claim 14 after forming the toner image on the irregular surface.

24. An image forming method for forming a toner image on a non-fixing type image receiving sheet having an irregular surface which includes at least one concavity for receiving toner and at least one convexity for protecting the toner received in the concavity, the method comprising the steps of:
forming the toner image on the irregular surface of the non-fixing type image receiving sheet by removably adhering the toner to the concavity or concavities; and
removing the toner adhering to a top portion of the convexity of the non-fixing type image receiving sheet by implementing the convexity-cleaning method according to claim 17 after forming the toner image on the irregular surface.

25. An image forming method for forming a toner image on a non-fixing type image receiving sheet having an irregular surface which includes at least one concavity for receiving toner and at least one convexity for protecting the toner received in the concavity, the method comprising the steps of:
forming the toner image on the irregular surface of the non-fixing type image receiving sheet by removably adhering the toner to the concavity or concavities; and
removing the toner adhering to a top portion of the convexity of the non-fixing type image receiving sheet by implementing the convexity-cleaning method according to claim 20 after forming the toner image on the irregular surface.

26. An image forming method for forming a toner image on a non-fixing type image receiving sheet having an irregular surface which includes at least one concavity for receiving toner and at least one convexity for protecting the toner received in the concavity, the method comprising the steps of:
forming the toner image on the irregular surface of the non-fixing type image receiving sheet by removably adhering the toner to the concavity or concavities; and
removing the toner adhering to a top portion of the convexity of the non-fixing type image receiving sheet by implementing the convexity-cleaning method according to claim 22 after forming the toner image on the irregular surface.

27. A non-fixing type image receiving sheet having an irregular surface for carrying a toner image to be formed thereon, the irregular surface including at least one concavity for receiving toner and at least one convexity for protecting the toner adhering to the concavity, wherein a surface of a top portion of the convexity has a center line average height in the range of 0.2 μm to 1.0 μm.

28. An image forming apparatus comprising:
a toner image forming device for forming a toner image both on an ordinary image receiving sheet and on a non-fixing type image receiving sheet, the non-fixing type image receiving sheet having an irregular surface including at least one concavity for receiving toner and at least one convexity for protecting the toner adhering to the concavity, the non-fixing type image receiving sheet being for carrying the toner image to be formed on the irregular surface by removably adhering the toner to the concavity or concavities of the irregular surface; and
a unit-fit part arranged at downstream side of the toner image forming device in a sheet feed direction; wherein
any one of a fixing unit and a convexity-cleaning unit can detachably fit to the unit-fit part, and thereby one of the fixing unit and the convexity-cleaning unit fitted to the unit-fit part can be exchanged to the other, the fixing unit being for fixing the toner image formed on the ordinary image receiving sheet to the ordinary image receiving sheet, the convexity-cleaning unit being for removing the toner adhering to the convexity of the irregular surface of the non-fixing type image receiving sheet.

29. The image forming apparatus according to claim 28, further comprising at least one of the fixing unit and the convexity-cleaning unit.

30. The image forming apparatus according to claim 28, wherein
the fixing unit includes a fixing roller to be driven via a first gear train;
the first gear train includes a first driving gear arranged in the unit-fit part, and a first driven gear or gear train arranged in the fixing unit and detachably engageable with the first driving gear;
the convexity-cleaning unit includes a convexity-cleaning roller to be driven via a second gear train;
the second gear train includes a second driving gear arranged in the unit-fit part, and a second driven gear or gear train arranged in the convexity-cleaning unit and detachably engageable with the second driving gear.

31. The image forming apparatus according to claim 30, wherein the first driving gear for driving the fixing roller is identical with the second driving gear for driving the convexity-cleaning roller.

32. The image forming apparatus according to claim 28, further comprising:
a sheet type detecting device for detecting whether the image receiving sheet to be used for forming the toner image is the ordinary image receiving sheet or the non-fixing type image receiving sheet; and
a unit type detecting device for detecting whether the unit fitted to the unit-fit part is the fixing unit or the convexity-cleaning unit, wherein
toner image formation on the ordinary image receiving sheet is permitted when the sheet type detecting device detects the ordinary image receiving sheet and the unit type detecting device detects the fixing unit; and
toner image formation on the non-fixing type image receiving sheet is permitted when the sheet type detecting device detects the non-fixing type image receiving sheet and the unit type detecting device detects the convexity-cleaning unit.

33. The image forming apparatus according to claim 30, wherein the convexity-cleaning roller is driven via the second gear train so that a peripheral surface moving speed of the convexity-cleaning roller is faster than a surface moving speed of the non-fixing type image receiving sheet when removing the toner adhering to the convexity of the irregular surface of the non-fixing type image receiving sheet.

34. A convexity-cleaning unit detachably fittable to the unit-fit part of the image forming apparatus according to claim 28.

35. A convexity-cleaning unit detachably fittable to the unit-fit part of the image forming apparatus according to claim 31, wherein the second driven gear or gear train arranged in the convexity-cleaning unit can rotate the convexity-cleaning roller at a peripheral surface moving speed higher than a peripheral surface moving speed of the fixing roller of the fixing unit.

36. The convexity-cleaning unit according to claim 35 having a plurality of convexity-cleaning rollers that includes said convexity-cleaning roller and are arranged along the sheet feed direction.

37. A convexity-cleaning unit detachably fittable to the unit-fit part of the image forming apparatus according to claim 28, the convexity-cleaning unit comprising a fixing unit-dummy detachably fittable to a power-supply connector, via which an electrical power can be supplied to an electrical heater of the fixing unit for fixing the toner image.
